(19) United States
(12) Patent Application Publication
(10) Pub. No.: US 2026/0261749 A1
(43) Pub. Date: Sep. 3, 2026

(54) LENS DEVICE AND IMAGING APPARATUS

(71) Applicant: FUJIFILM Corporation, Tokyo (JP)

(72) Inventors: Takuya TANAKA, Saitama (JP); Masaru YONEZAWA, Saitama (JP)

(73) Assignee: FUJIFILM Corporation, Tokyo (JP)

(21) Appl. No.: 19/542,561

(22) Filed: Feb. 17, 2026

(30) Foreign Application Priority Data
Feb. 28, 2025 (JP) 2025-032307

(51) Int. Cl. H04N 23/55; G02B 5/04; G02B 15/14; G02B 15/163; H04N 23/69; H04N 23/88

(52) U.S. Cl. CPC H04N 23/55; G02B 5/04; G02B 15/144109; G02B 15/145125; G02B 15/145129; G02B 15/1461; G02B 15/163; H04N 23/69; H04N 23/88

(57) ABSTRACT

The lens device is attachable to and detachable from an imaging apparatus body including a color separation prism, and includes a storage unit that stores correction data for correcting color shading of image data obtained in a case where an image formed by a zoom lens is captured through the color separation prism in the imaging apparatus body, and a communication unit that transmits the correction data to the imaging apparatus body. The correction data has a correction value that is set for each combination of a zoom state, a focus state, and an aperture state of the zoom lens. The zoom lens includes a first lens group that includes a focusing group, is disposed closest to an object side, and does not move during changing magnification, a plurality of movable lens groups that move during changing magnification, and a final lens group.

### CROSS-REFERENCE TO RELATED APPLICATIONS

This application claims priority from Japanese Patent Application No. 2025-032307, filed on Feb. 28, 2025, the entire disclosure of which is incorporated herein by reference.

### BACKGROUND

### Technical Field

The present disclosed technology relates to a lens device and an imaging apparatus.

### Related Art

In the related art, an imaging apparatus described in WO2018/168214A is known.

### SUMMARY

In the related art, a color separation prism that separates a luminous flux, for example, a three-plate color separation prism that separates a luminous flux into luminous fluxes of three primary colors including blue, green, and red is known. In the imaging apparatus, in a case where an imaging luminous flux is separated by the three-plate color separation prism, a phenomenon called color shading in which the tone of a captured image varies in an up-down direction of a screen may occur.

The present disclosure provides a lens device that is advantageous in correcting color shading and an imaging apparatus including the lens device.

According to a first aspect of the present disclosure, there is provided a lens device comprising: a zoom lens, in which the zoom lens includes a first lens group that includes a focusing group moving during focusing, is disposed closest to an object side, and is fixed relative to an image plane during changing magnification, a plurality of movable lens groups that move while changing a spacing to an adjacent lens group during changing magnification, and a final lens group that is disposed closest to an image side and is fixed relative to the image plane during changing magnification, the lens device is attachable to and detachable from an imaging apparatus body including a color separation prism, and includes a storage unit that stores correction data for correcting color shading of image data obtained in a case where an image formed by the zoom lens is captured through the color separation prism in the imaging apparatus body, and a communication unit that transmits the correction data to the imaging apparatus body, the correction data has a correction value that is set for each combination of a zoom state, a focus state, and an aperture state of the zoom lens at a specific image height, and in a case where a focal length and a maximum half angle of view of the zoom lens in each zoom state are represented by f and ω, respectively, and a unit of f is mm, the specific image height is defined by 0.49×f×tan ω, and
Conditional Expression (1) represented by

$$1.5 mm < 0.49 \times f \times tan ω < 5 mm \qquad ( 1 )$$

is satisfied.

According to a second aspect of the present disclosure, there is provided a lens device comprising: a zoom lens, in which the zoom lens includes a first lens group that includes a focusing group moving during focusing, is disposed closest to an object side, and is fixed relative to an image plane during changing magnification, a plurality of movable lens groups that move while changing a spacing to an adjacent lens group during changing magnification, and a final lens group that is disposed closest to an image side and is fixed relative to the image plane during changing magnification, the lens device is attachable to and detachable from an imaging apparatus body including a color separation prism, and includes a storage unit that stores correction data for correcting color shading of image data obtained in a case where an image formed by the zoom lens is captured through the color separation prism in the imaging apparatus body, and a communication unit that transmits the correction data to the imaging apparatus body, the correction data has a correction value that is set for each combination of a zoom state, a focus state, and an aperture state of the zoom lens, and in a case where the number of the zoom states, the number of the focus states, and the number of the aperture states in groups of the combination are represented by Nz, Nf, and Na, respectively,
Conditional Expressions (2) and (3) represented by

$$0.05 \leq Nf / ( Nz \times Na ) \leq 0.3 , \qquad ( 2 )$$

$$and 8 \leq ( Nz \times Nf ) / Na \leq 25 \; 6 \qquad ( 3 )$$

are satisfied.

In the lens device according to the second aspect, it is preferable that, in a case where a focal length and a maximum half angle of view of the zoom lens in each zoom state are represented by f and ω, respectively, and a unit of f is mm, the correction value is a value at a specific image height that is defined by 0.49×f×tan ω, and
Conditional Expression (1) represented by

$$1.5 mm < 0.49 \times f \times tan ω < 5 mm \qquad ( 1 )$$

is satisfied.

In the lens device according to the above-described aspect, it is preferable that, in a case where the number of the zoom states, the number of the focus states, and the number of the aperture states in groups of the combination are represented by Nz, Nf, and Na, respectively,
Conditional Expression (4) represented by

$$256 \leq Nz \times Nf \times Na \leq 2048 \qquad ( 4 )$$

is satisfied.

It is preferable that, in a case where the focal length and the maximum half angle of view of the zoom lens in each zoom state are represented by f and ω, respectively, and the unit of f is mm, the correction value is a value at a specific image height that is defined by 0.49×f×tan ω, and in a case where a ray that is incident at a bisected angle of an angle between an upper ray and a lower ray among rays that are incident at the specific image height of the image plane of the zoom lens is a middle ray, a focal length of the zoom lens in a state where an infinite distance object at a telephoto end is in focus is represented by ft, and a focal length of the zoom lens in a state where an infinite distance object at a wide angle end is in focus is represented by fw, a distance from the image plane of the zoom lens in a state where an infinite distance object is in focus to an exit pupil position of the middle ray is represented by Dexp, and a sign of Dexp is positive for a distance on the image side and is negative for a distance on the object side with respect to the image plane, Dexp of the zoom lens at the wide angle end is negative, Dexp of the zoom lens at the telephoto end is positive, and a focal length of the zoom lens in a state where Dexp is infinite is in a range of fw×(ft/fw)^{0.6} or more and fw×(ft/fw)^{0.9} or less.

The zoom lens may consist of, in order from the object side to the image side, the first lens group that has a positive refractive power, a second lens group that has a negative refractive power and moves during changing magnification, one or more and three or less lens groups that move while changing a spacing to an adjacent lens group during changing magnification, and the final lens group that has a positive refractive power.

The zoom lens may consist of, in order from the object side to the image side, the first lens group that has a positive refractive power, a second lens group that has a negative refractive power, a third lens group that has a negative refractive power, and the final lens group that has a positive refractive power, and during changing magnification, the second lens group and the third lens group may move while changing a mutual spacing.

The zoom lens may consist of, in order from the object side to the image side, a first lens group that has a positive refractive power, a second lens group that has a negative refractive power, a third lens group that has a negative refractive power, a fourth lens group that has a positive refractive power, and a final lens group that has a positive refractive power, and during changing magnification, the second lens group, the third lens group, and the fourth lens group may move while changing a spacing to an adjacent lens group.

The zoom lens may consist of, in order from the object side to the image side, the first lens group that has a positive refractive power, a second lens group that has a negative refractive power, a third lens group that has a positive refractive power, a fourth lens group that has a positive refractive power, and the final lens group that has a positive refractive power, and during changing magnification, the second lens group, the third lens group, and the fourth lens group may move while changing a spacing to an adjacent lens group.

The zoom lens may consist of, in order from the object side to the image side, the first lens group that has a positive refractive power, a second lens group that has a negative refractive power, a third lens group that has a negative refractive power, a fourth lens group that has a negative refractive power, a fifth lens group that has a negative refractive power, and the final lens group that has a positive refractive power, and during changing magnification, the second lens group, the third lens group, the fourth lens group, and the fifth lens group may move while changing a spacing to an adjacent lens group.

The zoom lens may consist of, in order from the object side to the image side, the first lens group that has a positive refractive power, a second lens group that has a negative refractive power, a third lens group that has a positive refractive power, a fourth lens group that has a negative refractive power, a fifth lens group that has a positive refractive power, and the final lens group that has a positive refractive power, and during changing magnification, the second lens group, the third lens group, the fourth lens group, and the fifth lens group may move while changing a spacing to an adjacent lens group.

The zoom lens may consist of, in order from the object side to the image side, the first lens group that has a positive refractive power, a second lens group that has a negative refractive power, a third lens group that has a negative refractive power, a fourth lens group that has a negative refractive power, a fifth lens group that has a negative refractive power, and the final lens group that has a positive refractive power, and during changing magnification, the second lens group, the third lens group, the fourth lens group, and the fifth lens group may move while changing a spacing to an adjacent lens group.

The lens device according to the above-described aspect may further comprise: an EX group that is insertable into and removable from an optical path of the zoom lens and changes a focal length depending on the insertion and removal; and an insertion/removal detection unit that detects a state of the insertion and removal, in which the correction value may be set depending on the state of the insertion and removal.

In the lens device according to the above-described aspect, it is preferable that, in a case where an open F-number of the zoom lens in a state where an infinite distance object at a telephoto end is in focus is represented by Fnot, a focal length of the zoom lens in a state where an infinite distance object at a telephoto end is in focus is represented by ft, and a focal length of the zoom lens in a state where an infinite distance object at a wide angle end is in focus is represented by fw,
Conditional Expression (5) represented by

$$0.03 < FNot / ( ft / fw ) < 0.3 \qquad ( 5 )$$

is satisfied.

In the lens device according to the above-described aspect, in a case where a focal length of a lens group that has a strongest negative refractive power among lens groups that have a negative refractive power and move during changing magnification in the zoom lens is represented by fn, and a focal length of the zoom lens in a state where an infinite distance object at a telephoto end is in focus is represented by ft,
it is preferable that Conditional Expression (6) represented by

$$- 0.4 < fn / ft < - 0.02 \qquad ( 6 )$$

is satisfied.

The first lens group of the zoom lens may consist of, in order from the object side to the image side, a first A partial group that is fixed relative to the image plane during focusing and has a negative refractive power, a first B partial group that moves along an optical axis during focusing and has a positive refractive power, and a first C partial group that changes a spacing to the first B partial group during focusing.

In the lens device according to the above-described aspect, in a case where a back focus of the zoom lens in terms of an air conversion distance is represented by Bfw, a focal length of the zoom lens in a state where an infinite distance object at a wide angle end is in focus is represented by fw, and a maximum half angle of view of the zoom lens in a state where the infinite distance object at the wide angle end is in focus is represented by ωw,
it is preferable that Conditional Expression (7) represented by

$$4 < Bfw / ( fw \times tan ω w ) < 10 \qquad ( 7 )$$

is satisfied.

In the lens device according to the above-described aspect, it is preferable that, in a case where the focal length and the maximum half angle of view of the zoom lens in each zoom state are represented by f and ω, respectively, and the unit of f is mm, the correction value is a value at a specific image height that is defined by 0.49×f×tan ω, and in a case where a ray that is incident at a bisected angle of an angle between an upper ray and a lower ray among rays that are incident at the specific image height of the image plane of the zoom lens is a middle ray, a focal length of the zoom lens in a state where an infinite distance object at a wide angle end is in focus is represented by fw, a distance from the image plane of the zoom lens in a state where the infinite distance object at the wide angle end is in focus to an exit pupil position of the middle ray is represented by Dexpw, and Dexpw is calculated using an air conversion distance for an optical member that does not have a refractive power and is disposed between the image plane and the exit pupil position of the middle ray,
Conditional Expression (8) represented by

$$4 < \vert Dexpw / fw \vert < 360 \qquad ( 8 )$$

is satisfied.

It is preferable that, in a case where the focal length and the maximum half angle of view of the zoom lens in each zoom state are represented by f and ω, respectively, and the unit of f is mm, the correction value is a value at a specific image height that is defined by 0.49×f×tan ω, and in a state where the zoom lens is focused on an infinite distance object, in an entire zoom range, an exit pupil position of a principal ray at the specific image height is positioned closer to the image side than the image plane.

According to the present disclosure, there is provided an imaging apparatus comprising: the lens device according to the above-described aspect; and the imaging apparatus body, in which the imaging apparatus body includes a color separation prism, an imaging element that captures the image formed by the zoom lens, and a processing unit that performs a process of correcting color shading of the image data based on the correction data transmitted from the lens device.

It should be noted that, in the present specification, the expressions “consists of . . . ” and “consisting of . . . ” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the shown constituent elements.

The term “group that has a positive refractive power” in the present specification means that the group has a positive refractive power as a whole. Similarly, the term “group that has a negative refractive power” means that the group has a negative refractive power as a whole. The term “lens that has a positive refractive power” and the term “positive lens” are synonymous with each other. The term “a lens that has a negative refractive power” and the term “negative lens” are synonymous. “~Lens group” and “focusing group” in the present specification are not limited to a configuration consisting of a plurality of lenses, but may be a configuration consisting of only one lens.

In the present specification, the number of lenses described above is the number of lenses as components. For example, it is assumed that the number of lenses in a cemented lens in which a plurality of single lenses made of different materials are cemented is represented by the number of single lenses constituting the cemented lens. Here, a compound aspherical lens (that is, in which a lens (for example, a spherical lens) and an aspherical film formed on the lens are integrally formed and function as one aspherical lens as a whole) is not regarded as a cemented lens, but the compound aspherical lens is regarded as one lens. Unless otherwise noted, a sign of a refractive power and a surface shape related to a lens including an aspherical surface in a paraxial region are used.

In the present specification, the term “focal length” used in the conditional expressions means a paraxial focal length. The values used in the conditional expressions are values with respect to the d line in a state where the zoom lens is focused on an infinite distance object unless otherwise specified.

“d line”, “C line”, “F line”, and “g line” described in the present specification are bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

The present disclosure can provide a lens device that is advantageous in correcting color shading and an imaging apparatus including the lens device.

### BRIEF DESCRIPTION OF THE DRAWINGS

FIG. 1 is a functional configuration diagram showing an imaging apparatus according to a first embodiment.

FIG. 2 is a configuration cross-sectional view showing an example of a zoom lens.

FIG. 3 is cross-sectional view showing a luminous flux and a configuration in each state of the zoom lens of FIG. 2.

FIG. 4 is a schematic configuration diagram showing an example of a three-plate color separation prism.

FIG. 5 is a diagram showing an example of correction data.

FIG. 6 is a diagram showing an example of the numbers of states in the correction data.

FIG. 7 is a diagram showing a middle ray.

FIG. 8 is an enlarged view showing a region A of FIG. 7.

FIG. 9 is a flowchart showing an example of an operation.

FIG. 10 is a flowchart showing another example of the operation.

FIG. 11 is a diagram showing a relationship between a focal length and Dexp.

FIG. 12 is a functional configuration diagram showing an imaging apparatus according to a second embodiment.

FIG. 13 is a cross-sectional view showing a configuration of a zoom lens according to Example 1 and a diagram showing movement loci thereof.

FIG. 14 shows each of aberration diagrams in the zoom lens according to Example 1.

FIG. 15 is a cross-sectional view showing a configuration of a zoom lens according to Example 2 and a diagram showing movement loci thereof.

FIG. 16 shows each of aberration diagrams in the zoom lens according to Example 2.

FIG. 17 is a cross-sectional view showing a configuration of a zoom lens according to Example 3 and a diagram showing movement loci thereof.

FIG. 18 shows each of aberration diagrams in the zoom lens according to Example 3.

FIG. 19 is a cross-sectional view showing a configuration of a zoom lens according to Example 4 and a diagram showing movement loci thereof.

FIG. 20 shows each of aberration diagrams in the zoom lens according to Example 4.

FIG. 21 is a cross-sectional view showing a configuration of a zoom lens according to Example 5 and a diagram showing movement loci thereof.

FIG. 22 shows each of aberration diagrams in the zoom lens according to Example 5.

FIG. 23 is a cross-sectional view showing a configuration of a zoom lens according to Example 6 and a diagram showing movement loci thereof.

FIG. 24 shows each of aberration diagrams in the zoom lens according to Example 6.

FIG. 25 is a cross-sectional view showing a configuration of a zoom lens according to Example 7 and a diagram showing movement loci thereof.

FIG. 26 shows each of aberration diagrams in the zoom lens according to Example 7.

FIG. 27 is a cross-sectional view showing a configuration of a zoom lens according to Example 8 and a diagram showing movement loci thereof.

FIG. 28 shows each of aberration diagrams in the zoom lens according to Example 8.

FIG. 29 is a cross-sectional view showing a configuration of a zoom lens according to Example 9 and a diagram showing movement loci thereof.

FIG. 30 shows each of aberration diagrams in the zoom lens according to Example 9.

### DETAILED DESCRIPTION

Hereinafter, an embodiment of the present disclosure will be described with reference to the drawings.

### First Embodiment

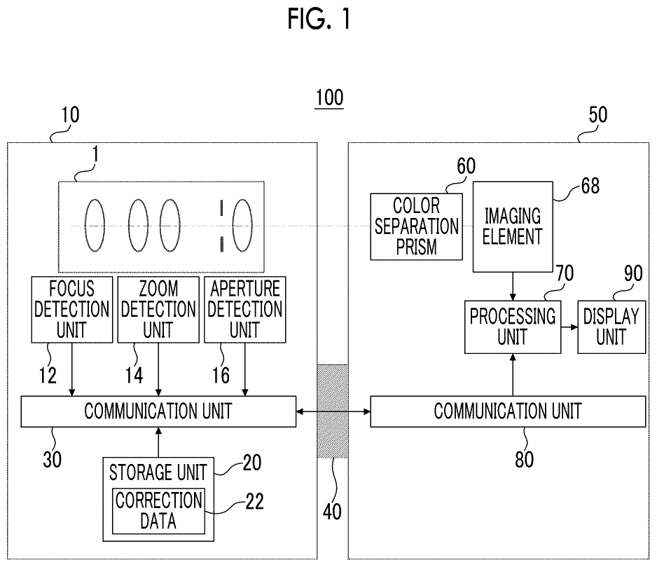

FIG. 1 is a functional configuration diagram showing an imaging apparatus 100 according to a first embodiment of the present disclosure. The imaging apparatus 100 is, for example, a broadcast camera. The imaging apparatus 100 includes a lens device 10 and an imaging apparatus body 50. The lens device 10 is attachable to and detachable from the imaging apparatus body 50, and is mountable on the imaging apparatus body 50 through a mount 40 provided in the imaging apparatus body 50.

The lens device 10 includes a zoom lens 1 that images a subject (not shown) to form an image. The imaging apparatus body 50 includes a color separation prism 60 and an imaging element 68. In a state where the lens device 10 is mounted on the imaging apparatus body 50, the image formed by the zoom lens 1 can be captured by the imaging element 68 through the color separation prism 60 in the imaging apparatus body 50, and image data is generated by the capturing.

### Configuration of Lens Device

In addition to the zoom lens 1, the lens device 10 includes a focus detection unit 12, a zoom detection unit 14, an aperture detection unit 16, a storage unit 20, and a communication unit 30.

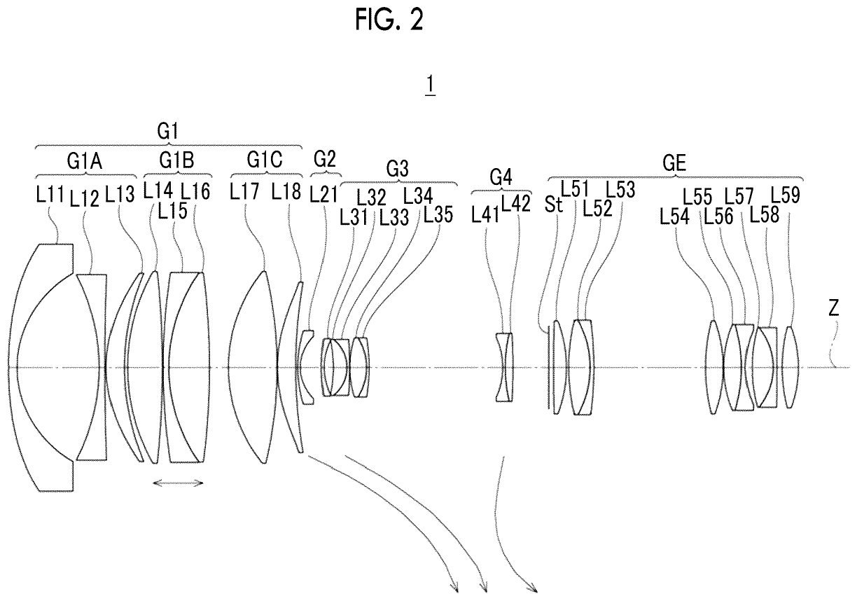

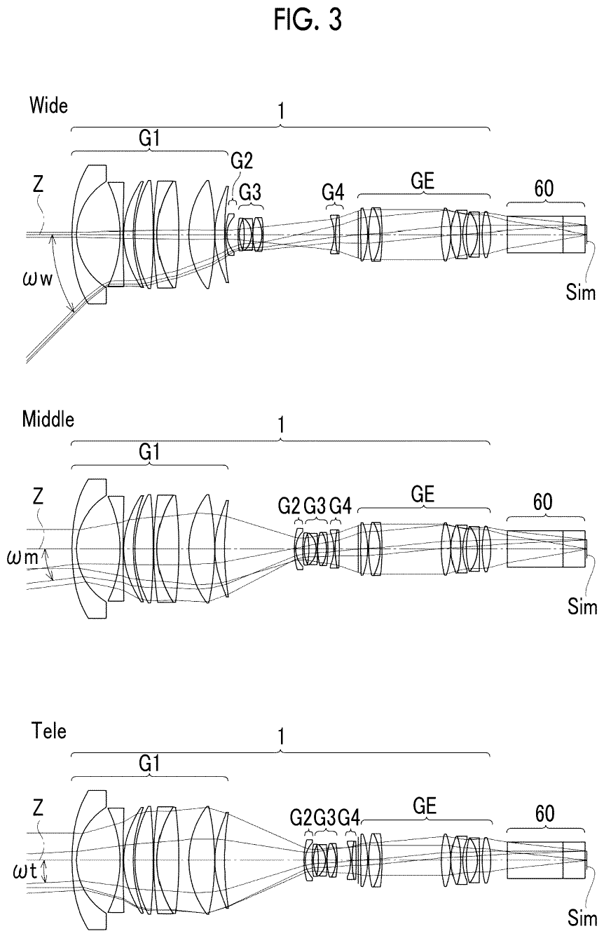

The zoom lens 1 functions as an imaging lens to form the image of the subject. FIG. 1 schematically shows the zoom lens 1. FIG. 2 is a configuration cross-sectional view showing an example of the zoom lens 1 at a wide angle end. The example shown in FIG. 2 corresponds to a zoom lens according to Example 1 below. FIG. 3 is a configuration cross-sectional view in each zoom state of the zoom lens 1 of FIG. 2. In FIG. 3, the upper stage to which “Wide” is attached shows a wide angle end state, the middle stage to which “Middle” is attached shows a middle focal length state, and the lower stage to which “Tele” is attached shows a telephoto end state. FIG. 3 shows the luminous fluxes, in which, as the luminous fluxes, an on-axis luminous flux and a luminous flux having a maximum half angle of view ωw at a wide angle end, an on-axis luminous flux and a luminous flux having a maximum half angle of view ωm at a middle focal length state, and an on-axis luminous flux and a luminous flux having a maximum half angle of view ωt at a telephoto end are shown. FIGS. 2 and 3 show a state in which the left side is an object side, the right side is an image side, and an infinite distance object is in focus.

FIG. 3 schematically shows the color separation prism 60 disposed between the zoom lens 1 and an image plane Sim. The color separation prism 60 according to the present example includes a filter that reflects or allows transmission of light having a specific wavelength instead of a prism member. The detailed configuration of the color separation prism 60 will be described below.

The zoom lens 1 includes a first lens group G1 that is disposed closest to the object side, a plurality of movable lens groups that move along an optical axis Z while changing a spacing to an adjacent lens group during changing magnification, and a final lens group GE that is disposed closest to the image side. The movable lens group moves to change the magnification of the zoom lens 1. During changing magnification, the first lens group G1 and the final lens group GE are fixed relative to the image plane Sim. During changing magnification, the lens group closest to the object side and the lens group closest to the image side do not move relative to the image plane Sim such that a variation in the center of gravity during changing magnification can be suppressed. The above-described configuration is suitable as an imaging lens for a motion picture that is adopted in an imaging optical system including a three-plate color separation prism, which is advantageous in correcting color shading.

An aperture stop St is disposed in the zoom lens 1. The aperture stop St includes an opening portion where an aperture amount is variable. By changing the aperture amount of the aperture stop St, the amount of light passing through the zoom lens 1 changes, and thus the F-number of the zoom lens 1 can be changed. The aperture amount may be changed through an operation of a user or during changing magnification.

For example, the zoom lens 1 of FIG. 2 is formed as follows. The zoom lens 1 consists of, in order from the object side to the image side, a first lens group G1, a second lens group G2, a third lens group G3, a fourth lens group G4, and a final lens group GE. The first lens group G1 consists of eight lenses including lenses L11 to L18 in order from the object side to the image side. The second lens group G2 consists of one lens L21. The third lens group G3 consists of five lenses including lenses L31 to L35 in order from the object side to the image side. The fourth lens group G4 consists of two lenses including lenses L41 and L42 in order from the object side to the image side. The final lens group GE consists of the aperture stop St and nine lenses including lenses L51 to L59 in order from the object side to the image side. The aperture stop St shown in FIG. 2 does not show the size or the shape thereof, but shows a position thereof in an optical axis direction. In the example of FIG. 2, the second lens group G2, the third lens group G3, and the fourth lens group G4 are examples of “movable lens group” according to the present disclosure. In FIG. 2, a schematic movement locus of each of the movable lens groups during changing magnification from the wide angle end to the telephoto end is indicated by a curved arrow below the lens group corresponding to the movable lens group.

The first lens group G1 includes a focusing group. The focusing group is a group that moves along the optical axis Z during focusing. By moving the focusing group, the zoom lens 1 is focused. By performing the focusing using the lenses of the first lens group G1 that is disposed closer to the object side than the movable lens group moving during changing magnification and does not move during changing magnification, the changing magnification and the focusing can be performed independently of each other. As a result, a lens configuration that is suitable for a lens for a motion picture can be adopted.

The first lens group G1 in the example of FIG. 2 consists of, in order from the object side to the image side, a first A partial group GIA that is fixed relative to the image plane Sim during focusing and has a negative refractive power, a first B partial group G1B that moves along the optical axis Z during focusing and has a positive refractive power, and a first C partial group G1C that changes a spacing to the first B partial group G1B during focusing. That is, in the example of FIG. 2, the first B partial group G1B corresponds to the focusing group. In FIG. 2, a double arrow in a horizontal direction is indicated below the group corresponding to the focusing group. In the example of FIG. 2, the first A partial group GIA consists of lenses L11 to L13, the first B partial group G1B consists of lenses L14 to L16, and the first C partial group G1C consists of lenses L17 and L18.

The movement of the focusing group, the movement of the movable lens group, and the variation in the aperture amount of the aperture stop St are performed, for example, using a driving unit (not shown) including an actuator such as a linear motor, a stepping motor, or a voice coil motor.

The focus detection unit 12 detects a position of the focusing group in the optical axis direction, and detects a focus state of the zoom lens 1 using the detected position. The focus state may be represented, for example, using a distance between a subject on which the zoom lens 1 is focused and the zoom lens 1. The focus detection unit 12 includes, for example, an encoder such as a photo interrupter and/or a magnetic sensor.

The zoom detection unit 14 detects a position of each of the movable lens groups in the optical axis direction, and detects a zoom state of the zoom lens 1 using the detected position. The zoom state refers to a state of changing magnification. Each of the wide angle end and the telephoto end is one zoom state. The zoom state may be represented, for example, using a focal length of the entire zoom lens 1. The zoom detection unit 14 includes, for example, an encoder such as a photo interrupter and/or a magnetic sensor.

The aperture detection unit 16 detects the aperture amount of the aperture stop St, and detects an aperture state of the zoom lens 1 using the detected aperture amount. The aperture state may be represented, for example, using an effective F-number of the zoom lens 1. The aperture detection unit 16 includes, for example, an encoder such as a photo interrupter and/or a magnetic sensor.

The storage unit 20 stores correction data 22. The correction data 22 is data for correcting color shading of image data obtained by capturing in the imaging apparatus body 50. The correction data 22 will be described below. The storage unit 20 is formed of, for example, a nonvolatile memory such as a flash memory.

The communication unit 30 communicates with the imaging apparatus body 50. In a state where the lens device 10 is mounted on the mount 40, the lens device 10 and the imaging apparatus body 50 are electrically connected to each other, and the communication unit 30 in the lens device 10 and a communication unit 80 in the imaging apparatus body 50 can communicate with each other due to the electrical connection. The communication unit 30 transmits each state of the lens device 10 and the correction data 22 to the imaging apparatus body 50. “Transmitting the correction data 22” is not limited to a case where the entire correction data is transmitted, and also includes a case where only a part of the correction data 22 is transmitted.

In the lens device 10, each unit is controlled by a processor (not shown) to perform various processes. The processor is formed of, for example, a microcomputer including a central processing unit (CPU), a read only memory (ROM), and a random access memory (RAM).

### Configuration of Imaging Apparatus Body

In addition to the color separation prism 60 and the imaging element 68, the imaging apparatus body 50 includes a processing unit 70, the communication unit 80, and a display unit 90.

The color separation prism 60 separates an incident luminous flux into luminous fluxes of a plurality of colors to emit the luminous fluxes. In an imaging apparatus that performs imaging using three solid-state imaging elements for red, green, and blue, an imaging luminous flux is separated into luminous fluxes of three primary colors including red, green, and blue by the color separation prism 60, and the luminous fluxes are incident into the solid-state imaging elements for the respective colors.

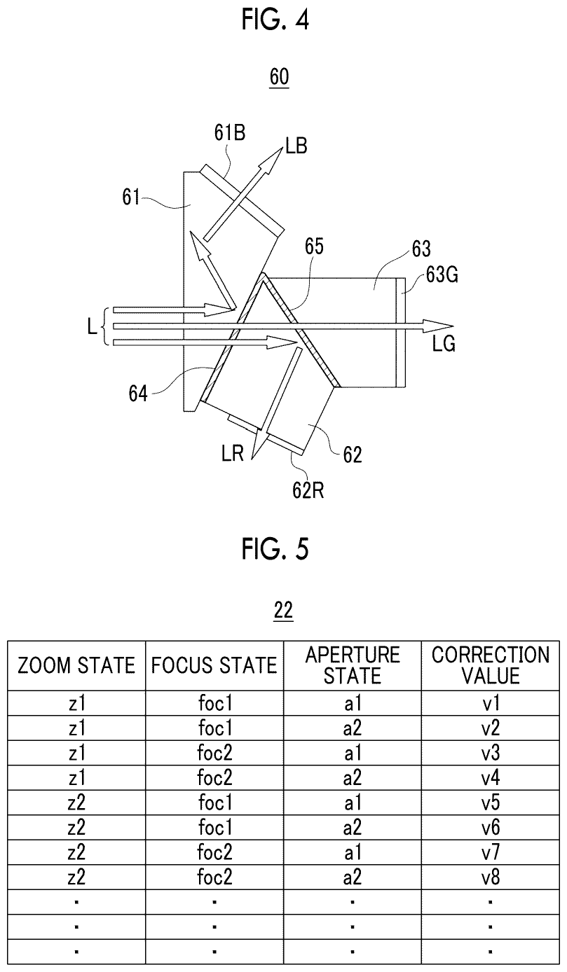

FIG. 4 is a schematic configuration diagram showing an example of the color separation prism 60. The color separation prism 60 of FIG. 4 is a three-plate color separation prism that separates an incident luminous flux L into luminous fluxes of three colors, and is an optical member having no refractive power. In the color separation prism 60, three prism members including a first prism member 61, a second prism member 62, and a third prism member 63 are disposed in this order from the light incidence side. A first optical filter 64 for color separation is formed at an interface between the first prism member 61 and the second prism member 62, and a second optical filter 65 for color separation is formed at an interface between the second prism member 62 and the third prism member 63.

In the color separation prism 60 of FIG. 4, the first optical filter 64 is provided to be inclined such that the incident luminous flux L is incident at a predetermined incidence angle, and is formed of an optical multilayer film that reflects blue light LB and allows transmission of green light LG and red light LR. The second optical filter 65 is provided to be inclined at a predetermined angle with respect to the first optical filter 64, and is formed of an optical multilayer film that reflects red light LR and allows transmission of green light LG. Each of the optical multilayer films forming the first optical filter 64 and the second optical filter 65 is a film where two or more kinds of optical films having different refractive indices are alternately laminated.

A blue light transmissive filter 61B that allows transmission of only the blue light LB is provided on a light emission surface of the first prism member 61. A red light transmissive filter 62R that allows transmission of only the red light LR is provided on a light emission surface of the second prism member 62. A green light transmissive filter 63G that allows transmission of only the green light LG is provided on a light emission surface of the third prism member 63.

The incident luminous flux L is incident into the first prism member 61, the blue light LB is reflected from the first optical filter 64, and the green light LG and the red light LR transmit through the first optical filter 64. The blue light LB reflected from the first optical filter 64 is totally reflected from an incident surface of the first prism member 61, and is emitted to the solid-state imaging element for blue light (not shown) through the blue light transmissive filter 61B.

The red light LR transmitted through the first optical filter 64 is reflected from the second optical filter 65, and is emitted to the solid-state imaging element for red light (not shown) through the red light transmissive filter 62R. The green light LG transmitted through the first optical filter 64 transmits through the second optical filter 65, and is emitted to the solid-state imaging element for green light (not shown) through the green light transmissive filter 63G.

For easy understanding in FIG. 4, the incident luminous flux L into the color separation prism 60 is schematically indicated by three arrows traveling in the horizontal direction. However, an actual imaging luminous flux passed through the zoom lens 1. Therefore, the imaging luminous flux incident into the color separation prism 60 includes not only a ray perpendicular to the incident surface but also rays incident at various incidence angles.

In general, the optical multilayer film has incidence angle dependence, and as the incidence angle increases, spectral characteristics tend to be shifted to a shorter wavelength side. In addition, as the incidence angle increases, the value of transmittance tends to decrease. Accordingly, there is a difference in the amount of light reflected or transmitted between light incident into the optical multilayer film at a high incidence angle and light incident into the optical multilayer film at a low incidence angle. The first optical filter 64 and the second optical filter 65 are formed of the optical multilayer film. Therefore, in the light passed through the color separation prism 60, due to the above-described incidence angle dependence, a phenomenon called “color shading” in which the tone of a captured image varies in an up-down direction of a screen occurs. “The up-down direction of the screen” of the present specification refers to a direction perpendicular to the optical axis.

In particular, the green light LG transmits through the two optical filters of the first optical filter 64 and the second optical filter 65 to be separated. Therefore, the angle dependence of the amount of light of the green light LG is stronger than the blue light LB and the red light LR. As a result, for example, in a peripheral portion of the screen of the captured image, green increases, and red and blue decrease. In particular, the green light has a strong effect on the luminance, the luminance is high in a portion where the amount of green light transmitted is large, and the luminance is low in a portion where the amount of green light transmitted is small. This also causes a phenomenon called “luminance shading” in which the luminance of a screen varies in the up-down direction to occur.

In the imaging apparatus body 50, the imaging luminous flux passed through the color separation prism 60 is incident into the imaging element 68. An image plane of the imaging element 68 is disposed at a position of the image plane Sim of the zoom lens 1. The imaging element 68 captures an image formed by the zoom lens 1, generates image data by the capturing, and outputs the image data to the processing unit 70. For example, a solid-state imaging element such as a charge coupled device (CCD) or a complementary metal oxide semiconductor (CMOS) can be used as the imaging element 68.

The processing unit 70 processes a signal output from the imaging element 68, and generates image data for output. In addition, in a case where the image data for output is generated, the processing unit 70 performs a process of correcting color shading of the image data based on the correction data 22 transmitted from the lens device 10 and acquired through the communication unit 80.

The communication unit 80 communicates with the communication unit 30 of the lens device 10. The correction data 22 transmitted from the lens device 10 to the imaging apparatus body 50 through the communication unit 30 is received by the communication unit 80 and transmitted to the processing unit 70.

The display unit 90 displays the image data for output generated by the processing unit 70. The display unit 90 is formed of, for example, a liquid crystal monitor.

The imaging apparatus body 50 includes an operation unit (not shown) that receives an operation input of a user. The operation unit includes, for example, a zoom button, a release button, a dial, a cross-key type or control-wheel type selection button, and a touch panel provided on a display.

In the imaging apparatus body 50, each unit is controlled by a processor (not shown) to perform various processes. The processor is formed of, for example, a microcomputer including a central processing unit (CPU), a read only memory (ROM), and a random access memory (RAM). The processing unit 70 may be formed as a part of the processor.

### Correction Data

The correction data 22 has a correction value that is set for each combination of a zoom state, a focus state, and an aperture state of the zoom lens 1. That is, the correction data 22 includes a plurality of combinations of the zoom state, the focus state, and the aperture state, and one corresponding correction value is set for each of the combinations. This configuration is advantageous in suppressing the size of the correction data 22.

The correction data 22 may be stored as table data. For example, FIG. 5 shows an example of the correction data 22 stored as the table data. The correction data 22 of FIG. 5 has correction values v1, v2, v3, . . . that are set for respective combinations of zoom states z1, z2, . . . , focus states foc1 and foc2, and aperture states a1 and a2.

In order to suitably obtain the effect of correcting color shading while suppressing the size of the correction data 22, it is preferable to satisfy at least one of Conditional Expression (2), (3), or (4) is satisfied. Here, in groups of each of the combinations in the correction data 22, the number of the zoom states is represented by Nz, the number of the focus states is represented by Nf, and the number of the aperture states is represented by Na.

$$0.05 \leq Nf / ( Nz \times Na ) \leq 0.3 \qquad ( 2 )$$

$$8 \leq ( Nz \times Nf ) / Na \leq 256 \qquad ( 3 )$$

$$256 \leq Nz \times Nf \times Na \leq 2048 \qquad ( 4 )$$

By setting the corresponding value of Conditional Expression (2) not to be the lower limit value or less, the number of the focus states in the correction data 22 can be ensured. Therefore, in a case where color shading caused by a change in the focus state is corrected, the insufficient correction can be easily prevented. By setting the corresponding value of Conditional Expression (2) not to be the upper limit value or more, the proportion of the number of the focus states in the correction data 22 is not excessively large. Therefore, in a case where color shading caused by a change in the zoom state and the aperture state is corrected, the insufficient correction can be easily prevented.

In order to obtain more favorable characteristics, the lower limit value of Conditional Expression (2) is more preferably 0.0625, still more preferably 0.1, and even more preferably 0.125. In order to obtain more favorable characteristics, it is more preferable that the upper limit value of Conditional Expression (2) is 0.25. For example, instead of Conditional Expression (2), it is more preferable that Conditional Expression (2-1) is satisfied, it is still more preferable that Conditional Expression (2-2) is satisfied, and it is still more preferable that Conditional Expression (2-3) is satisfied.

$$0.0625 \leq Nf / ( Nz \times Na ) \leq 0.25 \qquad ( 2 - 1 )$$

$$0.1 \leq Nf / ( Nz \times Na ) \leq 0.25 \qquad ( 2 - 2 )$$

$$0.12 5 \leq Nf / ( Nz \times Na ) \leq 0.25 \qquad ( 2 - 3 )$$

By setting the corresponding value of Conditional Expression (3) not to be the lower limit value or less, the proportion of the number of the aperture states in the correction data 22 is not excessively large. Therefore, in a case where color shading caused by a change in the zoom state and the focus state is corrected, the insufficient correction can be easily prevented. By setting the corresponding value of Conditional Expression (3) not to be the upper limit value or more, the number of the aperture states in the correction data 22 can be ensured. Therefore, in a case where color shading caused by a change in the aperture state is corrected, the insufficient correction can be easily prevented.

In order to obtain more favorable characteristics, the lower limit value of Conditional Expression (3) is more preferably 16, still more preferably 20, still more preferably 24, and still more preferably 32. In order to obtain more favorable characteristics, the upper limit value of Conditional Expression (3) is more preferably 128 and still more preferably 64. For example, instead of Conditional Expression (3), it is more preferable that Conditional Expression (3-1) is satisfied, it is still more preferable that Conditional Expression (3-2) is satisfied, it is still more preferable that Conditional Expression (3-3) is satisfied, and it is still more preferable that Conditional Expression (3-4) is satisfied.

$$16 \leq ( N z \times Nf ) / Na \leq 128 \qquad ( 3 - 1 )$$

$$20 \leq ( N z \times Nf ) / Na \leq 128 \qquad ( 3 - 2 )$$

$$24 \leq ( N z \times Nf ) / Na \leq 128 \qquad ( 3 - 3 )$$

$$32 \leq ( N z \times Nf ) / Na \leq 64 \qquad ( 3 - 4 )$$

It is preferable that the lens device 10 simultaneously satisfies Conditional Expressions (2) and (3). A change in the incidence angle of the ray with respect to the image plane occurs due to a change in each state of the zoom lens 1, and is more largely affected by a change in the zoom state, a change in the focus state, and a change in the aperture state in this order. By simultaneously satisfying Conditional Expressions (2) and (3), the number of the focus states and the number of the aperture states can be set in suitable ranges. Therefore, color shading can be effectively corrected while suppressing the size of the correction data 22.

By setting the corresponding value of Conditional Expression (4) not to be the lower limit value or less, the insufficient correction of color shading can be easily prevented. By setting the corresponding value of Conditional Expression (4) not to be the upper limit value or more, an excessive increase in the size of the correction data 22 can be suppressed. By satisfying Conditional Expression (4), color shading can be effectively corrected while suppressing the size of the correction data 22.

In order to obtain more favorable characteristics, the lower limit value of Conditional Expression (4) is more preferably 320, still more preferably 384, and still more preferably 448. In order to obtain more favorable characteristics, the upper limit value of Conditional Expression (4) is more preferably 1600, still more preferably 1296, and still more preferably 1024. For example, instead of Conditional Expression (4), it is more preferable that Conditional Expression (4-1) is satisfied, it is still more preferable that Conditional Expression (4-2) is satisfied, and it is still more preferable that Conditional Expression (4-3) is satisfied.

$$320 \leq Nz \times Nf \times Na \leq 1600 \qquad ( 4 - 1 )$$

$$384 \leq Nz \times Nf \times Na \leq 1296 \qquad ( 4 - 2 )$$

$$448 \leq Nz \times Nf \times Na \leq 1024 \qquad ( 4 - 3 )$$

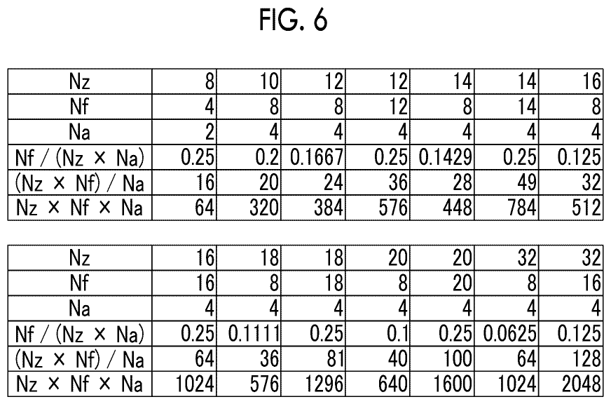

FIG. 6 shows examples of Nz, Nf, and Na in the group of each of the combinations and the corresponding values of Conditional Expressions (2), (3), and (4) calculated from these examples.

It is preferable that the correction value in the correction data 22 is a value at a predetermined image height. Hereinafter, the predetermined image height will be referred to as “specific image height”. In a case where a focal length and a maximum half angle of view of the zoom lens 1 in each zoom state are represented by f and ω, respectively, and a unit of f is millimeters (mm), “specific image height” in the present disclosure is defined by 0.49×f×tan ω. It is preferable that the specific image height satisfies Conditional Expression (1) below.

$$1.5 mm < 0.49 \times f \times tan ω < 5 mm \qquad ( 1 )$$

By setting the corresponding value of Conditional Expression (1) not to be the lower limit value or less, the insufficient correction of color shading can be easily prevented. By setting the corresponding value of Conditional Expression (1) not to be the upper limit value or more, the excessive correction of color shading can be easily prevented. By satisfying Conditional Expression (1), color shading in the up-down direction of a screen of a captured image can be effectively corrected easily.

In order to obtain more favorable characteristics, the lower limit value of Conditional Expression (1) is more preferably 1.7 mm, still more preferably 1.9 mm, and still more preferably 2.1 mm. In order to obtain more favorable characteristics, the upper limit value of Conditional Expression (1) is more preferably 3.5 mm, still more preferably 3.2 mm, and even more preferably 3 mm. For example, instead of Conditional Expression (1), it is more preferable that Conditional Expression (1-1) is satisfied, it is still more preferable that Conditional Expression (1-2) is satisfied, and it is still more preferable that Conditional Expression (1-3) is satisfied.

$$1.7 mm < 0.49 \times f \times tan ω < 3.5 mm \qquad ( 1 - 1 )$$

$$1.9 mm < 0.49 \times f \times tan ω < 3.2 mm \qquad ( 1 - 2 )$$

$$2.1 mm < 0.49 \times f \times tan ω < 3 mm \qquad ( 1 - 3 )$$

Specifically, the correction value may be set as, for example, a distance on the optical axis between an exit pupil position of a ray incident at the specific image height of the image plane Sim and the image plane Sim. There are many rays incident at the specific image height. Among the rays, a principal ray (that is, a ray passing through the center of the aperture stop St) may be used, a ray passing through the center position of gravity of a spot diagram may be used, or a middle ray described below may be used.

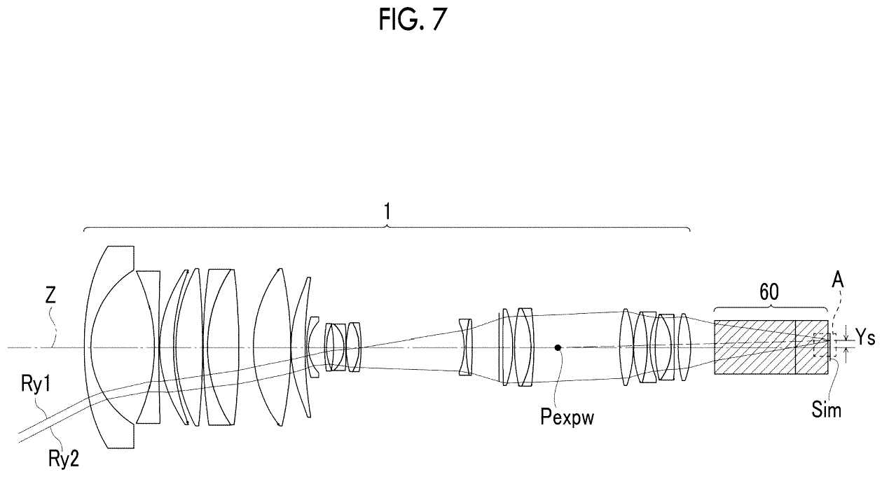

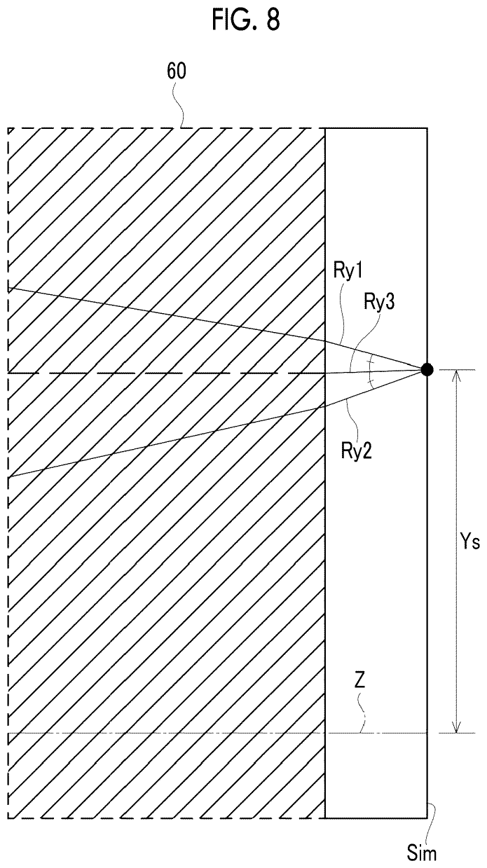

In the present specification, for convenience of description, a ray that is incident at a bisected angle of an angle between an upper ray and a lower ray among the rays that are incident at the specific image height will be referred to as “middle ray”. The middle ray will be described with reference to FIGS. 7 and 8.

FIG. 7 shows an upper ray Ry1 and a lower ray Ry2 incident at a specific image height Ys in a state where an infinite distance object is in focus at the wide angle end of the zoom lens 1 shown in FIG. 2. The upper ray Ry1 is a ray that includes the optical axis Z and is farthest from the optical axis Z in one cross section among the rays incident at the specific image height Ys, and the lower ray Ry2 is a ray that includes the optical axis Z and is closest to the optical axis Z in the same cross section among the rays incident at the specific image height Ys. “Farthest from the optical axis Z” and “closest to the optical axis Z” are determined in the vicinity of the image plane Sim of the zoom lens 1.

In FIG. 7, a region A in the vicinity of the image plane Sim is indicated by a broken line, and FIG. 8 is an enlarged view showing the region A. In FIGS. 7 and 8, for easy understanding, a diagonal line is added to the color separation prism 60. FIG. 8 shows a middle ray Ry3 incident at an angle obtained by bisecting an angle between the upper ray Ry1 and the lower ray Ry2. That is, an angle between the upper ray Ry1 and the middle ray Ry3 is the same as an angle between the lower ray Ry2 and the middle ray Ry3. For example, FIG. 7 shows an exit pupil position Pexpw of the middle ray Ry3.

In the present disclosed technology, rays that are used for setting the correction value are not limited to the rays that are incident at the specific image height. For example, the correction value may be a distance from the image plane Sim to the paraxial exit pupil position. In addition, it is preferable that the value that can be used as the correction value is appropriately determined depending on required specifications and the like. For example, the correction value may be an incidence angle of a ray incident into the image plane. Even in a case where the correction value is an incidence angle of a ray incident into the image plane, the ray may be a principal ray at the specific image height, may be a ray passing through the center position of gravity of a spot diagram of the luminous fluxes incident at the specific image height, or may be the above-described middle ray.

Further, the correction value is not limited to an actual value such as an actual distance or an actual angle, and a value converted from an actual value may be used. Examples of the conversion include proportional conversion, exponential conversion, number base conversion, 8-bit conversion, and 16-bit conversion.

### Operation Examples

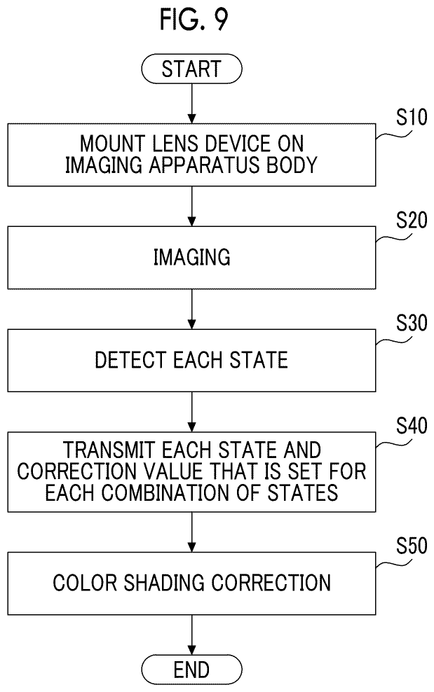

Next, an example of the operation according to the present embodiment will be described with reference to a flowchart of FIG. 9.

In Step S10, the lens device 10 is mounted on the imaging apparatus body 50. Optionally, a user operates an operation unit (not shown) provided in the imaging apparatus body 50 and/or the lens device 10 to change the zoom state, the focus state, and/or the aperture state of the zoom lens 1.

In Step S20, the user images a subject using the zoom lens 1. The imaging element 68 captures an image formed by the zoom lens 1 to generate image data, and outputs the image data to the processing unit 70.

In Step S30, the detection units of the lens device 10 detects the states during the imaging, respectively. That is, the focus detection unit 12 detects the focus state, the zoom detection unit 14 detects the zoom state, and the aperture detection unit 16 detects the aperture state.

In Step S40, the lens device 10 transmits each of the focus state, the zoom state, and the aperture state that are detected to the imaging apparatus body 50 through the communication unit 30. In addition, the lens device 10 acquires one correction value that is set for the combination of the detected states from the storage unit 20, and transmits the correction value to the imaging apparatus body 50 through the communication unit 30. The processing unit 70 of the imaging apparatus body 50 receives the respective states and the correction value through the communication unit 30 and the communication unit 80.

In Step S50, the processing unit 70 performs the color shading correction of the image data based on the received correction value to generate image data for output, and outputs the image data for output to the display unit 90. The display unit 90 displays the image data for output.

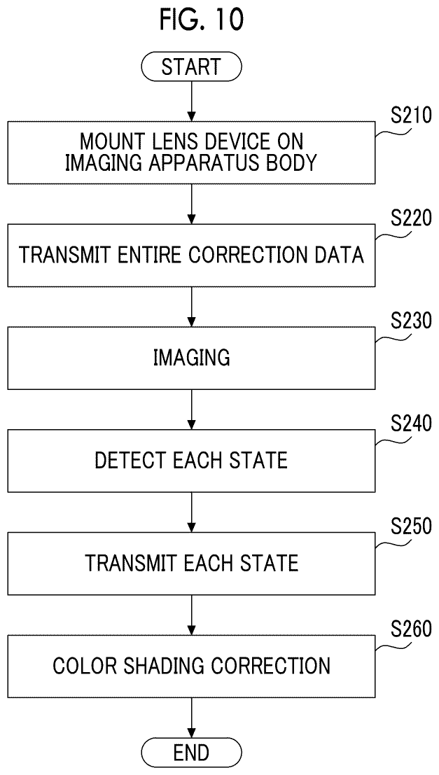

In Step S40 of the above-described operation, the lens device 10 transmits one correction value corresponding to the combination of the detected states. However, the present disclosed technology is not limited to the above-described example. For example, the lens device 10 may transmit all the correction values before detecting each of the states. Another example of the operation different from that of FIG. 9 will be described with reference to a flowchart of FIG. 10.

In Step S210, the lens device 10 is mounted on the imaging apparatus body 50. Optionally, a user operates an operation unit (not shown) provided in the imaging apparatus body 50 and/or the lens device 10 to change the zoom state, the focus state, and/or the aperture state of the zoom lens 1.

In Step S220, the lens device 10 transmits all the correction data 22 for color shading correction to the imaging apparatus body 50 through the communication unit 30. The processing unit 70 of the imaging apparatus body 50 receives the correction data 22 through the communication unit 30 and the communication unit 80.

In Step S230, the user images a subject using the zoom lens 1. The imaging element 68 captures an image formed by the zoom lens 1 to generate image data, and outputs the image data to the processing unit 70.

In Step S240, the detection units of the lens device 10 detects the states during the imaging, respectively. That is, the focus detection unit 12 detects the focus state, the zoom detection unit 14 detects the zoom state, and the aperture detection unit 16 detects the aperture state.

In Step S250, the lens device 10 transmits each of the focus state, the zoom state, and the aperture state that are detected to the imaging apparatus body 50 through the communication unit 30. The processing unit 70 of the imaging apparatus body 50 receives the respective states of the zoom lens 1 through the communication unit 30 and the communication unit 80.

In Step S260, the processing unit 70 reads a correction value that is set for the combination of the received states from the correction data 22 received in Step S220, performs the color shading correction of the image data based on the read correction value to generate image data for output, and outputs the image data for output to the display unit 90. The display unit 90 displays the image data for output.

Since the value of each of the states in the correction data is discrete, there is a case where the value of the detected state does not match with the value of each of the states in the correction data. In this case, among the values in the correction data, the closest value may be used instead. Alternatively, a correction value may be generated by interpolation processing to perform color shading correction based on the generated correction value.

### Configuration of Zoom Lens

Next, a preferable configuration and a possible configuration of the zoom lens used in the present disclosed technology will be described. In the following description, “specific image height” is the above-described image height defined by 0.49×f×tan ω. In the following description, in order to avoid redundant description, the same symbol will be used for the same definition, and the duplicate description of the symbol will be omitted.

It is preferable that, in a state where the zoom lens is focused on an infinite distance object, in an entire zoom range, the exit pupil position of the principal ray at the specific image height is positioned closer to the image side than the image plane. This configuration is a feature generated by a lens configuration suitable for a lens for a motion picture adopted in an imaging optical system including a three-plate color separation prism, which is advantageous in correcting color shading.

In a case where a distance from the image plane of the zoom lens to the exit pupil position of the middle ray is represented by Dexp, a focal length of the zoom lens at the telephoto end is represented by ft, and a focal length of the zoom lens at the wide angle end is represented by fw, it is preferable that the zoom lens is formed as follows. It is preferable that Dexp of the zoom lens at the wide angle end is negative, Dexp of the zoom lens at the telephoto end is positive, and a focal length of the zoom lens in a state where Dexp is infinite is in a range of fw×(ft/fw)^{0.6} or more and fw×(ft/fw)^{0.9} or less. A sign of Dexp is positive for a distance on the image side and is negative for a distance on the object side with respect to the image plane of the zoom lens. In addition, Dexp, ft, and fw are values in a state where the zoom lens is focused on the infinite distance object. As described above, the value of Dexp is negative at the wide angle end, is infinite in the middle range, and is positive at the telephoto end. As a result, in the entire zoom range, the absolute value of Dexp can be increased. Thus, the incidence angle of the ray that is incident from the zoom lens 1 into the color separation prism 60 can be further reduced easily, which is advantageous in correcting color shading.

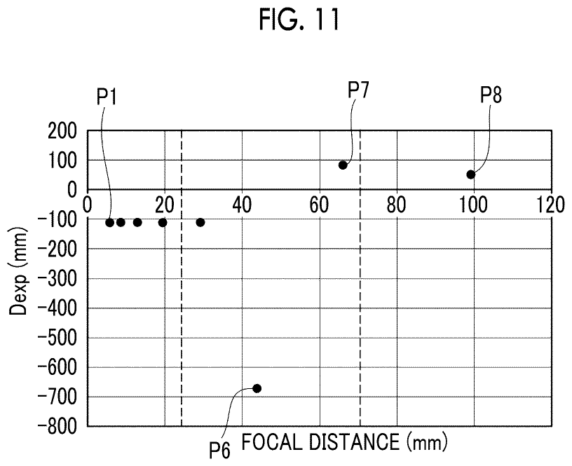

For example, FIG. 11 shows a relationship between a focal length of a zoom lens according to Example 1 described below and Dexp. In FIG. 11, the horizontal axis represents the focal length, the vertical axis represents Dexp, the units of the horizontal axis and the vertical axis are millimeters (mm), and data of Example 1 of Table 27 described below is plotted. In FIG. 11, a plot P1 represents a value at the wide angle end, and a plot P8 represents a value at the telephoto end. In FIG. 11, the focal length corresponding to fw×(ft/fw)^{0.6} and the focal length corresponding to fw×(ft/fw)^{0.9} are indicated by broken lines. A range interposed between the two broken lines of FIG. 11 is the range of the focal length of fw×(ft/fw)^{0.6} or more and fw×(ft/fw)^{0.9} or less, and a plot P6 and a plot P7 are present in this range. Dexp of the plot P6 is a negative value, and Dexp of the plot P7 is a positive value. In Example 1 described below, a focal length where Dexp is infinite is present between the focal length of the plot P6 and the focal length of the plot P7.

In a case where a distance from the image plane of the zoom lens in a state where an infinite distance object at the wide angle end is in focus to the exit pupil position of the middle ray is represented by Dexpw, it is preferable that the zoom lens satisfies Conditional Expression (8). In a case where an optical member having no refractive power is disposed between the image plane Sim and the exit pupil position of the middle ray, Dexpw of the optical member is calculated using an air conversion distance. By setting the corresponding value of Conditional Expression (8) not to be the lower limit value or less, this configuration is advantageous in reducing the incidence angle of the ray incident into the image plane. Therefore, an optical system that is suitable for an imaging optical system including a three-plate color separation prism can be obtained. By setting the corresponding value of Conditional Expression (8) not to be the upper limit value or more, the total length of the optical system can be easily reduced, which is advantageous in reducing the size.

$$4 < \vert Dexpw / fw \vert < 360 \qquad ( 8 )$$

In order to obtain more favorable characteristics, the lower limit value of Conditional Expression (8) is more preferably 6, still more preferably 8, and still more preferably 10. In order to obtain more favorable characteristics, the upper limit value of Conditional Expression (8) is more preferably 200, still more preferably 100, and still more preferably 50. For example, instead of Conditional Expression (8), it is more preferable that Conditional Expression (8-1) is satisfied, it is still more preferable that Conditional Expression (8-2) is satisfied, and it is still more preferable that Conditional Expression (8-3) is satisfied.

$$6 < \vert Dexpw / fw \vert < 200 \qquad ( 8 - 1 )$$

$$8 < \vert Dexpw / fw \vert < 100 \qquad ( 8 - 2 )$$

$$10 < \vert Dexpw / fw \vert < 50 \qquad ( 8 - 3 )$$

In a case where an open F-number of the zoom lens in a state where an infinite distance object at the telephoto end is in focus is represented by Fnot, it is preferable that the zoom lens satisfies Conditional Expression (5). By setting the corresponding value of Conditional Expression (5) not to be the lower limit value or less, this configuration is advantageous in reducing the size of the entire optical system or facilitates to suppress various aberrations particularly at the telephoto end. By setting the corresponding value of Conditional Expression (5) not to be the upper limit value or more, a sufficient brightness can be easily obtained at the telephoto end or a high-magnification optical system can be obtained.

$$0.03 < FNot / ( f t / fw ) < 0.3 \qquad ( 5 )$$

In order to obtain more favorable characteristics, the lower limit value of Conditional Expression (5) is more preferably 0.04 and still more preferably 0.05. In order to obtain more favorable characteristics, the upper limit value of Conditional Expression (5) is more preferably 0.25 and still more preferably 0.2. For example, instead of Conditional Expression (5), it is more preferable that Conditional Expression (5-1) is satisfied, and it is still more preferable that Conditional Expression (5-2) is satisfied.

$$0.04 < FNot / ( f t / fw ) < 0 \text{.25} \qquad ( 5 - 1 )$$

$$0.05 < FNot / ( f t / fw ) < 0.2 \qquad ( 5 - 2 )$$

In a case where a focal length of a lens group that has a strongest negative refractive power among lens groups that have a negative refractive power and move during changing magnification in the zoom lens is represented by fn, it is preferable that the zoom lens satisfies Conditional Expression (6). By setting the corresponding value of Conditional Expression (6) not to be the lower limit value or less, a sufficient refractive power for changing magnification can be ensured, which is advantageous in obtaining a high-magnification optical system. By setting the corresponding value of Conditional Expression (6) not to be the upper limit value or more, this configuration is advantageous for suppressing various aberrations particularly at the telephoto end.

$$- 0.4 < fn / f t < - 0.02 \qquad ( 6 )$$

In order to obtain more favorable characteristics, the lower limit value of Conditional Expression (6) is more preferably −0.35 and still more preferably −0.3. In order to obtain more favorable characteristics, the upper limit value of Conditional Expression (6) is more preferably −0.03 and still more preferably −0.04. For example, instead of Conditional Expression (6), it is more preferable that Conditional Expression (6-1) is satisfied, and it is still more preferable that Conditional Expression (6-2) is satisfied.

$$- 0.35 < fn / f t < - 0.03 \qquad ( 6 - 1 )$$

$$- 0.3 < fn / f t < - 0.04 \qquad ( 6 - 2 )$$

In a case where a back focus of the zoom lens in terms of an air conversion distance is represented by Bfw, and a maximum half angle of view of the zoom lens in a state where the infinite distance object at the wide angle end is in focus is represented by ωw, It is preferable that the zoom lens satisfies Conditional Expression (7). By setting the corresponding value of Conditional Expression (7) not to be the lower limit value or less, the back focus is not excessively short. Therefore, an optical system that is suitable for an imaging optical system including a three-plate color separation prism can be obtained. By setting the corresponding value of Conditional Expression (7) not to be the upper limit value or more, the back focus is not excessively long, which is advantageous in reducing the size.

$$4 < Bfw / ( f w \times tan ω w ) < 10 \qquad ( 7 )$$

In order to obtain more favorable characteristics, the lower limit value of Conditional Expression (7) is more preferably 4.5 and still more preferably 5. In order to obtain more favorable characteristics, an upper limit value of Conditional Expression (7) is more preferably 9 and still more preferably 8. For example, instead of Conditional Expression (7), it is more preferable that Conditional Expression (7-1) is satisfied, and it is still more preferable that Conditional Expression (7-2) is satisfied.

$$4.5 < Bfw / ( fw \times tan ω w ) < 9 \qquad ( 7 - 1 )$$

$$5 < Bfw / ( fw \times tan ω w ) < 8 \qquad ( 7 - 2 )$$

The zoom lens may consist of, in order from the object side to the image side, a first lens group that has a positive refractive power, a second lens group that has a negative refractive power and moves during changing magnification, one or more and three or less lens groups that move while changing a spacing to an adjacent lens group during changing magnification, and a final lens group that has a positive refractive power. This configuration is a lens configuration suitable for a high-magnification lens for a motion picture adopted in an imaging optical system including a three-plate color separation prism, which is advantageous in correcting color shading.

The zoom lens may consist of, in order from the object side to the image side, a first lens group that has a positive refractive power, a second lens group that has a negative refractive power, a third lens group that has a negative refractive power, and a final lens group that has a positive refractive power, and the second lens group and the third lens group may move while changing a mutual spacing during changing magnification. This configuration is a lens configuration suitable for a high-magnification lens for a motion picture that is adopted in an imaging optical system including a three-plate color separation prism and where a focal length at the wide angle end is close to a wide angle, which is advantageous in correcting color shading.

The zoom lens may consist of, in order from the object side to the image side, a first lens group that has a positive refractive power, a second lens group that has a negative refractive power, a third lens group that has a negative refractive power, a fourth lens group that has a positive refractive power, and a final lens group that has a positive refractive power, and the second lens group, the third lens group, and the fourth lens group may move while changing a spacing to an adjacent lens group during changing magnification. This configuration is a lens configuration suitable for a high-magnification lens for a motion picture that is adopted in an imaging optical system including a three-plate color separation prism and where a focal length at the wide angle end is close to a standard, which is advantageous in correcting color shading.

The zoom lens may consist of, in order from the object side to the image side, a first lens group that has a positive refractive power, a second lens group that has a negative refractive power, a third lens group that has a positive refractive power, a fourth lens group that has a positive refractive power, and a final lens group that has a positive refractive power, and the second lens group, the third lens group, and the fourth lens group may move while changing a spacing to an adjacent lens group during changing magnification. This configuration is a lens configuration suitable for a high-magnification lens for a motion picture that is adopted in an imaging optical system including a three-plate color separation prism and where a focal length at the wide angle end is close to a wide angle and a focal length at the telephoto end is super-telephoto, which is advantageous in correcting color shading.

The zoom lens may consist of, in order from the object side to the image side, a first lens group that has a positive refractive power, a second lens group that has a negative refractive power, a third lens group that has a negative refractive power, a fourth lens group that has a negative refractive power, a fifth lens group that has a negative refractive power, and a final lens group that has a positive refractive power, and the second lens group, the third lens group, the fourth lens group, and the fifth lens group may move while changing a spacing to an adjacent lens group during changing magnification. This configuration is a lens configuration suitable for a high-magnification lens for a motion picture that is adopted in an imaging optical system including a three-plate color separation prism and where a focal length at the wide angle end is close to a standard, which is advantageous in correcting color shading.

The zoom lens may consist of, in order from the object side to the image side, a first lens group that has a positive refractive power, a second lens group that has a negative refractive power, a third lens group that has a positive refractive power, a fourth lens group that has a negative refractive power, a fifth lens group that has a positive refractive power, and a final lens group that has a positive refractive power, and the second lens group, the third lens group, the fourth lens group, and the fifth lens group may move while changing a spacing to an adjacent lens group during changing magnification. This configuration is a lens configuration suitable for a high-magnification lens for a motion picture that is adopted in an imaging optical system including a three-plate color separation prism and where a focal length at the wide angle end is close to a standard, which is advantageous in correcting color shading.

The zoom lens may consist of, in order from the object side to the image side, a first lens group that has a positive refractive power, a second lens group that has a negative refractive power, a third lens group that has a negative refractive power, a fourth lens group that has a negative refractive power, a fifth lens group that has a negative refractive power, and a final lens group that has a positive refractive power, and the second lens group, the third lens group, the fourth lens group, and the fifth lens group may move while changing a spacing to an adjacent lens group during changing magnification. This configuration is a lens configuration suitable for a high-magnification lens for a motion picture that is adopted in an imaging optical system including a three-plate color separation prism and where a focal length at the wide angle end is close to a standard and the magnification is 40-fold, which is advantageous in correcting color shading.

In the present specification, one lens group is a group of which a spacing to an adjacent group in an optical axis direction changes during changing magnification. During changing magnification, a spacing between adjacent lenses does not change in one lens group. That is, “lens group” is a component part of the zoom lens, and is a part including at least one lens divided by an air spacing that changes during changing magnification. During changing magnification, the lens group moves or is fixed in each lens group unit. “Lens group” may include a component having no refractive power other than a lens, for example, an aperture stop.

The aperture stop may be disposed closest to the object side of the final lens group, or may be provided in the movable lens group.

The first lens group may consist of, in order from the object side to the image side, a first A partial group that is fixed relative to the image plane during focusing and has a negative refractive power, a first B partial group that moves along the optical axis Z during focusing and has a positive refractive power, and a first C partial group G1C that moves while changing a mutual spacing to the first B partial group G1B during focusing.

The preferable configurations and available configurations including the configurations regarding the conditional expressions can be freely combined within a range where they do not contradict each other, and it is preferable to appropriately selectively adopt the combination according to required specifications.

### Second Embodiment

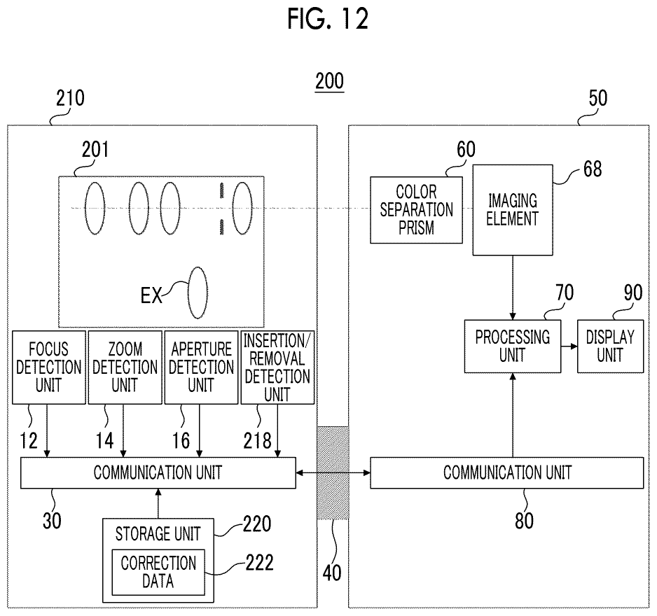

FIG. 12 is a functional configuration diagram showing an imaging apparatus 200 according to a second embodiment of the present disclosure. The second embodiment is largely different from the first embodiment, in that the zoom lens includes an EX group EX that is insertable into and removable from the optical path of the zoom lens, and the lens device includes an insertion/removal detection unit that detects the insertion and removal of the EX group EX. In the following description regarding the second embodiment, different points from the first embodiment will be described, and the same configurations as those of the first embodiment will be omitted.

The imaging apparatus 200 includes a lens device 210 and the imaging apparatus body 50. The lens device 210 is attachable to and detachable from the imaging apparatus body 50, and is mountable on the imaging apparatus body 50 through a mount 40 provided in the imaging apparatus body 50.

The lens device 210 includes a zoom lens 201, the focus detection unit 12, the zoom detection unit 14, the aperture detection unit 16, an insertion/removal detection unit 218, a storage unit 220, and the communication unit 30.

The zoom lens 201 functions as an imaging lens to form the image of the subject. FIG. 12 schematically shows the zoom lens 201. The zoom lens 201 may include, for example, the zoom lens 1 according to the first embodiment and the EX group EX that is insertable into and removable from the optical path of the zoom lens 1. A focal length of the zoom lens 201 changes depending on the insertion and removal of the EX group EX.

For example, by being inserted into the optical path, the EX group EX can be formed as an extender lens that can increase the focal length of the lens system after the insertion as compared to the lens system before the insertion. It is preferable that an imaging position is kept constant even after the insertion and removal of the EX group EX. A maximum image height may be kept constant even after the insertion and removal of the EX group EX, or may change depending on the insertion and removal of the EX group EX. “Being kept constant” described herein includes being kept constant with error that is generally allowable in the field to which the present disclosed technology belongs.

The insertion/removal detection unit 218 detects a state of the insertion and removal of the EX group EX.

The storage unit 220 stores correction data 222. The correction data 222 is data for correcting color shading of image data obtained by capturing in the imaging apparatus body 50. The correction data 222 has one correction value that is set for each of a plurality of combinations of the zoom state, the focus state, and the aperture state of the zoom lens 1, and this correction value is set depending on the state of the insertion and removal of the EX group EX. The incidence angle of a ray used for imaging into the image plane varies depending on the insertion and removal state of the EX group EX. Therefore, the correction data 222 has a unique correction value for each of the states of the insertion and removal of the EX group EX, and more accurate correction can be performed by switching the correction value based on the insertion and removal state.

It can be considered that the correction data 222 according to the second embodiment is the same as the correction data 22 according to the first embodiment, except that the correction value is set depending on the state of the insertion and removal of the EX group EX. That is, it can be considered that a preferable configuration and a possible configuration regarding the correction value of the second embodiment are the same as those regarding the correction value according to the first embodiment.

In the second embodiment, in a case where each of the states of the zoom lens is transmitted from the lens device 210 to the imaging apparatus body 50, the zoom state, the focus state, the aperture state, and the state of the insertion and removal of the EX group EX are transmitted. The processing unit 70 of the imaging apparatus body 50 performs the color shading correction based on the correction value that is set for the combination of the zoom state, the focus state, the aperture state, and the state of the insertion and removal of the EX group EX.

### EXAMPLES OF ZOOM LENS

Next, examples of the zoom lens according to the present disclosure will be described with reference to the drawings. The reference numerals added to the groups in the cross-sectional views of each example are used independently for each example in order to avoid complication of description and drawings due to an increase in number of digits of the reference numerals. Therefore, even in a case where common reference numerals are added in the drawings of different examples, components do not necessarily have a common configuration.

### Example 1

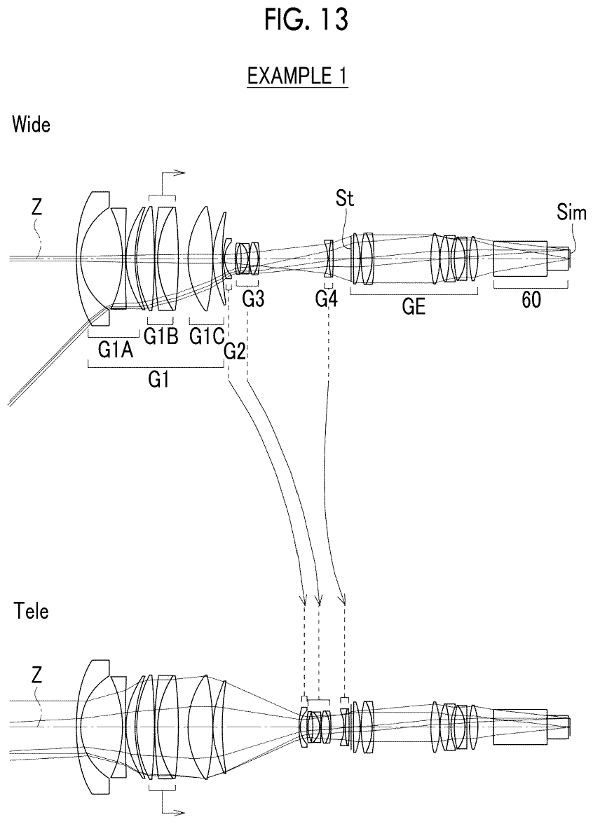

FIG. 13 shows a cross-sectional view showing a configuration of the zoom lens according to Example 1 and movement loci thereof. In FIG. 13, the upper stage to which “Wide” is attached shows a wide angle end state, and the lower stage to which “Tele” is added shows a telephoto end state. Regarding each lens group that moves during changing magnification, a schematic movement locus during changing magnification from the wide angle end to the telephoto end is indicated by a solid line arrow between the upper stage diagram and the lower stage diagram. As luminous fluxes, FIG. 13 shows an on-axis luminous flux and a luminous flux having a maximum half angle of view at the wide angle end, and an on-axis luminous flux and a luminous flux having a maximum half angle of view at the telephoto end. The zoom lens according to Example 1 consists of, in order from the object side to the image side, a first lens group G1 that has a positive refractive power, a second lens group G2 that has a negative refractive power, a third lens group G3 that has a negative refractive power, a fourth lens group G4 that has a negative refractive power, and a final lens group GE that has a positive refractive power.

The first lens group G1 consists of a first A partial group GIA, a first B partial group G1B, and a first C partial group G1C in order from the object side to the image side. The focusing group consists of the first B partial group G1B. During focusing from an infinite distance object to a short range object, the first B partial group G1B moves to the image side, and the other groups are fixed relative to the image plane Sim. A parenthesis and an arrow in the horizontal direction added to the first B partial group G1B of FIG. 13 represent that the first B partial group G1B is the focusing group and represent a direction in which the first B partial group G1B moves during focusing from an infinite distance object to a short range object. This illustration method regarding the focus group also applies to the other Examples.

During changing magnification from the wide angle end to the telephoto end, the first lens group G1 and the final lens group GE are fixed relative to the image plane Sim, and the other lens groups move along the optical axis Z while changing a spacing to an adjacent lens group.

Regarding the zoom lens according to Example 1, Tables 1A and 1B show basic lens data, Table 2 shows specifications and variable surface spacings, and Table 3 shows aspherical coefficients. In the present specification, the basic lens data is shown to be divided into two tables in order to avoid an increase in the length of one table.

The table of the basic lens data is described as follows. The “Sn” column shows surface numbers in a case where the surface closest to the object side is the first surface and the number is increased one by one toward the image side. The “R” column shows a curvature radius of each surface. The “D” column shows a surface spacing between each surface and the surface adjacent to the image side on the optical axis. The “Nd” column shows a refractive index of each component with respect to the d line. The “vd” column shows an Abbe number of each component with respect to the d line. The “θg,F” column shows a partial dispersion ratio between the g line and the F line in each of the components. The “ED” column shows a maximum effective diameter of each surface.

In a case where refractive indices of one lens with respect to the g line, the F line, and the C line are represented by Ng, NF, and NC, respectively, and a partial dispersion ratio between the g line and the F line in the lens is represented by θg,F, θg,F is defined by the following expression.

$$θ g , F = ( Ng - NF ) / ( NF - NC )$$

In the table of the basic lens data, the sign of the curvature radius of a surface that is convex to the object side is positive, and the sign of the curvature radius of a surface that is convex to the image side is negative. The table of the basic lens data also shows the aperture stop St and the color separation prism 60. In the fields of the surface number of the surface corresponding to the aperture stop St, the surface number and the expression (St) are shown. A value in the lowermost field of the column of D in Table 1B is a spacing between a surface closest to the image side in the table and the image plane Sim. The symbol DD[ ] is used for the variable surface spacing during changing magnification, and the surface number of the object side of the spacing is given in [ ] and is shown in the column of the surface spacing.

Table 2 shows a zoom ratio Zr, a focal length f, an open F-number FNo., a maximum total angle of view 20, and a variable surface spacing with respect to the d line. The zoom ratio is synonymous with the zoom magnification. [°] in the fields of 2ω indicates that the unit thereof is degree. Table 2 shows each value of the wide angle end state, a middle focal length state, and the telephoto end state in the columns labeled “Wide”, “Middle”, and “Tele”, respectively.

In the table of the basic lens data, a reference sign * is added to surface numbers of aspherical surfaces, and values of paraxial curvature radius are shown in the fields of the curvature radius of the aspherical surface. In Table 3, the Sn row shows surface numbers of the aspherical surfaces, and the KA and Am rows show numerical values of the aspherical coefficients for each aspherical surface. Here, m of Am represents an integer of 3 or more and varies depending on the surface. For example, in the first surface of Example 1, m=4, 6, 8, . . . , and 20. The “E+n” (n: an integer) in the numerical values of the aspherical coefficients of Table 3 indicates “×10^{±n}”. KA and Am represent the aspherical coefficients in an aspheric equation represented by the following expression.

$$Zd = C \times {h}^{2} / \{ 1 + {( 1 - KA \times {C}^{2} \times {h}^{2} )}^{1 / 2} \} + Σ A m \times {h}^{m}$$

where,
Zd is an aspherical surface depth (a length of a perpendicular from a point on an aspherical surface at a height h to a plane that is perpendicular to the optical axis Z and in contact with the aspherical surface apex),
h is a height (a distance from the optical axis Z to the lens surface),
C is a reciprocal of the paraxial curvature radius,
KA and Am are aspherical coefficients, and
Σ in the aspheric equation represents the total sum regarding m.

In the data of each of the tables, degrees are used as the unit of an angle, and millimeters (mm) are used as the unit of a length. However, appropriate different units may be used because the optical system can be used even in a case where the system is enlarged or reduced in proportion. In addition, each of the following tables shows numerical values rounded off to predetermined decimal places.

TABLE 1A
Example 1

| Sn | R | D | Nd | νd | θg, F | ED |
|---|---|---|---|---|---|---|
| *1 | 124.78501 | 2.689 | 1.77250 | 49.60 | 0.55212 | 81.13 |
| 2 | 37.74743 | 25.827 | | | | 63.38 |
| 3 | −72.18082 | 1.800 | 1.77250 | 49.60 | 0.55212 | 61.96 |
| 4 | 892.53227 | 0.400 | | | | 61.96 |
| *5 | 49.51735 | 5.628 | 1.59270 | 35.31 | 0.59336 | 62.49 |
| 6 | 86.09519 | 1.000 | | | | 61.90 |
| 7 | 70.22676 | 10.906 | 1.43387 | 95.18 | 0.53733 | 63.53 |
| 8 | −339.62039 | 0.270 | | | | 63.63 |
| 9 | 222.24370 | 1.800 | 1.73800 | 32.26 | 0.59654 | 63.60 |
| 10 | 58.97499 | 12.800 | 1.43875 | 94.94 | 0.53433 | 62.53 |
| 11 | −266.65342 | 5.945 | | | | 62.74 |
| 12 | 54.77341 | 15.315 | 1.43387 | 95.18 | 0.53733 | 63.59 |
| 13 | −150.67500 | 0.120 | | | | 63.12 |
| *14 | 51.57988 | 5.752 | 1.72916 | 54.68 | 0.54451 | 57.04 |
| 15 | 180.42701 | DD[15] | | | | 56.25 |
| 16 | 45.14581 | 0.800 | 2.00100 | 29.13 | 0.59952 | 24.55 |
| 17 | 15.41283 | DD[17] | | | | 20.83 |
| 18 | 62.72211 | 0.800 | 1.95375 | 32.32 | 0.59015 | 18.72 |
| 19 | 22.05485 | 2.895 | | | | 17.78 |
| 20 | −47.81998 | 4.273 | 1.80518 | 25.42 | 0.61616 | 17.75 |
| 21 | −12.90677 | 0.800 | 1.88300 | 40.76 | 0.56679 | 17.90 |
| 22 | −184.37775 | 0.120 | | | | 18.62 |
| 23 | 36.47847 | 5.259 | 1.69895 | 30.13 | 0.60298 | 19.00 |
| 24 | −20.03387 | 0.800 | 1.88300 | 40.76 | 0.56679 | 19.25 |
| 25 | −65.26368 | DD[25] | | | | 19.86 |
| 26 | −26.36540 | 0.810 | 1.83400 | 37.16 | 0.57759 | 20.41 |
| 27 | 55.51007 | 2.419 | 1.95906 | 17.47 | 0.65993 | 22.30 |
| 28 | −230.09092 | DD[28] | | | | 22.70 |

TABLE 1B
Example 1

| Sn | R | D | Nd | νd | θg, F | ED |
|---|---|---|---|---|---|---|
| 29 | ∞ | 1.500 | | | | 28.16 |
| (St) | | | | | | |
| 30 | 643.40525 | 4.054 | 1.95375 | 32.32 | 0.59015 | 29.38 |
| 31 | −47.66544 | 0.695 | | | | 29.86 |
| 32 | 70.83967 | 6.756 | 1.51633 | 64.14 | 0.53531 | 29.91 |
| 33 | −35.44225 | 1.200 | 2.00100 | 29.13 | 0.59952 | 29.65 |
| 34 | −127.20202 | 35.154 | | | | 30.07 |
| 35 | 69.13379 | 5.518 | 1.51633 | 64.14 | 0.53531 | 30.21 |
| 36 | −49.70082 | 0.190 | | | | 29.98 |
| 37 | 40.01074 | 5.535 | 1.48749 | 70.24 | 0.53007 | 27.00 |
| 38 | −54.67136 | 1.200 | 1.81600 | 46.62 | 0.55682 | 26.25 |
| 39 | 33.23002 | 2.090 | | | | 24.78 |
| 40 | 54.13362 | 6.601 | 1.59282 | 68.62 | 0.54414 | 24.94 |
| 41 | −22.63084 | 1.200 | 1.91082 | 35.25 | 0.58224 | 24.80 |
| 42 | −820.01081 | 1.620 | | | | 25.45 |
| 43 | 59.48668 | 5.126 | 1.51633 | 64.14 | 0.53531 | 26.19 |
| 44 | −41.85959 | 9.791 | | | | 26.19 |
| 45 | ∞ | 33.000 | 1.58267 | 46.46 | 0.56601 | |
| 46 | ∞ | 13.200 | 1.51633 | 64.05 | 0.53548 | |
| 47 | ∞ | 1.000 | | | | |

TABLE 2
Example 1

| | Wide | Middle | Tele |
|---|---|---|---|
| Zr | 1.0 | 7.7 | 17.3 |
| f | 5.730 | 43.898 | 99.120 |
| FNo. | 1.87 | 1.87 | 3.02 |
| 2ω[°] | 91.6 | 14.2 | 6.4 |
| DD[15] | 0.650 | 41.450 | 47.134 |
| DD[17] | 6.545 | 4.71 | 4.065 |
| DD[25] | 42.063 | 3.504 | 7.958 |
| DD[28] | 11.106 | 11.240 | 1.208 |

TABLE 3
Example 1

| Sn | 1 | 5 | 14 |
|---|---|---|---|
| KA | 1.0000000E+00 | 1.0000000E+00 | 1.0000000E+00 |
| A4 | 5.2505930E−08 | −3.5687571E−09 | −1.9280825E−06 |
| A6 | 1.1616876E−09 | −2.1257577E−09 | −7.8956322E−10 |
| A8 | −6.0416610E−13 | 1.0336393E−12 | −3.3616325E−13 |
| A10 | −1.3868729E−18 | 3.5341212E−16 | −5.4950910E−17 |
| A12 | 9.9799255E−20 | −6.9602547E−19 | 1.9800037E−20 |
| A14 | 4.9006064E−24 | −1.3764973E−22 | −3.3569246E−22 |
| A16 | −1.2331637E−26 | 4.1688838E−25 | −5.4608475E−25 |
| A18 | −6.8046320E−30 | −3.3328819E−29 | 1.3606563E−27 |
| A20 | 3.1696454E−33 | −7.3557201E−32 | −6.9412805E−31 |

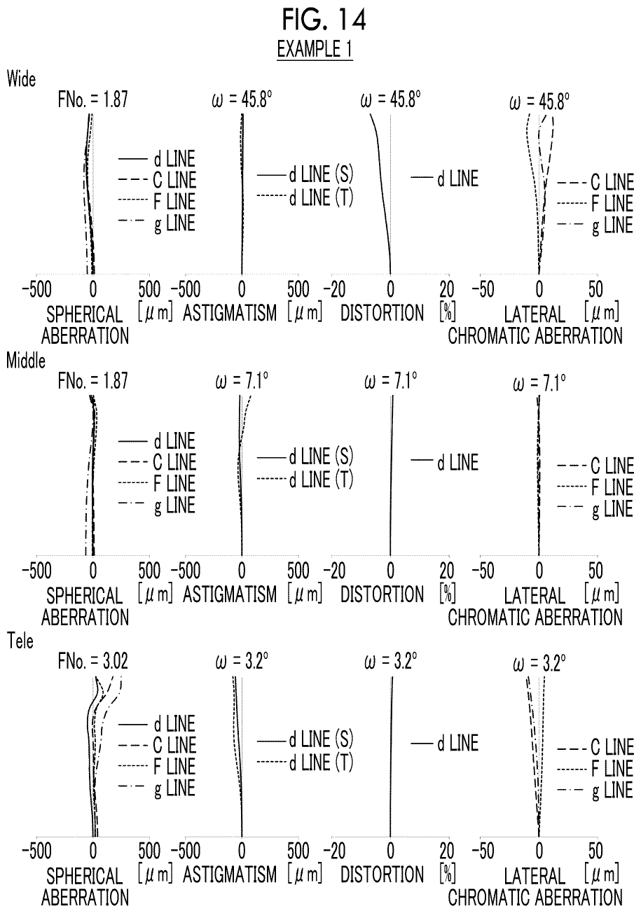

FIG. 14 shows each of aberration diagrams of the zoom lens according to Example 1 in a state where the infinite distance object is in focus. In FIG. 14, the upper part labeled “Wide” shows aberrations in the wide angle end state, the middle part labeled “Middle” shows aberrations in the middle focal length state, and the lower part labeled “Tele” shows aberrations in the telephoto end state. FIG. 14 shows spherical aberration, astigmatism, distortion, and lateral chromatic aberration in order from the left side. In the spherical aberration diagram, the aberrations at the d line, the C line, the F line, and the g line are indicated by a solid line, a long broken line, a short broken line, and a dot-dashed line, respectively. In the astigmatism diagram, the aberration at the d line in a sagittal direction is indicated by a solid line, and the aberration on the d line in a tangential direction is indicated by a short broken line. In the distortion diagram, the aberration at the d line is indicated by a solid line. In the lateral chromatic aberration diagram, the aberrations at the C line, the F line, and the g line are shown by a long broken line, a short broken line, and a dot-dashed line, respectively. In the spherical aberration diagram, a value of the open F-number is shown after “FNo.=”. In other aberration diagrams, the value of the maximum half angle of view is shown after “ω=”.

Symbols, meanings, description methods, and illustration methods of the respective data pieces according to Example 1 are basically similar to those in the following examples unless otherwise specified. Therefore, hereinafter, repeated description will be omitted.

### Example 2

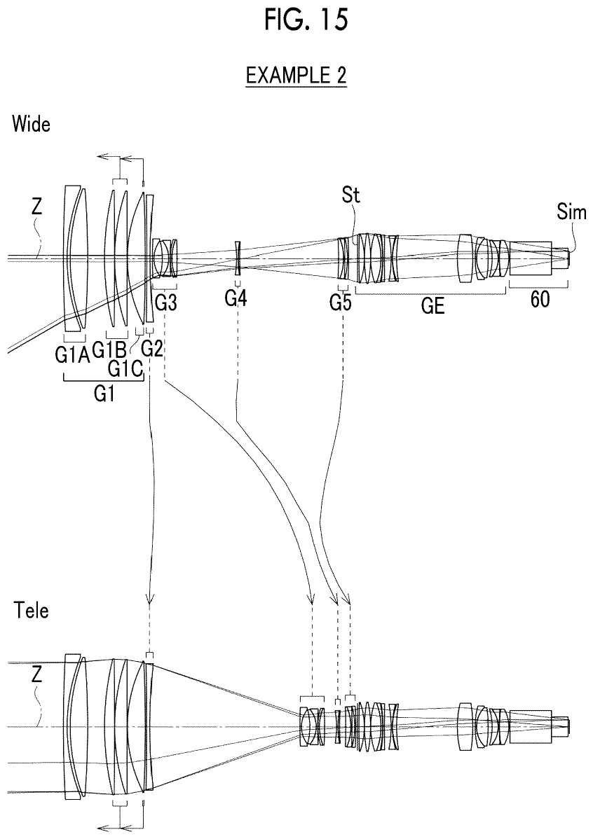

FIG. 15 shows a cross-sectional view showing a configuration of the zoom lens according to Example 2 and movement loci thereof. The zoom lens according to Example 2 consists of, in order from the object side to the image side, a first lens group G1 that has a positive refractive power, a second lens group G2 that has a negative refractive power, a third lens group G3 that has a negative refractive power, a fourth lens group G4 that has a negative refractive power, a fifth lens group G5 that has a negative refractive power, and a final lens group GE that has a positive refractive power.

The first lens group G1 consists of a first A partial group GIA, a first B partial group G1B, and a first C partial group G1C in order from the object side to the image side. The zoom lens according to Example 2 includes two focusing groups of the first B partial group G1B and the first C partial group G1C. During focusing from the infinite distance object to a short range object, the first B partial group G1B and the first C partial group G1C move to the object side while changing a mutual spacing, and the other groups are fixed relative to the image plane Sim.

During changing magnification from the wide angle end to the telephoto end, the first lens group G1 and the final lens group GE are fixed relative to the image plane Sim, and the other lens groups move along the optical axis Z while changing a spacing to an adjacent lens group.

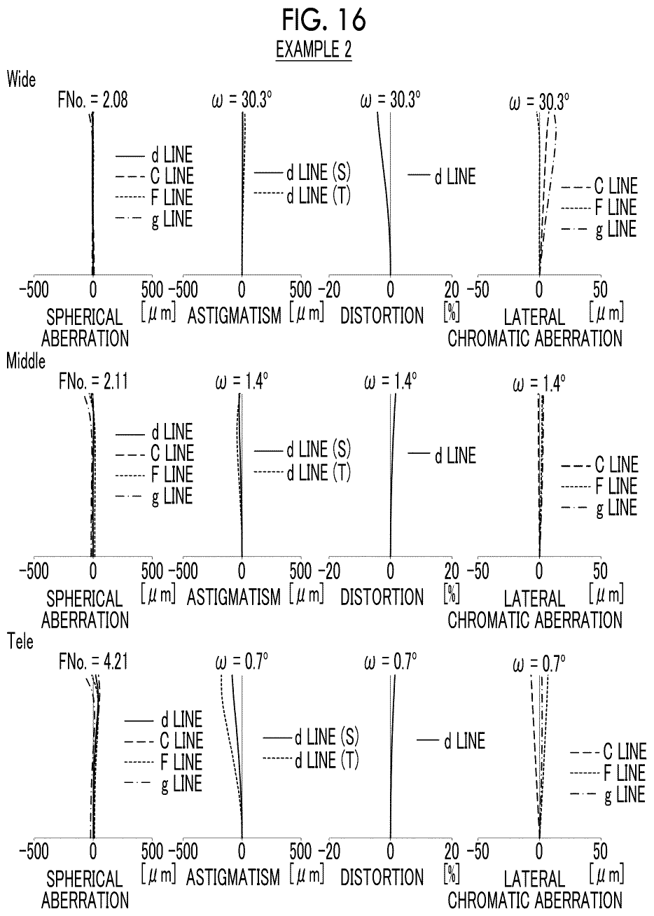

Regarding the zoom lens according to Example 2, Tables 4A and 4B show basic lens data, Table 5 shows specifications and variable surface spacings, and FIG. 16 shows each of the aberration diagrams.

TABLE 4A
Example 2

| Sn | R | D | Nd | νd | θg, F | ED |
|---|---|---|---|---|---|---|
| 1 | 1051.81310 | 3.000 | 1.82964 | 44.89 | 0.55798 | 116.50 |
| 2 | 152.55560 | 2.427 | | | | 111.60 |
| 3 | 159.89751 | 13.859 | 1.43387 | 95.18 | 0.53733 | 111.40 |
| 4 | −734.77564 | 13.446 | | | | 111.35 |
| 5 | 230.20665 | 7.928 | 1.43387 | 95.18 | 0.53733 | 109.00 |
| 6 | −5057.72441 | 0.120 | | | | 108.91 |
| 7 | 171.81084 | 9.839 | 1.43387 | 95.18 | 0.53733 | 107.80 |
| 8 | 2775099.34242 | 0.282 | | | | 107.57 |
| 9 | 116.31797 | 14.190 | 1.43387 | 95.18 | 0.53733 | 103.53 |
| 10 | −1191.06939 | DD[10] | | | | 103.05 |
| 11 | −3131.72775 | 2.550 | 1.55052 | 72.23 | 0.52679 | 101.59 |
| 12 | 559.77131 | DD[12] | | | | 99.06 |
| 13 | 579.06784 | 1.200 | 1.96578 | 30.29 | 0.59694 | 30.98 |
| 14 | 22.76441 | 6.613 | | | | 27.14 |
| 15 | −54.41931 | 5.093 | 1.89286 | 20.36 | 0.63944 | 27.14 |
| 16 | −22.11761 | 1.210 | 1.89190 | 37.13 | 0.57813 | 27.64 |
| 17 | 301.31867 | 0.720 | | | | 29.13 |
| 18 | 51.91350 | 1.200 | 2.00001 | 17.34 | 0.64613 | 30.25 |
| 19 | 39.46575 | 4.089 | 1.87582 | 22.80 | 0.62149 | 30.11 |
| 20 | −345.51314 | DD[20] | | | | 30.10 |
| 21 | −81.16312 | 1.210 | 1.53188 | 75.10 | 0.53873 | 26.08 |
| 22 | 78.39258 | 1.200 | 1.90000 | 34.39 | 0.58573 | 26.42 |
| 23 | 169.28533 | DD[23] | | | | 26.49 |
| 24 | −296.19284 | 4.028 | 1.80241 | 26.13 | 0.60986 | 31.82 |
| 25 | −41.88603 | 0.960 | 1.81529 | 43.63 | 0.56266 | 31.93 |
| 26 | −312.28017 | 2.093 | | | | 32.26 |
| 27 | −62.71952 | 0.960 | 1.88300 | 40.76 | 0.56679 | 32.28 |
| 28 | −224.00273 | DD[28] | | | | 33.00 |

TABLE 4B
Example 2

| Sn | R | D | Nd | νd | θg, F | ED |
|---|---|---|---|---|---|---|
| 29 | ∞ | 1.149 | | | | 37.74 |
| (St) | | | | | | |
| 30 | 575.00010 | 4.286 | 1.74637 | 53.36 | 0.54468 | 38.84 |
| 31 | −58.72936 | 0.120 | | | | 39.07 |
| 32 | 110.83395 | 4.853 | 1.46727 | 89.84 | 0.53589 | 39.82 |
| 33 | −96.76277 | 0.120 | | | | 39.81 |
| 34 | 62.69869 | 8.787 | 1.49697 | 84.82 | 0.53784 | 38.61 |
| 35 | −52.08496 | 1.280 | 1.79192 | 30.08 | 0.60149 | 38.05 |
| 36 | −94.57620 | 0.182 | | | | 37.55 |
| 37 | −126.94212 | 1.200 | 1.88687 | 21.03 | 0.62742 | 37.08 |
| 38 | 976.67406 | 5.363 | | | | 36.55 |
| 39 | −92.02203 | 1.000 | 1.80522 | 46.58 | 0.55777 | 36.12 |
| 40 | 65.88382 | 0.120 | | | | 36.10 |
| 41 | 48.61640 | 3.223 | 1.83586 | 23.54 | 0.62199 | 36.66 |
| 42 | 112.52350 | 47.833 | | | | 36.52 |
| 43 | 80.57501 | 12.282 | 1.71800 | 36.72 | 0.58401 | 37.83 |
| 44 | −121.24667 | 1.875 | | | | 36.32 |
| 45 | 66.89115 | 1.081 | 1.89987 | 37.92 | 0.57359 | 33.42 |
| 46 | 22.35256 | 9.219 | 1.63484 | 63.55 | 0.54238 | 30.73 |
| 47 | −124.36852 | 3.145 | | | | 29.98 |
| 48 | −52.01559 | 4.876 | 1.48749 | 70.24 | 0.53007 | 28.39 |
| 49 | −22.66865 | 0.920 | 1.81801 | 45.92 | 0.55875 | 27.81 |
| 50 | 222.74262 | 0.120 | | | | 28.22 |
| 51 | 96.97878 | 7.386 | 1.48749 | 70.24 | 0.53007 | 28.38 |
| 52 | −29.59806 | 0.928 | | | | 28.52 |
| 53 | ∞ | 33.000 | 1.58267 | 46.46 | 0.56601 | |
| 54 | ∞ | 13.200 | 1.51633 | 64.05 | 0.53548 | |
| 55 | ∞ | 0.994 | | | | |

TABLE 5
Example 2

| | Wide | Middle | Tele |
|---|---|---|---|
| Zr | 1.0 | 22.3 | 44.4 |
| f | 9.832 | 218.844 | 436.093 |
| FNo. | 2.08 | 2.11 | 4.21 |
| 2ω[°] | 60.6 | 2.8 | 1.4 |
| DD[10] | 1.245 | 2.417 | 1.058 |
| DD[12] | 1.500 | 111.292 | 118.910 |
| DD[20] | 47.341 | 1.467 | 9.527 |
| DD[23] | 78.616 | 2.284 | 4.957 |
| DD[28] | 6.981 | 18.222 | 1.231 |

### Example 3

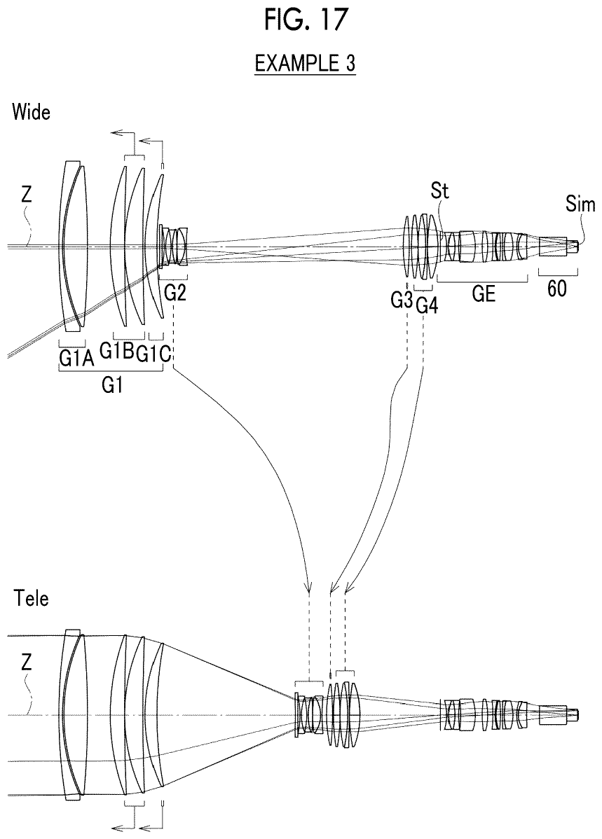

FIG. 17 shows a cross-sectional view showing a configuration of the zoom lens according to Example 3 and movement loci thereof. The zoom lens according to Example 3 consists of, in order from the object side to the image side, a first lens group G1 that has a positive refractive power, a second lens group G2 that has a negative refractive power, a third lens group G3 that has a positive refractive power, a fourth lens group G4 that has a positive refractive power, and a final lens group GE that has a positive refractive power.

The first lens group G1 consists of a first A partial group GIA, a first B partial group G1B, and a first C partial group G1C in order from the object side to the image side. The zoom lens according to Example 3 includes two focusing groups of the first B partial group G1B and the first C partial group G1C. During focusing from the infinite distance object to a short range object, the first B partial group G1B and the first C partial group G1C move to the object side while changing a mutual spacing, and the other groups are fixed relative to the image plane Sim.

During changing magnification from the wide angle end to the telephoto end, the first lens group G1 and the final lens group GE are fixed relative to the image plane Sim, and the other lens groups move along the optical axis Z while changing a spacing to an adjacent lens group.

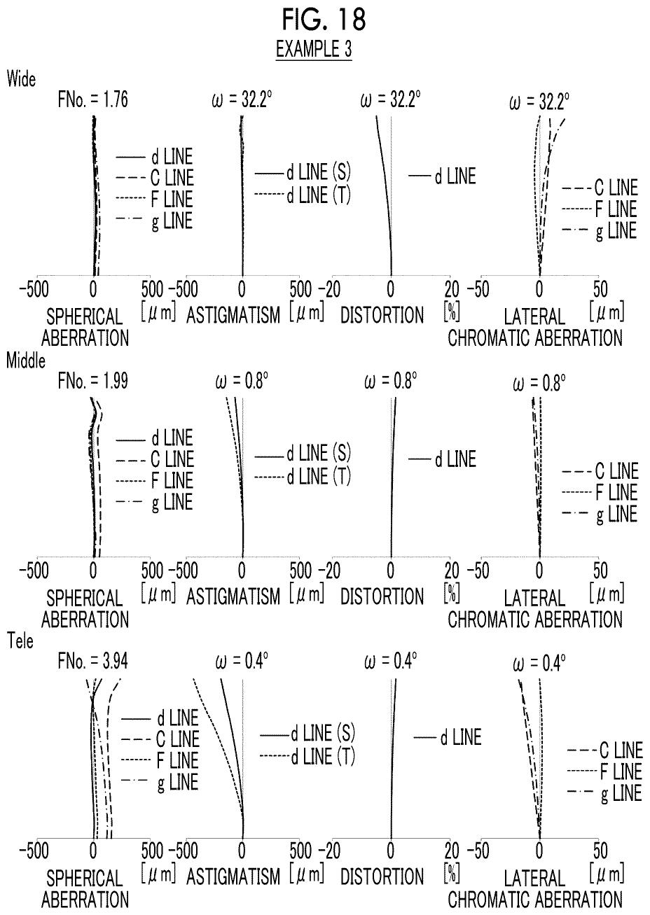

Regarding the zoom lens according to Example 3, Tables 6A and 6B show basic lens data, Table 7 shows specifications and variable surface spacings, Table 8 shows aspherical coefficients, and FIG. 18 shows each of the aberration diagrams.

TABLE 6A
Example 3

| Sn | R | D | Nd | νd | θg, F | ED |
|---|---|---|---|---|---|---|
| 1 | 654.83654 | 4.400 | 1.83400 | 37.16 | 0.57759 | 212.00 |
| 2 | 245.86434 | 1.800 | | | | 200.41 |
| 3 | 245.02541 | 28.619 | 1.43387 | 95.18 | 0.53733 | 199.60 |
| 4 | −1120.24221 | 27.749 | | | | 198.40 |
| 5 | 292.42657 | 17.372 | 1.43387 | 95.18 | 0.53733 | 198.00 |
| 6 | 2215.79316 | 0.120 | | | | 197.66 |
| 7 | 232.58280 | 22.191 | 1.43387 | 95.18 | 0.53733 | 194.32 |
| 8 | 2538.30628 | 2.500 | | | | 193.23 |
| 9 | 214.92938 | 13.915 | 1.43875 | 94.94 | 0.53433 | 178.40 |
| 10 | 494.77412 | DD[10] | | | | 176.67 |
| *11 | −332.22709 | 3.000 | 1.90366 | 31.31 | 0.59481 | 50.15 |
| 12 | ∞ | 2.571 | | | | 46.97 |
| 13 | −115.07405 | 1.750 | 2.00330 | 28.27 | 0.59802 | 46.34 |
| 14 | 59.69185 | 6.472 | | | | 41.80 |
| 15 | −89.44566 | 1.750 | 1.81600 | 46.62 | 0.55682 | 41.73 |
| 16 | 68.83700 | 5.405 | 1.80809 | 22.76 | 0.63073 | 42.18 |
| 17 | −304.82886 | 0.120 | | | | 42.68 |
| 18 | 172.44318 | 9.630 | 1.80809 | 22.76 | 0.63073 | 44.00 |
| 19 | −38.95000 | 1.750 | 1.88300 | 40.76 | 0.56679 | 44.25 |
| 20 | 217.52513 | DD[20] | | | | 46.42 |
| 21 | 174.55163 | 7.202 | 1.43875 | 94.94 | 0.53433 | 75.41 |
| 22 | −390.51154 | DD[22] | | | | 75.60 |
| 23 | 257.69285 | 7.910 | 1.49700 | 81.54 | 0.53748 | 78.32 |
| *24 | −280.71349 | 0.120 | | | | 78.50 |
| 25 | 198.11000 | 9.264 | 1.49700 | 81.54 | 0.53748 | 78.69 |
| 26 | −198.11000 | 2.000 | 1.92286 | 18.90 | 0.64960 | 78.53 |
| 27 | −950.89584 | 0.120 | | | | 78.53 |
| *28 | 145.85242 | 12.782 | 1.43875 | 94.94 | 0.53433 | 78.18 |
| 29 | −114.30778 | DD[29] | | | | 77.87 |

TABLE 6B
Example 3

| Sri | R | D | Nd | νd | θg, F | ED |
|---|---|---|---|---|---|---|
| 30 | ∞ | 7.634 | | | | 38.20 |
| (St) | | | | | | |
| 31 | −60.96171 | 1.801 | 1.80400 | 46.57 | 0.55784 | 35.48 |
| 32 | 44.55500 | 7.637 | 1.80518 | 25.43 | 0.61027 | 35.48 |
| 33 | −66.76600 | 4.536 | 1.80400 | 46.57 | 0.55784 | 35.46 |
| 34 | 134.14245 | 2.467 | | | | 35.32 |
| 35 | −141.05618 | 17.718 | 1.51823 | 58.90 | 0.54567 | 35.35 |
| 36 | −63.09958 | 8.525 | | | | 38.69 |
| 37 | 154.07827 | 6.588 | 1.48749 | 70.24 | 0.53007 | 38.50 |
| 38 | −77.55259 | 6.318 | | | | 38.22 |
| 39 | −165.12252 | 2.668 | 1.88300 | 40.76 | 0.56679 | 35.12 |
| 40 | 57.99115 | 1.302 | | | | 34.48 |
| 41 | 56.23901 | 5.281 | 1.51823 | 58.90 | 0.54567 | 35.02 |
| 42 | −155.87451 | 2.530 | | | | 35.03 |
| 43 | 767.03318 | 2.048 | 1.84666 | 23.83 | 0.62045 | 34.64 |
| 44 | 70.80300 | 10.589 | 1.51633 | 64.14 | 0.53531 | 34.33 |
| 45 | −52.34416 | 4.600 | | | | 34.40 |
| 46 | 52.34553 | 1.918 | 1.80400 | 46.57 | 0.55784 | 32.70 |
| 47 | 27.75300 | 10.133 | 1.61772 | 49.81 | 0.56035 | 31.13 |
| 48 | 341.54446 | 15.651 | | | | 29.54 |
| 49 | ∞ | 33.000 | 1.58267 | 46.46 | 0.56601 | |
| 50 | ∞ | 13.200 | 1.51633 | 64.05 | 0.53548 | |
| 51 | ∞ | 1.000 | | | | |

TABLE 7
Example 3

| | Wide | Middle | Tele |
|---|---|---|---|
| Zr | 1.0 | 42.9 | 84.9 |
| f | 9.201 | 394.510 | 781.319 |
| FNo. | 1.76 | 1.99 | 3.94 |
| 2ω[°] | 64.4 | 1.6 | 0.8 |
| DD[10] | 3.275 | 162.389 | 168.427 |
| DD[20] | 263.924 | 35.916 | 5.474 |
| DD[22] | 2.804 | 4.204 | 1.200 |
| DD[29] | 2.976 | 70.470 | 97.878 |

TABLE 8
Example 3

| Sn | 11 | 24 | 28 |
|---|---|---|---|
| KA | −4.9418045E+00 | 9.9523976E−01 | −2.0383957E+00 |
| A3 | −1.4203045E−07 | 1.1859057E−06 | 1.2515068E−06 |
| A4 | 1.7333447E−06 | −5.7384564E−07 | −1.0577877E−06 |
| A5 | −1.2966716E−08 | −2.3283991E−09 | −3.4422669E−09 |
| A6 | 6.6607906E−10 | 2.2882884E−10 | 3.3387300E−10 |
| A7 | 1.1951059E−11 | 7.4779710E−12 | 3.9752212E−12 |
| A8 | −1.3060110E−12 | 1.4860577E−14 | 8.3588280E−14 |
| A9 | −6.0014016E−14 | −1.9534239E−15 | 7.1982155E−17 |
| A10 | 9.3503799E−16 | −7.1273740E−17 | −7.1506358E−17 |
| A11 | 1.9726746E−16 | −5.3262049E−19 | −2.8114763E−18 |
| A12 | 1.1882518E−17 | 1.4149029E−20 | −5.0322122E−20 |
| A13 | −8.4714318E−19 | 3.4277679E−22 | 2.7014471E−22 |
| A14 | −6.0287223E−21 | −3.1002895E−24 | 7.2003217E−23 |
| A15 | 8.4349845E−22 | −2.2643938E−25 | 1.4200909E−24 |
| A16 | −5.4898317E−23 | −3.5043252E−27 | 5.1873654E−27 |
| A17 | 1.4092261E−24 | 1.1984709E−28 | −4.3113729E−27 |
| A18 | 2.2403360E−26 | 8.0200449E−30 | 8.1891591E−29 |
| A19 | 2.0827217E−27 | 2.4281036E−31 | 5.8965941E−31 |
| A20 | −9.6606238E−29 | −8.5071377E−33 | −1.8849183E−32 |

### Example 4

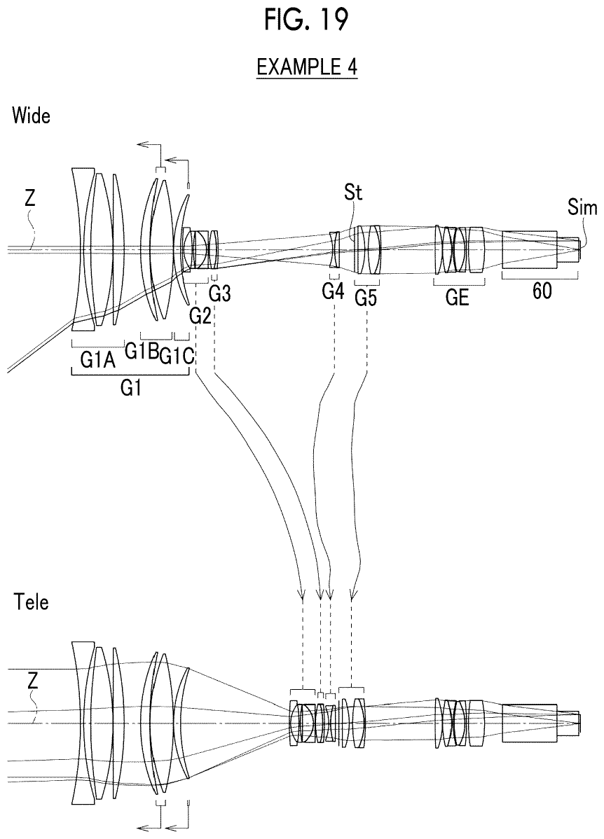

FIG. 19 shows a cross-sectional view showing a configuration of the zoom lens according to Example 4 and movement loci thereof. The zoom lens according to Example 4 consists of, in order from the object side to the image side, a first lens group G1 that has a positive refractive power, a second lens group G2 that has a negative refractive power, a third lens group G3 that has a negative refractive power, a fourth lens group G4 that has a negative refractive power, a fifth lens group G5 that has a positive refractive power, and a final lens group GE that has a positive refractive power.

The first lens group G1 consists of a first A partial group GIA, a first B partial group G1B, and a first C partial group G1C in order from the object side to the image side. The zoom lens according to Example 4 includes two focusing groups of the first B partial group G1B and the first C partial group G1C. During focusing from the infinite distance object to a short range object, the first B partial group G1B and the first C partial group G1C move to the object side while changing a mutual spacing, and the other groups are fixed relative to the image plane Sim.

During changing magnification from the wide angle end to the telephoto end, the first lens group G1 and the final lens group GE are fixed relative to the image plane Sim, and the other lens groups move along the optical axis Z while changing a spacing to an adjacent lens group.

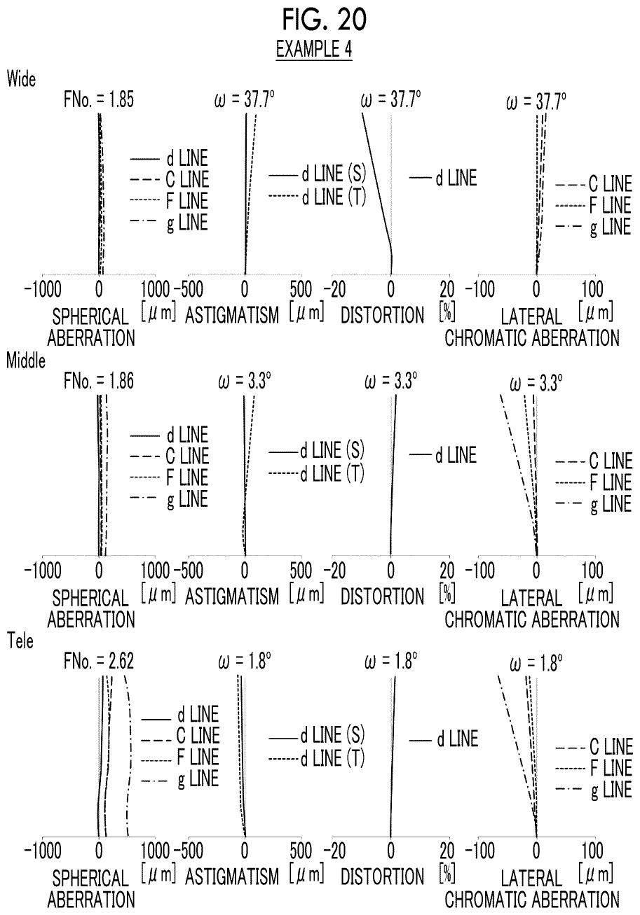

Regarding the zoom lens according to Example 4, Tables 9A and 9B show basic lens data, Table 10 shows specifications and variable surface spacings, Table 11 shows aspherical coefficients, and FIG. 20 shows each of the aberration diagrams.

TABLE 9A
Example 4

| Sn | R | D | Nd | νd | θg, F | ED |
|---|---|---|---|---|---|---|
| 1 | −240.25167 | 2.000 | 1.80610 | 33.27 | 0.58845 | 96.65 |
| 2 | 169.87028 | 4.254 | | | | 92.79 |
| *3 | 269.30524 | 13.458 | 1.43700 | 95.10 | 0.53364 | 93.11 |
| 4 | −161.30887 | 0.120 | | | | 93.41 |
| 5 | 18447.86359 | 6.699 | 1.43387 | 95.18 | 0.53733 | 92.51 |
| 6 | −204.17917 | 9.919 | | | | 92.39 |
| 7 | 109.59520 | 5.605 | 1.43387 | 95.18 | 0.53733 | 87.37 |
| 8 | 212.78561 | 0.162 | | | | 86.87 |
| 9 | 120.87764 | 13.801 | 1.43387 | 95.18 | 0.53733 | 85.07 |
| 10 | −188.62332 | 0.162 | | | | 84.29 |
| *11 | 72.67343 | 4.233 | 1.80400 | 46.58 | 0.55730 | 67.96 |
| 12 | 109.82011 | DD[12] | | | | 66.86 |
| *13 | 165.65756 | 0.800 | 2.00100 | 29.13 | 0.59952 | 27.39 |
| 14 | 19.42359 | 5.062 | | | | 23.30 |
| 15 | −77.73338 | 0.800 | 1.90043 | 37.37 | 0.57720 | 23.12 |
| 16 | 65.70080 | 1.325 | | | | 22.73 |
| 17 | −305.64252 | 6.630 | 1.89286 | 20.36 | 0.63944 | 22.74 |
| 18 | −14.67054 | 1.000 | 1.90043 | 37.37 | 0.57720 | 22.81 |
| 19 | −3642.75074 | DD[19] | | | | 23.23 |
| 20 | 49.86597 | 4.366 | 1.60250 | 52.58 | 0.55628 | 23.48 |
| 21 | −45.46259 | 1.000 | 1.67101 | 32.80 | 0.59182 | 23.46 |
| 22 | −115.88465 | DD[22] | | | | 23.48 |
| 23 | −28.76871 | 1.173 | 1.78814 | 41.50 | 0.57014 | 20.00 |
| 24 | 40.96821 | 2.906 | 1.89286 | 20.36 | 0.63944 | 21.86 |
| *25 | −620.90513 | DD[25] | | | | 22.33 |
| 26 | ∞ | 2.074 | | | | 27.45 |
| (St) | | | | | | |
| 27 | 33053.85083 | 4.183 | 1.91082 | 35.25 | 0.58224 | 28.81 |
| 28 | −45.63857 | 2.053 | | | | 29.40 |
| 29 | 73.56575 | 6.964 | 1.53165 | 53.78 | 0.55387 | 29.73 |
| 30 | −35.51276 | 0.800 | 2.00000 | 28.00 | 0.60493 | 29.49 |
| 31 | −119.46400 | DD[31] | | | | 29.89 |

TABLE 9B
Example 4

| Sn | R | D | Nd | νd | θg, F | ED |
|---|---|---|---|---|---|---|
| 32 | 350.84398 | 4.371 | 1.54223 | 70.57 | 0.52944 | 30.29 |
| 33 | −44.80815 | 0.178 | | | | 30.25 |
| 34 | 60.90289 | 5.190 | 1.53337 | 73.90 | 0.52467 | 28.22 |
| 35 | −45.52387 | 0.800 | 1.95375 | 32.32 | 0.59015 | 27.58 |
| 36 | 50.43866 | 0.797 | | | | 26.59 |
| 37 | 64.32820 | 6.404 | 1.62489 | 60.17 | 0.54224 | 26.64 |
| 38 | −28.10641 | 0.905 | 1.91082 | 35.25 | 0.58224 | 26.69 |
| 39 | −145.26797 | 1.239 | | | | 27.36 |
| 40 | 90.28889 | 9.774 | 1.75213 | 27.89 | 0.60421 | 27.89 |
| 41 | −68.30829 | 10.852 | | | | 27.64 |
| 42 | ∞ | 33.000 | 1.58267 | 46.46 | 0.56601 | |
| 43 | ∞ | 13.200 | 1.51633 | 64.05 | 0.53548 | |
| 44 | ∞ | 1.003 | | | | |

TABLE 10
Example 4

| | Wide | Middle | Tele |
|---|---|---|---|
| Zr | 1.0 | 11.9 | 22.1 |
| f | 7.881 | 93.772 | 174.161 |
| FNo. | 1.85 | 1.86 | 2.62 |
| 2ω[°] | 75.4 | 6.6 | 3.6 |
| DD[12] | 1.135 | 61.258 | 65.918 |
| DD[19] | 0.657 | 1.751 | 0.286 |
| DD[22] | 69.393 | 3.736 | 2.536 |
| DD[25] | 9.186 | 9.163 | 2.087 |
| DD[31] | 32.780 | 37.243 | 42.323 |

TABLE 11
Example 4

| Sn | 3 | 11 | 13 | 25 |
|---|---|---|---|---|
| KA | 1.0000000E+00 | 1.0000000E+00 | 1.0000000E+00 | 1.0000000E+00 |
| A4 | −2.7088112E−07 | 8.6195898E−08 | 2.4539169E−06 | 2.0740789E−06 |
| A6 | 8.4081080E−10 | −5.3096656E−10 | −2.7230169E−08 | −1.6500349E−07 |
| A8 | −2.1558352E−12 | 1.4072359E−12 | 4.7911782E−10 | 7.1697692E−09 |
| A10 | 3.3033945E−15 | −2.2955408E−15 | −7.9564470E−12 | −1.8667418E−10 |
| A12 | −3.1994957E−18 | 2.3772788E−18 | 1.0289046E−13 | 3.0344013E−12 |
| A14 | 1.9687357E−21 | −1.5654736E−21 | −8.8507685E−16 | −3.1035910E−14 |
| A16 | −7.4522783E−25 | 6.2026508E−25 | 4.6071065E−18 | 1.9396811E−16 |
| A18 | 1.5802652E−28 | −1.2695111E−28 | −1.3078324E−20 | −6.7635354E−19 |
| A20 | −1.4348776E−32 | 8.3529995E−33 | 1.5517302E−23 | 1.0080293E−21 |

### Example 5

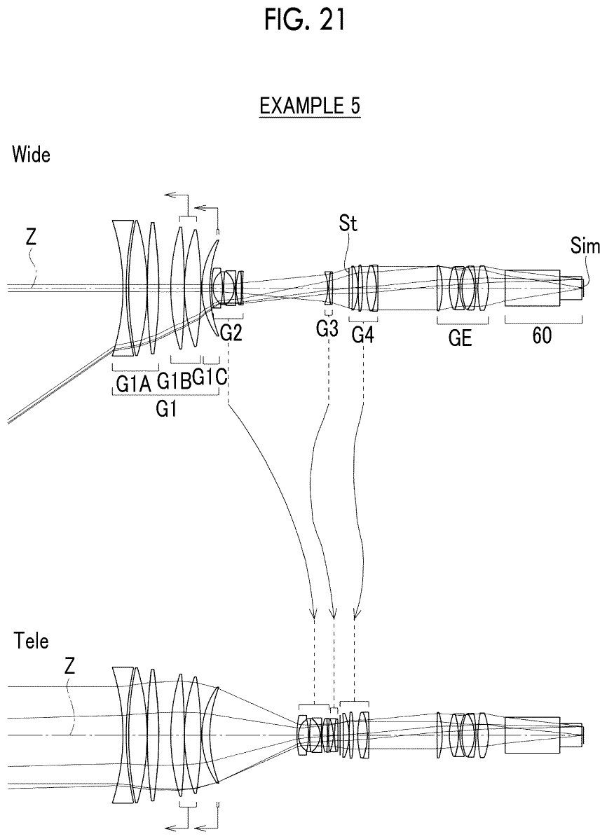

FIG. 21 shows a cross-sectional view showing a configuration of the zoom lens according to Example 5 and movement loci thereof. The zoom lens according to Example 5 consists of, in order from the object side to the image side, a first lens group G1 that has a positive refractive power, a second lens group G2 that has a negative refractive power, a third lens group G3 that has a negative refractive power, a fourth lens group G4 that has a positive refractive power, and a final lens group GE that has a positive refractive power.

The first lens group G1 consists of a first A partial group GIA, a first B partial group G1B, and a first C partial group G1C in order from the object side to the image side. The zoom lens according to Example 5 includes two focusing groups of the first B partial group G1B and the first C partial group G1C. During focusing from the infinite distance object to a short range object, the first B partial group G1B and the first C partial group G1C move to the object side while changing a mutual spacing, and the other groups are fixed relative to the image plane Sim.

During changing magnification from the wide angle end to the telephoto end, the first lens group G1 and the final lens group GE are fixed relative to the image plane Sim, and the other lens groups move along the optical axis Z while changing a spacing to an adjacent lens group.

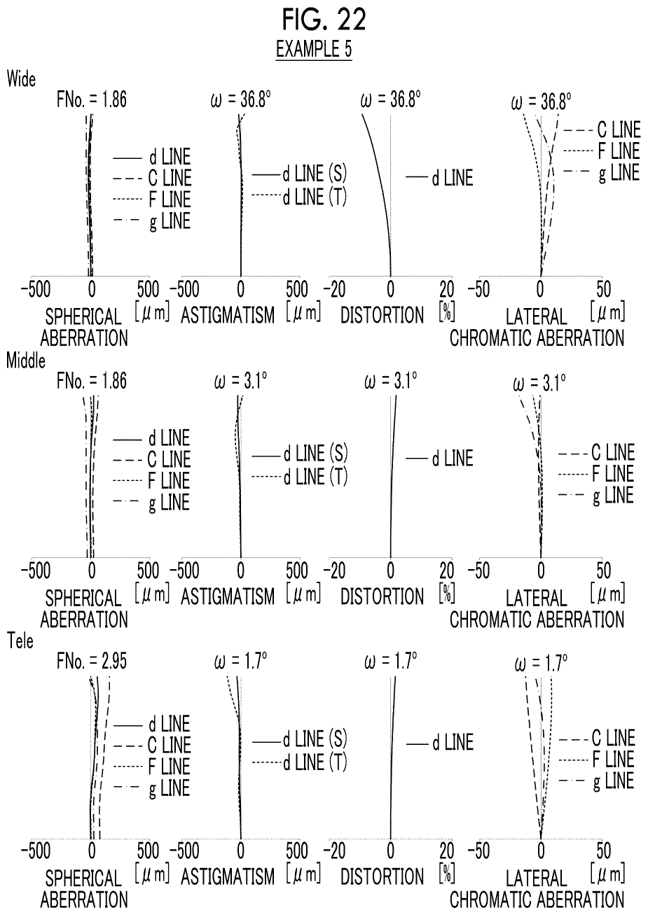

Regarding the zoom lens according to Example 5, Tables 12A and 12B show basic lens data, Table 13 shows specifications and variable surface spacings, Table 14 shows aspherical coefficients, and FIG. 22 shows each of the aberration diagrams.

TABLE 12A
Example 5

| Sn | R | D | Nd | νd | θg, F | ED |
|---|---|---|---|---|---|---|
| 1 | −156.56421 | 2.000 | 1.80610 | 33.27 | 0.58845 | 88.50 |
| 2 | 221.88779 | 1.481 | | | | 86.40 |
| 3 | 237.53179 | 11.070 | 1.43387 | 95.18 | 0.53733 | 86.57 |
| 4 | −168.43113 | 0.120 | | | | 86.54 |
| 5 | 373.95224 | 6.920 | 1.43700 | 95.10 | 0.53364 | 84.40 |
| *6 | −275.48580 | 7.246 | | | | 83.97 |
| 7 | 148.64138 | 8.140 | 1.43387 | 95.18 | 0.53733 | 78.40 |
| 8 | −485.06373 | 0.120 | | | | 78.10 |
| 9 | 123.38062 | 9.870 | 1.43700 | 95.10 | 0.53364 | 75.01 |
| 10 | −263.36724 | 0.600 | | | | 74.40 |
| 11 | 58.45696 | 4.790 | 1.76385 | 48.49 | 0.55898 | 62.00 |
| 12 | 93.65707 | DD[12] | | | | 61.02 |
| *13 | 79.89145 | 0.900 | 2.00100 | 29.13 | 0.59952 | 25.52 |
| 14 | 14.38782 | 5.733 | | | | 20.58 |
| 15 | −47.26968 | 0.710 | 1.84850 | 43.79 | 0.56197 | 20.42 |
| 16 | 105.29700 | 6.290 | 1.85896 | 22.73 | 0.62844 | 20.24 |
| 17 | −14.21400 | 0.740 | 1.95375 | 32.32 | 0.59015 | 20.11 |
| 18 | 317.86072 | 0.487 | | | | 20.25 |
| 19 | 38.02948 | 3.140 | 1.80518 | 25.46 | 0.61572 | 20.44 |
| 20 | −160.72300 | 0.740 | 1.80420 | 46.50 | 0.55727 | 20.34 |
| 21 | 196.72371 | DD[21] | | | | 20.24 |
| 22 | −28.73802 | 0.750 | 1.83400 | 37.34 | 0.57908 | 18.86 |
| 23 | 60.17400 | 2.050 | 1.98613 | 16.48 | 0.66558 | 19.76 |
| 24 | −450.79748 | DD[24] | | | | 20.01 |
| 25 | ∞ | 1.980 | | | | 25.99 |
| (St) | | | | | | |
| 26 | −361.53232 | 3.430 | 1.56883 | 56.04 | 0.54853 | 27.16 |
| 27 | −39.98070 | 0.120 | | | | 27.70 |
| 28 | 224.96817 | 2.590 | 1.72342 | 37.95 | 0.58370 | 28.57 |
| 29 | −108.96845 | 2.542 | | | | 28.69 |
| 30 | 60.60050 | 5.750 | 1.51633 | 64.14 | 0.53531 | 28.68 |
| 31 | −46.08200 | 0.920 | 1.95375 | 32.32 | 0.59015 | 28.38 |
| 32 | −820.45663 | DD[32] | | | | 28.43 |

TABLE 12B
Example 5

| Sn | R | D | Nd | νd | θg, F | ED |
|---|---|---|---|---|---|---|
| 33 | 844.60059 | 3.080 | 1.73800 | 32.33 | 0.59005 | 28.49 |
| 34 | −59.18665 | 4.322 | | | | 28.61 |
| 35 | 41.48104 | 5.440 | 1.48749 | 70.24 | 0.53007 | 26.90 |
| 36 | −49.50700 | 0.860 | 1.95375 | 32.32 | 0.59015 | 26.42 |
| 37 | 33.85248 | 1.342 | | | | 25.77 |
| 38 | 40.17043 | 7.500 | 1.53775 | 74.70 | 0.53936 | 26.38 |
| 39 | −26.65900 | 0.880 | 1.87070 | 40.73 | 0.56825 | 26.57 |
| 40 | −80.58184 | 1.244 | | | | 27.50 |
| 41 | 76.68452 | 6.239 | 1.58144 | 40.75 | 0.57757 | 28.38 |
| 42 | −43.96715 | 10.083 | | | | 28.40 |
| 43 | ∞ | 33.000 | 1.58267 | 46.46 | 0.56601 | |
| 44 | ∞ | 13.200 | 1.51633 | 64.05 | 0.53548 | |
| 45 | ∞ | 1.003 | | | | |

TABLE 13
Example 5

| | Wide | Middle | Tele |
|---|---|---|---|
| Zr | 1.0 | 12.3 | 23.1 |
| f | 8.092 | 99.786 | 186.995 |
| FNo. | 1.86 | 1.86 | 2.95 |
| 2ω[°] | 73.6 | 6.2 | 3.4 |
| DD[12] | 1.036 | 49.067 | 52.513 |
| DD[21] | 50.980 | 2.576 | 2.759 |
| DD[24] | 10.000 | 10.143 | 1.294 |
| DD[32] | 35.654 | 35.885 | 41.105 |

TABLE 14
Example 5

| Sn | 6 | 13 |
|---|---|---|
| KA | 1.0000000E+00 | 1.0000000E+00 |
| A4 | 1.0052940E−07 | 4.8215119E−06 |
| A6 | 5.2398512E−11 | −2.3658343E−08 |
| A8 | −1.7512379E−13 | 6.0301433E−10 |
| A10 | 3.7976355E−16 | −1.7465769E−11 |
| A12 | −4.8613057E−19 | 3.4211689E−13 |
| A14 | 3.8205957E−22 | −3.8654089E−15 |
| A16 | −1.8037912E−25 | 2.4363541E−17 |
| A18 | 4.6844462E−29 | −7.9838847E−20 |
| A20 | −5.1369470E−33 | 1.0592695E−22 |

### Example 6

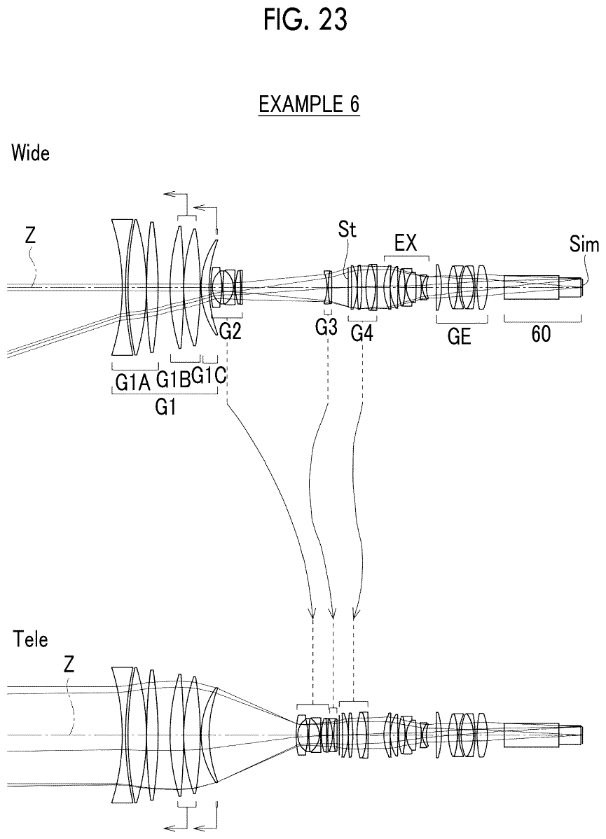

FIG. 23 shows a cross-sectional view showing a configuration of the zoom lens according to Example 6 and movement loci thereof. The zoom lens according to Example 6 has a configuration where the EX group EX is added to the zoom lens according to Example 5. In the zoom lens according to Example 6, the EX group EX is insertable into and removable from the optical path. FIG. 23 shows a state where the EX group EX is inserted into the optical path between the fourth lens group G4 and the final lens group GE. A configuration of lens groups other than the EX group EX, each of groups that move during focusing, and behavior of each of lens groups that move during changing magnification are the same as those of the zoom lens according to Example 5.

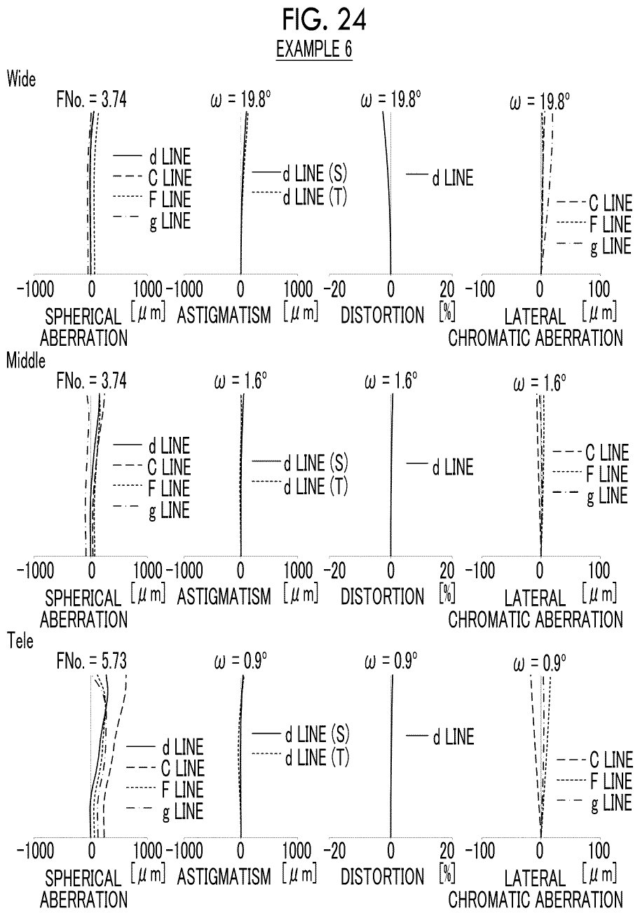

Regarding the zoom lens according to Example 6, Tables 15A and 15B show basic lens data, Table 16 shows specifications and variable surface spacings, Table 17 shows aspherical coefficients, and FIG. 24 shows each of the aberration diagrams.

TABLE 15A
Example 6

| Sn | R | D | Nd | νd | θg, F | ED |
|---|---|---|---|---|---|---|
| 1 | −156.56421 | 2.000 | 1.80610 | 33.27 | 0.58845 | 67.74 |
| 2 | 221.88779 | 1.481 | | | | 69.17 |
| 3 | 237.53179 | 11.070 | 1.43387 | 95.18 | 0.53733 | 69.98 |
| 4 | −168.43113 | 0.120 | | | | 71.40 |
| 5 | 373.95224 | 6.920 | 1.43700 | 95.10 | 0.53364 | 72.83 |
| *6 | −275.48580 | 7.246 | | | | 73.15 |
| 7 | 148.64138 | 8.140 | 1.43387 | 95.18 | 0.53733 | 73.85 |
| 8 | −485.06373 | 0.120 | | | | 73.63 |
| 9 | 123.38062 | 9.870 | 1.43700 | 95.10 | 0.53364 | 72.10 |
| 10 | −263.36724 | 0.600 | | | | 71.40 |
| 11 | 58.45696 | 4.790 | 1.76385 | 48.49 | 0.55898 | 61.93 |
| 12 | 93.65707 | DD[12] | | | | 61.02 |
| *13 | 79.89145 | 0.900 | 2.00100 | 29.13 | 0.59952 | 16.92 |
| 14 | 14.38782 | 5.733 | | | | 15.35 |
| 15 | −47.26968 | 0.710 | 1.84850 | 43.79 | 0.56197 | 15.45 |
| 16 | 105.29700 | 6.290 | 1.85896 | 22.73 | 0.62844 | 15.77 |
| 17 | −14.21400 | 0.740 | 1.95375 | 32.32 | 0.59015 | 16.42 |
| 18 | 317.86072 | 0.487 | | | | 17.26 |
| 19 | 38.02948 | 3.140 | 1.80518 | 25.46 | 0.61572 | 18.07 |
| 20 | −160.72300 | 0.740 | 1.80420 | 46.50 | 0.55727 | 18.17 |
| 21 | 196.72371 | DD[21] | | | | 18.23 |
| 22 | −28.73802 | 0.750 | 1.83400 | 37.34 | 0.57908 | 18.64 |
| 23 | 60.17400 | 2.050 | 1.98613 | 16.48 | 0.66558 | 19.71 |
| 24 | −450.79748 | DD[24] | | | | 20.01 |
| 25 | ∞ | 1.980 | | | | 25.99 |
| (St) | | | | | | |
| 26 | −361.53232 | 3.430 | 1.56883 | 56.04 | 0.54853 | 27.09 |
| 27 | −39.98070 | 0.120 | | | | 27.61 |
| 28 | 224.96817 | 2.590 | 1.72342 | 37.95 | 0.58370 | 28.36 |
| 29 | −108.96845 | 2.542 | | | | 28.47 |
| 30 | 60.60050 | 5.750 | 1.51633 | 64.14 | 0.53531 | 28.27 |
| 31 | −46.08200 | 0.920 | 1.95375 | 32.32 | 0.59015 | 27.91 |
| 32 | 820.45663 | DD[32] | | | | 27.91 |

TABLE 15B
Example 6

| Sn | R | D | Nd | νd | θg, F | ED |
|---|---|---|---|---|---|---|
| 33 | 33.29005 | 3.720 | 1.53775 | 74.70 | 0.53936 | 27.50 |
| 34 | 187.90486 | 0.120 | | | | 27.12 |
| 35 | 28.50596 | 4.550 | 1.53775 | 74.70 | 0.53936 | 26.01 |
| 36 | −1163.92768 | 0.550 | | | | 25.19 |
| 37 | 47.63610 | 3.860 | 1.83400 | 37.34 | 0.57908 | 23.12 |
| 38 | −57.10100 | 0.750 | 2.00100 | 29.13 | 0.59952 | 22.07 |
| 39 | 16.61700 | 5.870 | 1.56732 | 42.82 | 0.57309 | 18.94 |
| 40 | −146.23228 | 3.121 | | | | 17.68 |
| 41 | −49.83808 | 0.760 | 1.81600 | 46.62 | 0.55682 | 15.25 |
| 42 | 12.02400 | 2.260 | 1.89286 | 20.36 | 0.63944 | 14.18 |
| 43 | 20.49832 | 5.969 | | | | 13.79 |
| 44 | 844.60059 | 3.080 | 1.73800 | 32.33 | 0.59005 | 14.83 |
| 45 | −59.18665 | 4.322 | | | | 15.13 |
| 46 | 41.48104 | 5.440 | 1.48749 | 70.24 | 0.53007 | 15.20 |
| 47 | −49.50700 | 0.860 | 1.95375 | 32.32 | 0.59015 | 14.73 |
| 48 | 33.85248 | 1.342 | | | | 14.70 |
| 49 | 40.17043 | 7.500 | 1.53775 | 74.70 | 0.53936 | 15.22 |
| 50 | −26.65900 | 0.880 | 1.87070 | 40.73 | 0.56825 | 15.91 |
| 51 | −80.58184 | 1.244 | | | | 16.26 |
| 52 | 76.68452 | 6.239 | 1.58144 | 40.75 | 0.57757 | 16.72 |
| 53 | −43.96715 | 10.056 | | | | 16.99 |
| 54 | ∞ | 33.000 | 1.58267 | 46.46 | 0.56601 | |
| 55 | ∞ | 13.200 | 1.51633 | 64.05 | 0.53548 | |
| 56 | ∞ | 1.040 | | | | |

TABLE 16
Example 6

| | Wide | Middle | Tele |
|---|---|---|---|
| Zr | 1.0 | 12.3 | 23.1 |
| f | 15.678 | 193.347 | 362.324 |
| FNo. | 3.74 | 3.74 | 5.73 |
| 2ω[°] | 39.6 | 3.2 | 1.8 |
| DD[12] | 1.036 | 49.067 | 52.513 |
| DD[21] | 50.980 | 2.576 | 2.759 |
| DD[24] | 10.000 | 10.143 | 1.294 |
| DD[32] | 4.125 | 4.356 | 9.576 |

TABLE 17
Example 6

| Sn | 6 | 13 |
|---|---|---|
| KA | 1.0000000E+00 | 1.0000000E+00 |
| A4 | 1.0052940E−07 | 4.8215119E−06 |
| A6 | 5.2398512E−11 | −2.3658343E−08 |
| A8 | −1.7512379E−13 | 6.0301433E−10 |
| A10 | 3.7976355E−16 | −1.7465769E−11 |
| A12 | −4.8613057E−19 | 3.4211689E−13 |
| A14 | 3.8205957E−22 | −3.8654089E−15 |
| A16 | −1.8037912E−25 | 2.4363541E−17 |
| A18 | 4.6844462E−29 | −7.9838847E−20 |
| A20 | −5.1369470E−33 | 1.0592695E−22 |

### Example 7

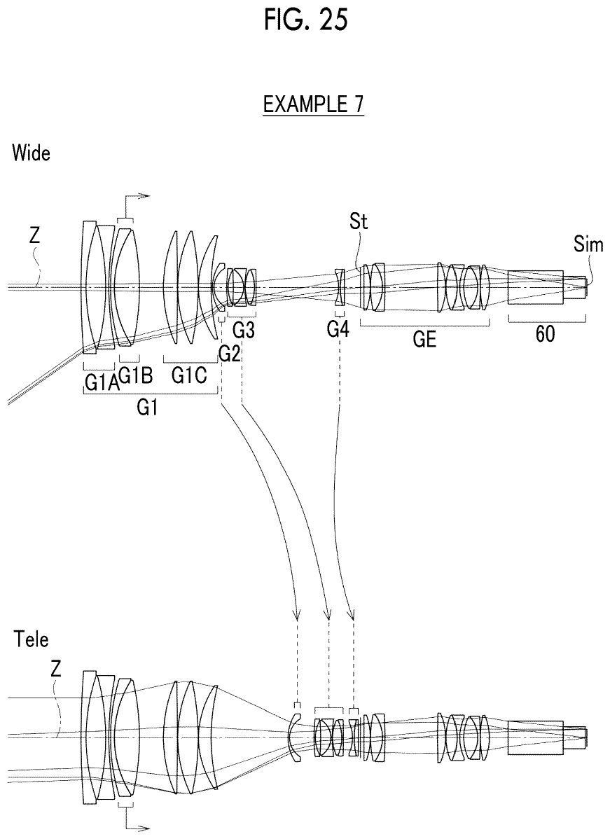

FIG. 25 shows a cross-sectional view showing a configuration of the zoom lens according to Example 7 and movement loci thereof. The zoom lens according to Example 7 consists of, in order from the object side to the image side, a first lens group G1 that has a positive refractive power, a second lens group G2 that has a negative refractive power, a third lens group G3 that has a negative refractive power, a fourth lens group G4 that has a negative refractive power, and a final lens group GE that has a positive refractive power.

The first lens group G1 consists of a first A partial group GIA, a first B partial group G1B, and a first C partial group G1C in order from the object side to the image side. The focusing group consists of the first B partial group G1B. During focusing from an infinite distance object to a short range object, the first B partial group G1B moves to the image side, and the other groups are fixed relative to the image plane Sim.

During changing magnification from the wide angle end to the telephoto end, the first lens group G1 and the final lens group GE are fixed relative to the image plane Sim, and the other lens groups move along the optical axis Z while changing a spacing to an adjacent lens group.

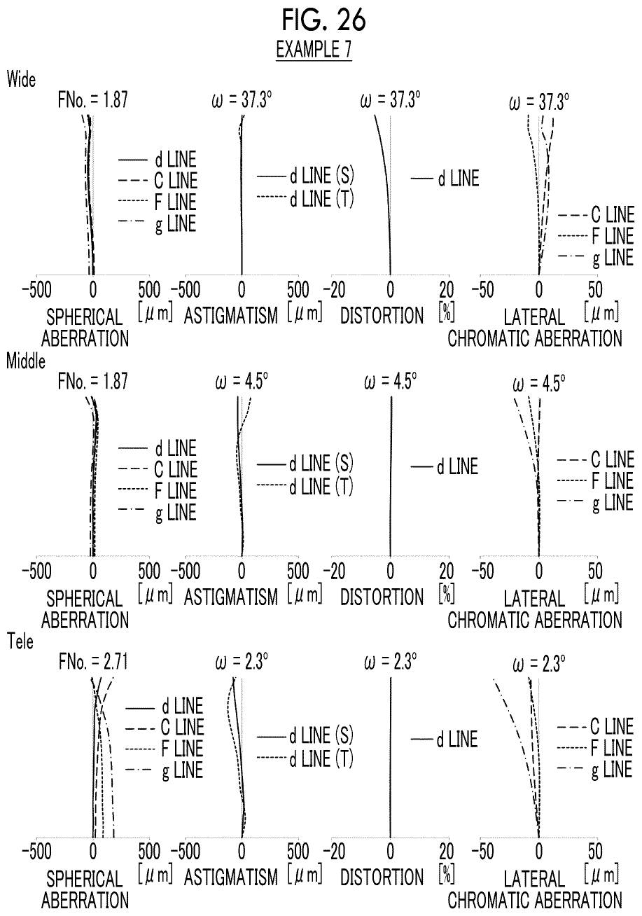

Regarding the zoom lens according to Example 7, Tables 18A and 18B show basic lens data, Table 19 shows specifications and variable surface spacings, Table 20 shows aspherical coefficients, and FIG. 26 shows each of the aberration diagrams.

TABLE 18A
Example 7

| Sn | R | D | Nd | νd | θg, F | ED |
|---|---|---|---|---|---|---|
| *1 | 671.77414 | 3.000 | 1.77250 | 49.60 | 0.55212 | 84.43 |
| 2 | 134.83839 | 11.751 | | | | 78.54 |
| 3 | −163.34259 | 1.900 | 1.79952 | 42.22 | 0.56727 | 77.34 |
| 4 | 210.15742 | 1.010 | | | | 74.95 |
| 5 | 139.46389 | 2.300 | 1.80000 | 29.84 | 0.60178 | 74.55 |
| 6 | 73.42300 | 15.029 | 1.49700 | 81.54 | 0.53748 | 72.72 |
| 7 | −176.74507 | 14.084 | | | | 72.60 |
| 8 | 98.01526 | 8.344 | 1.43387 | 95.18 | 0.53733 | 72.00 |
| 9 | −1700.99520 | 0.200 | | | | 72.00 |
| 10 | 91.11017 | 12.244 | 1.43387 | 95.18 | 0.53733 | 72.00 |
| 11 | −181.34692 | 0.200 | | | | 71.76 |
| *12 | 59.36080 | 7.577 | 1.77250 | 49.60 | 0.55212 | 65.60 |
| 13 | 144.54050 | DD[13] | | | | 64.19 |
| 14 | 30.06227 | 0.900 | 2.00100 | 29.13 | 0.59952 | 29.37 |
| 15 | 15.17225 | DD[15] | | | | 24.32 |
| 16 | 116.70849 | 0.800 | 1.88300 | 40.76 | 0.56679 | 22.52 |
| 17 | 25.26597 | 3.107 | | | | 21.17 |
| 18 | −211.59446 | 6.245 | 1.80809 | 22.76 | 0.63073 | 21.07 |
| 19 | −14.35200 | 0.800 | 1.81600 | 46.62 | 0.55682 | 20.94 |
| 20 | 92.07521 | 0.168 | | | | 20.66 |
| 21 | 29.50300 | 5.505 | 1.65844 | 50.88 | 0.55612 | 20.80 |
| 22 | −29.50300 | 0.900 | 1.88300 | 40.76 | 0.56679 | 20.62 |
| 23 | −546.60461 | DD[23] | | | | 20.63 |
| 24 | 25.83454 | 1.000 | 1.74400 | 44.79 | 0.56560 | 20.00 |
| 25 | 53.63800 | 2.456 | 1.92286 | 18.90 | 0.64960 | 21.90 |
| 26 | −868.61979 | DD[26] | | | | 22.33 |

TABLE 18B
Example 7

| Sn | R | D | Nd | νd | θg, F | ED |
|---|---|---|---|---|---|---|
| 27 | ∞ | 2.146 | | | | 26.06 |
| (St) | | | | | | |
| 28 | ∞ | 3.797 | 1.88300 | 40.76 | 0.56679 | 27.57 |
| 29 | −47.26239 | 0.125 | | | | 28.16 |
| 30 | 75.91716 | 7.143 | 1.58313 | 59.37 | 0.54345 | 28.56 |
| 31 | −27.82500 | 1.500 | 1.80400 | 46.58 | 0.55730 | 28.43 |
| 32 | −253.30015 | 31.474 | | | | 28.86 |
| 33 | 417.33148 | 4.820 | 1.69680 | 55.53 | 0.54341 | 30.90 |
| 34 | −43.56428 | 0.301 | | | | 30.91 |
| 35 | 41.42400 | 6.323 | 1.48749 | 70.24 | 0.53007 | 27.71 |
| 36 | −41.42400 | 1.600 | 1.88300 | 40.76 | 0.56679 | 26.65 |
| 37 | 33.78345 | 2.400 | | | | 24.75 |
| 38 | 34.15631 | 8.354 | 1.49700 | 81.54 | 0.53748 | 25.00 |
| 39 | −22.42000 | 1.500 | 1.80610 | 33.27 | 0.58845 | 24.93 |
| 40 | −244.38285 | 0.720 | | | | 25.91 |
| 41 | 75.80803 | 5.362 | 1.56732 | 42.82 | 0.57309 | 26.37 |
| 42 | −39.89742 | 11.215 | | | | 26.46 |
| 43 | ∞ | 33.000 | 1.58267 | 46.46 | 0.56601 | |
| 44 | ∞ | 13.200 | 1.51633 | 64.05 | 0.53548 | |
| 45 | ∞ | 1.000 | | | | |

TABLE 19
Example 7

| | Wide | Middle | Tele |
|---|---|---|---|
| Zr | 1.0 | 9.2 | 18.2 |
| f | 7.627 | 70.134 | 138.802 |
| FNo. | 1.87 | 1.87 | 2.71 |
| 2ω[°] | 74.6 | 9.0 | 4.6 |
| DD[13] | 0.800 | 42.444 | 46.092 |
| DD[15] | 7.680 | 12.404 | 14.680 |
| DD[23] | 49.515 | 3.203 | 5.551 |
| DD[26] | 9.597 | 9.541 | 1.269 |

TABLE 20
Example 7

| Sn | 1 | 12 |
|---|---|---|
| KA | −1.1446585E+02 | 9.4548358E−01 |
| A3 | 1.2666355E−06 | −4.6817042E−07 |
| A4 | −7.6809035E−07 | −8.8011676E−08 |
| A5 | 1.8354554E−07 | −2.7333584E−08 |
| A6 | −1.7990870E−08 | 6.6176639E−10 |
| A7 | 1.0178179E−09 | 5.6552987E−11 |
| A8 | −3.2762561E−11 | −4.4066434E−12 |
| A9 | 5.2335240E−13 | 4.3364223E−14 |
| A10 | −6.2193449E−15 | 3.6373589E−15 |
| A11 | 4.2543041E−16 | −1.2520638E−17 |
| A12 | −1.8725763E−17 | −6.2786347E−18 |
| A13 | 3.2337532E−19 | 1.0835941E−19 |
| A14 | −7.1198088E−22 | 3.9281113E−21 |
| A15 | −4.1662458E−23 | −1.4316832E−22 |
| A16 | 3.6160304E−25 | 1.2825006E−24 |

### Example 8

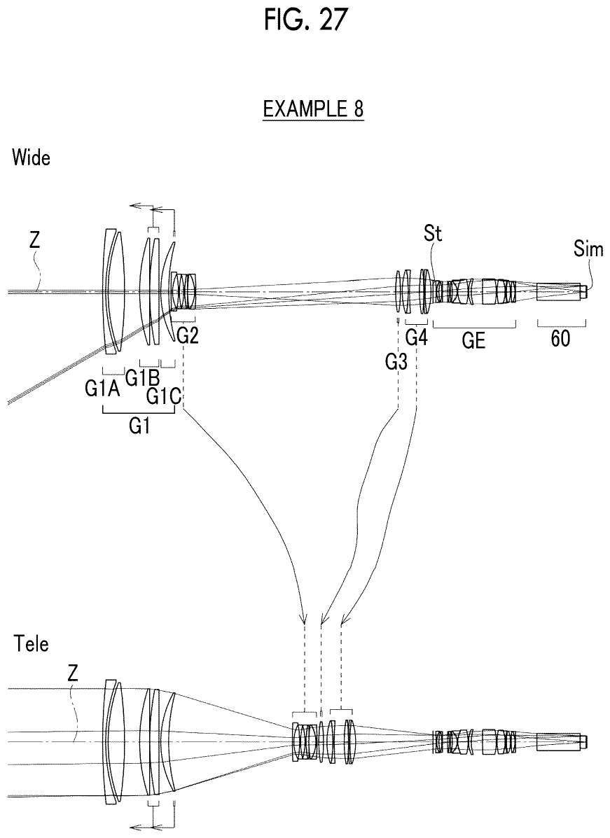

FIG. 27 shows a cross-sectional view showing a configuration of the zoom lens according to Example 8 and movement loci thereof. The zoom lens according to Example 8 consists of, in order from the object side to the image side, a first lens group G1 that has a positive refractive power, a second lens group G2 that has a negative refractive power, a third lens group G3 that has a positive refractive power, a fourth lens group G4 that has a positive refractive power, and a final lens group GE that has a positive refractive power.

The first lens group G1 consists of a first A partial group GIA, a first B partial group G1B, and a first C partial group G1C in order from the object side to the image side. The zoom lens according to Example 8 includes two focusing groups of the first B partial group G1B and the first C partial group G1C. During focusing from the infinite distance object to a short range object, the first B partial group G1B and the first C partial group G1C move to the object side while changing a mutual spacing, and the other groups are fixed relative to the image plane Sim.

During changing magnification from the wide angle end to the telephoto end, the first lens group G1 and the final lens group GE are fixed relative to the image plane Sim, and the other lens groups move along the optical axis Z while changing a spacing to an adjacent lens group.

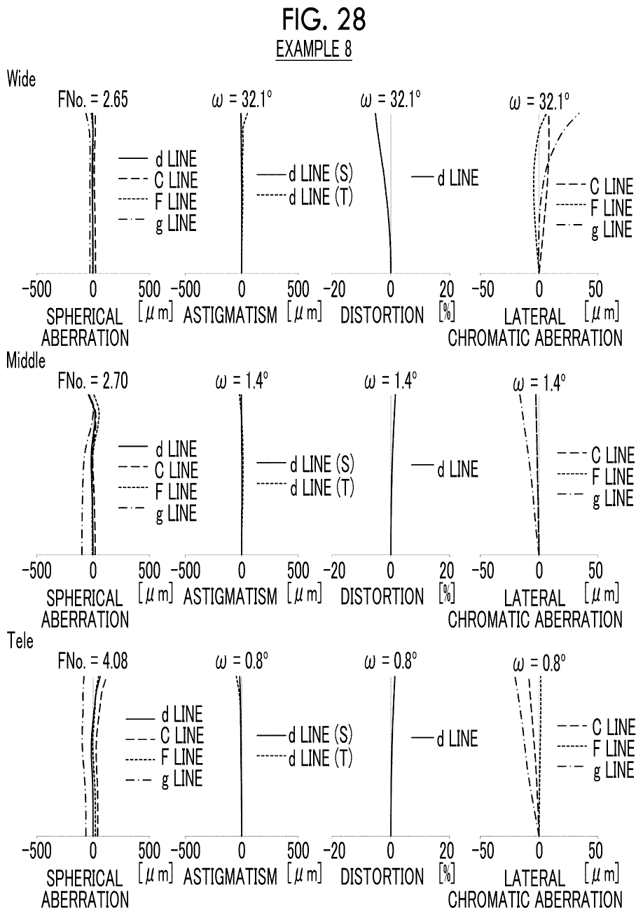

Regarding the zoom lens according to Example 8, Tables 21A and 21B show basic lens data, Table 22 shows specifications and variable surface spacings, Table 23 shows aspherical coefficients, and FIG. 28 shows each of the aberration diagrams.

TABLE 21A
Example 8

| Sn | R | D | Nd | νd | θg, F | ED |
|---|---|---|---|---|---|---|
| 1 | 955.81543 | 4.400 | 1.83400 | 37.21 | 0.58082 | 193.85 |
| 2 | 302.25870 | 3.644 | | | | 186.82 |
| 3 | 297.42207 | 23.792 | 1.43387 | 95.18 | 0.53733 | 185.47 |
| 4 | −722.93744 | 22.015 | | | | 184.07 |
| 5 | 296.36518 | 14.584 | 1.43387 | 95.18 | 0.53733 | 167.71 |
| 6 | ∞ | 0.120 | | | | 167.31 |
| 7 | 476.16920 | 12.551 | 1.43387 | 95.18 | 0.53733 | 165.63 |
| 8 | ∞ | 2.750 | | | | 164.22 |
| 9 | 171.21493 | 11.514 | 1.43875 | 94.94 | 0.53433 | 155.18 |
| 10 | 322.66349 | DD[10] | | | | 153.91 |
| *11 | 1060.94223 | 2.000 | 2.00069 | 25.46 | 0.61364 | 60.37 |
| 12 | 64.68717 | 8.453 | | | | 53.96 |
| 13 | −163.08241 | 1.500 | 1.78800 | 47.37 | 0.55598 | 53.71 |
| 14 | 118.42396 | 6.286 | | | | 52.06 |
| 15 | −103.99855 | 1.512 | 1.73400 | 51.47 | 0.54874 | 52.05 |
| 16 | 129.96228 | 4.079 | 1.89286 | 20.36 | 0.63944 | 53.29 |
| 17 | 1710.87635 | 0.120 | | | | 53.47 |
| 18 | 181.47743 | 10.158 | 1.80518 | 25.42 | 0.61616 | 53.99 |
| 19 | −56.50189 | 1.610 | 1.80400 | 46.53 | 0.55775 | 54.00 |
| 20 | −477.82923 | DD[20] | | | | 54.07 |
| 21 | 212.18454 | 6.985 | 1.43700 | 95.10 | 0.53364 | 63.14 |
| *22 | −213.88627 | DD[22] | | | | 63.67 |
| 23 | 122.76002 | 8.725 | 1.43700 | 95.10 | 0.53364 | 67.22 |
| 24 | −213.35733 | 1.885 | 1.59270 | 35.31 | 0.59336 | 67.17 |
| 25 | 431.03082 | 14.389 | | | | 67.20 |
| *26 | 181.89382 | 6.303 | 1.43700 | 95.10 | 0.53364 | 68.77 |
| 27 | −418.50132 | 0.179 | | | | 68.76 |
| 28 | 620.24327 | 1.875 | 1.84666 | 23.78 | 0.62054 | 68.54 |
| 29 | 276.42951 | 8.433 | 1.43700 | 95.10 | 0.53364 | 68.25 |
| 30 | −118.94996 | DD[30] | | | | 68.18 |

TABLE 21B
Example 8

| Sn | R | D | Nd | νd | θg, F | ED |
|---|---|---|---|---|---|---|
| 31 | ∞ | 4.338 | | | | 35.23 |
| (St) | | | | | | |
| 32 | −472.78842 | 0.875 | 1.59522 | 67.73 | 0.54426 | 33.98 |
| 33 | 37.79609 | 0.120 | | | | 32.90 |
| 34 | 37.07247 | 3.277 | 1.84139 | 24.56 | 0.61874 | 32.95 |
| 35 | 69.41856 | 4.015 | | | | 32.51 |
| 36 | −82.56395 | 0.875 | 1.56732 | 42.82 | 0.57309 | 32.42 |
| 37 | 905.88105 | 7.500 | | | | 32.55 |
| 38 | 1284.12207 | 2.573 | 1.80400 | 46.53 | 0.55775 | 32.97 |
| 39 | −109.09985 | 2.000 | 1.80518 | 25.42 | 0.61616 | 33.01 |
| 40 | −9005.24276 | 2.481 | | | | 33.13 |
| 41 | −95.47382 | 6.235 | 1.74950 | 35.33 | 0.58189 | 33.19 |
| 42 | −25.96179 | 0.885 | 1.71700 | 47.93 | 0.56062 | 33.49 |
| 43 | 40.35994 | 15.010 | 1.51823 | 58.90 | 0.54567 | 35.20 |
| 44 | −82.26735 | 0.730 | | | | 37.99 |
| 45 | 51.46806 | 3.925 | 1.84666 | 23.78 | 0.62054 | 39.65 |
| 46 | 69.32553 | 16.419 | | | | 38.91 |
| 47 | 562.41538 | 19.985 | 1.56883 | 56.36 | 0.54890 | 39.07 |
| 48 | −92.64291 | 1.190 | | | | 38.82 |
| 49 | 88.31713 | 11.717 | 1.56883 | 56.36 | 0.54890 | 37.38 |
| 50 | −56.75558 | 0.875 | 1.91082 | 35.25 | 0.58224 | 35.13 |
| 51 | 101.81604 | 0.976 | | | | 34.44 |
| 52 | 91.40555 | 5.878 | 1.43875 | 94.66 | 0.53402 | 34.50 |
| 53 | −54.68374 | 0.969 | | | | 34.50 |
| 54 | 152.37116 | 5.561 | 1.67270 | 32.10 | 0.59891 | 33.34 |
| 55 | −44.68980 | 0.875 | 1.90366 | 31.31 | 0.59481 | 32.98 |
| 56 | 1213.00724 | 31.081 | | | | 32.54 |
| 57 | ∞ | 63.000 | 1.61340 | 44.27 | 0.56340 | |
| 58 | ∞ | 8.700 | 1.51633 | 64.06 | 0.53479 | |
| 59 | ∞ | 1.002 | | | | |

TABLE 22
Example 8

| | Wide | Middle | Tele |
|---|---|---|---|
| Zr | 1.0 | 24.3 | 44.1 |
| f | 15.545 | 377.017 | 685.486 |
| FNo. | 2.65 | 2.70 | 4.08 |
| 2ω[°] | 64.2 | 2.8 | 1.6 |
| DD[10] | 3.653 | 171.946 | 180.163 |
| DD[20] | 291.030 | 36.788 | 2.597 |
| DD[22] | 2.632 | 11.816 | 4.896 |
| DD[30] | 3.068 | 79.833 | 112.727 |

TABLE 23
Example 8

| Sri | 11 | 22 | 26 |
|---|---|---|---|
| KA | 6.1978006E+00 | 9.9811835E−01 | 8.2319259E−01 |
| A3 | 0.0000000E+00 | 0.0000000E+00 | 0.0000000E+00 |
| A4 | −2.5587406E−07 | 5.1962321E−08 | −4.0666494E−07 |
| A5 | 5.1160236E−08 | 8.4274998E−10 | 5.2880735E−10 |
| A6 | −8.9249504E−09 | −2.8273859E−10 | −7.0874035E−11 |
| A7 | 6.0814387E−10 | 4.2873729E−11 | −5.2379227E−12 |
| A8 | 1.0797567E−11 | −3.5691917E−12 | 1.2421876E−12 |
| A9 | −4.0268206E−12 | 1.4220879E−13 | −7.9683224E−14 |
| A10 | 2.0848289E−13 | 3.2927111E−16 | 1.4939226E−15 |
| A11 | −2.1175268E−15 | −1.7083899E−16 | 9.7794970E−17 |
| A12 | −6.9500528E−17 | −2.7095433E−18 | −5.8766497E−18 |
| A13 | −5.4970526E−18 | 5.7761676E−19 | 3.2692473E−20 |
| A14 | 4.8327527E−19 | −2.0655018E−20 | 5.3001492E−21 |
| A15 | −1.1975879E−20 | 3.1604574E−22 | −1.5392925E−22 |
| A16 | 1.0197283E−22 | −1.8285931E−24 | 1.3258932E−24 |

### Example 9

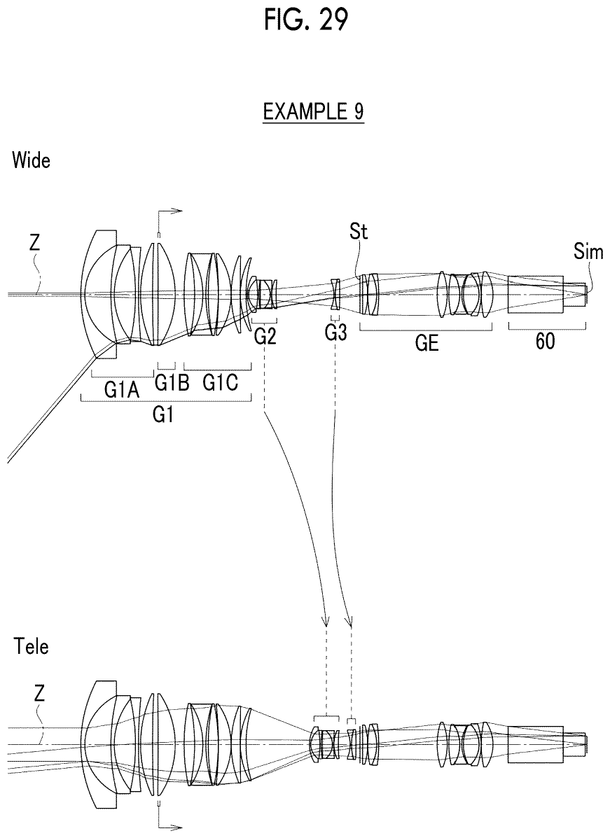

FIG. 29 shows a cross-sectional view showing a configuration of the zoom lens according to Example 9 and movement loci thereof. The zoom lens according to Example 9 consists of, in order from the object side to the image side, a first lens group G1 that has a positive refractive power, a second lens group G2 that has a negative refractive power, a third lens group G3 that has a negative refractive power, and a final lens group GE that has a positive refractive power.

The first lens group G1 consists of a first A partial group GIA, a first B partial group G1B, and a first C partial group G1C in order from the object side to the image side. The focusing group consists of the first B partial group G1B. During focusing from an infinite distance object to a short range object, the first B partial group G1B moves to the image side, and the other groups are fixed relative to the image plane Sim.

During changing magnification from the wide angle end to the telephoto end, the first lens group G1 and the final lens group GE are fixed relative to the image plane Sim, and the other lens groups move along the optical axis Z while changing a spacing to an adjacent lens group.

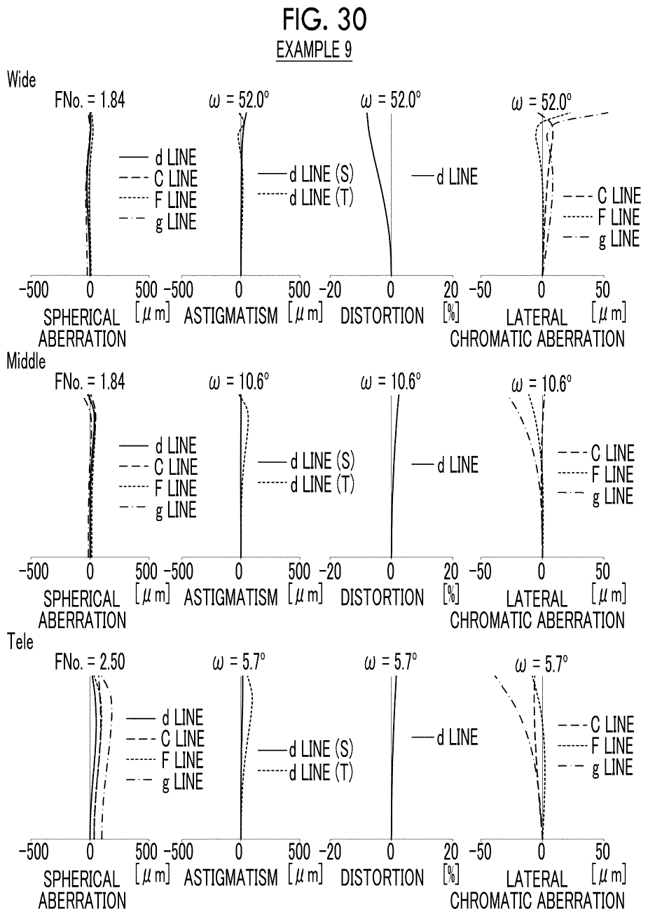

Regarding the zoom lens according to Example 9, Tables 24A and 24B show basic lens data, Table 25 shows specifications and variable surface spacings, and FIG. 30 shows each of the aberration diagrams.

TABLE 24A
Example 9

| Sn | R | D | Nd | νd | θg, F | ED |
|---|---|---|---|---|---|---|
| 1 | 95.91487 | 2.400 | 1.88300 | 40.76 | 0.56679 | 82.70 |
| 2 | 36.12450 | 15.615 | | | | 63.39 |
| 3 | 140.06036 | 2.000 | 1.84661 | 23.88 | 0.62072 | 63.14 |
| 4 | 50.07573 | 12.712 | | | | 58.92 |
| 5 | −147.94361 | 1.800 | 1.88300 | 40.76 | 0.56679 | 58.95 |
| 6 | 318.56728 | 1.256 | | | | 60.80 |
| 7 | 83.80900 | 7.184 | 1.84661 | 23.88 | 0.62072 | 65.96 |
| 8 | 799.46588 | 2.952 | | | | 65.93 |
| 9 | −3351.11805 | 10.325 | 1.61800 | 63.33 | 0.54414 | 65.97 |
| 10 | −63.85813 | 5.306 | | | | 66.00 |
| 11 | 138.67742 | 6.307 | 1.56908 | 71.34 | 0.54530 | 53.40 |
| 12 | −138.67742 | 4.973 | | | | 52.87 |
| 13 | −51.82862 | 1.800 | 1.66680 | 33.05 | 0.59619 | 52.46 |
| 14 | 95.52646 | 1.406 | | | | 52.30 |
| 15 | 144.23031 | 5.999 | 1.49700 | 81.54 | 0.53748 | 52.35 |
| 16 | −144.23031 | 0.100 | | | | 52.50 |
| 17 | −252.91497 | 7.583 | 1.56908 | 71.34 | 0.54530 | 52.50 |
| 18 | −48.90474 | 0.100 | | | | 52.60 |
| 19 | 69.81036 | 5.378 | 1.56908 | 71.34 | 0.54530 | 49.80 |
| 20 | 939.90376 | 0.100 | | | | 49.40 |
| 21 | 52.64732 | 3.382 | 1.78590 | 44.20 | 0.56317 | 46.87 |
| 22 | 87.32066 | DD[22] | | | | 46.17 |
| 23 | 24.63577 | 0.800 | 2.00330 | 28.27 | 0.59802 | 22.24 |
| 24 | 11.86617 | 5.393 | | | | 18.50 |
| 25 | −68.35692 | 0.800 | 1.88300 | 40.76 | 0.56679 | 18.32 |
| 26 | 64.68738 | 0.830 | | | | 18.03 |
| 27 | 487.78083 | 5.963 | 1.84661 | 23.88 | 0.62072 | 18.03 |
| 28 | −12.20900 | 0.800 | 1.88300 | 40.76 | 0.56679 | 17.99 |
| 29 | 158.93514 | 0.100 | | | | 18.05 |
| 30 | 24.46771 | 2.599 | 1.57501 | 41.50 | 0.57672 | 18.26 |
| 31 | 102.74546 | DD[31] | | | | 18.00 |

TABLE 24B
Example 9

| Sri | R | D | Nd | νd | θg, F | ED |
|---|---|---|---|---|---|---|
| 32 | −23.79077 | 0.800 | 1.77250 | 49.60 | 0.55212 | 17.52 |
| 33 | 35.60400 | 2.721 | 1.80518 | 25.42 | 0.61616 | 19.07 |
| 34 | −175.80975 | DD[34] | | | | 19.50 |
| 35 | ∞ | 1.600 | | | | 23.80 |
| (St) | | | | | | |
| 36 | ∞ | 3.019 | 1.79952 | 42.22 | 0.56727 | 24.92 |
| 37 | −49.15419 | 0.100 | | | | 25.41 |
| 38 | 74.83870 | 5.331 | 1.57501 | 41.50 | 0.57672 | 26.10 |
| 39 | −30.91800 | 1.200 | 1.88300 | 40.76 | 0.56679 | 26.11 |
| 40 | −101.31856 | 35.031 | | | | 26.64 |
| 41 | 49.65913 | 6.013 | 1.48749 | 70.24 | 0.53007 | 29.39 |
| 42 | −43.11720 | 1.000 | | | | 29.20 |
| 43 | 63.02295 | 6.202 | 1.48749 | 70.24 | 0.53007 | 26.00 |
| 44 | −26.24800 | 1.200 | 1.88300 | 40.76 | 0.56679 | 25.25 |
| 45 | 24.62861 | 1.000 | | | | 24.40 |
| 46 | 29.16045 | 9.419 | 1.49700 | 81.54 | 0.53748 | 25.00 |
| 47 | −19.38400 | 1.200 | 1.88300 | 40.76 | 0.56679 | 25.44 |
| 48 | −43.78312 | 0.100 | | | | 27.37 |
| 49 | 75.22474 | 7.017 | 1.51633 | 64.14 | 0.53531 | 28.81 |
| 50 | −28.06086 | 9.057 | | | | 29.00 |
| 51 | ∞ | 33.000 | 1.58267 | 46.46 | 0.56601 | |
| 52 | ∞ | 13.200 | 1.51633 | 64.05 | 0.53548 | |
| 53 | ∞ | 1.000 | | | | |

TABLE 25
Example 9

| | Wide | Middle | Tele |
|---|---|---|---|
| Zr | 1.0 | 6.2 | 11.6 |
| f | 4.670 | 28.781 | 54.179 |
| FNo. | 1.84 | 1.84 | 2.50 |
| 2ω[°] | 104.0 | 21.2 | 11.4 |
| DD[22] | 0.756 | 33.492 | 38.063 |
| DD[31] | 34.653 | 3.571 | 7.074 |
| DD[34] | 12.079 | 10.424 | 2.351 |

Table 26 shows the corresponding values of Conditional Expressions (1) and (5) to (8) of the zoom lenses of Examples 1 to 9. Examples of the corresponding values of Conditional Expressions (2) to (4) are as shown in FIG. 6. The unit of the corresponding values of Conditional Expression (1) of Table 26 is millimeters (mm). Preferable ranges of the conditional expressions may be set by using the values shown in Table 26 and FIG. 6 as the upper limits or the lower limits of the conditional expressions.

TABLE 26

| Expression | | Exam- | Exam- | Exam- | Exam- | Exam- |
|---|---|---|---|---|---|---|
| Number | | ple 1 | ple 2 | ple 3 | ple 4 | ple 5 |
| (1) | 0.49 × f × tanω | 2.89 | 2.82 | 2.84 | 2.98 | 2.97 |
| (5) | FNot/(ft/fw) | 0.17 | 0.09 | 0.05 | 0.12 | 0.13 |
| (6) | fn/ft | −0.24 | −0.06 | −0.04 | −0.13 | −0.08 |
| (7) | Bfw/(fw × tanωw) | 6.84 | 5.48 | 7.97 | 6.80 | 6.70 |
| (8) | \|De × pw/fw\| | 19.51 | 38.79 | 12.56 | 31.37 | 37.86 |

| Expression | | Exam- | Exam- | Exam- | Exam- |
|---|---|---|---|---|---|
| Number | | ple 6 | ple 7 | ple 8 | ple 9 |
| (1) | 0.49 × f × tanω | 2.85 | 2.93 | 4.78 | 2.77 |
| (5) | FNot/(ft/fw) | 0.15 | 0.22 | 0.09 | 0.25 |
| (6) | fn/ft | −0.23 | −0.32 | −0.05 | −0.04 |
| (7) | Bfw/(fw × tanωw) | 7.19 | 6.63 | 7.87 | 7.19 |
| (8) | \|De × pw/fw\| | 15.93 | 353.08 | 10.45 | 6.43 |

Tables 27 to 29 show the value of Dexp at each of the focal lengths of the zoom lenses according to Examples 1 to 9. The values shown in Tables 27 to 29 are values in a state where the zoom lens is focused on an infinite distance object.

TABLE 27

| Example 1 | | Example 2 | | Example 3 | |
|---|---|---|---|---|---|
| Focal | | Focal | | Focal | |
| Distance | Dexp | Distance | Dexp | Distance | Dexp |
| 5.73 | −111.80 | 9.83 | 381.39 | 9.20 | −115.52 |
| 8.61 | −111.48 | 13.88 | 619.71 | 12.95 | −115.09 |
| 12.94 | −111.54 | 19.59 | 659.29 | 18.22 | −114.88 |
| 19.44 | −111.80 | 27.66 | 658.73 | 25.64 | −114.87 |
| 29.21 | −111.75 | 39.04 | 659.08 | 36.09 | −115.02 |
| 43.90 | −671.95 | 55.11 | 659.73 | 50.79 | −115.18 |
| 65.97 | 82.48 | 77.80 | 660.73 | 71.47 | −115.28 |
| 99.12 | 50.60 | 109.82 | 660.97 | 100.58 | −115.27 |
| | | 155.03 | 156.68 | 141.55 | −115.25 |
| | | 218.84 | 56.83 | 199.20 | −115.16 |
| | | 308.92 | 47.88 | 280.33 | −202.44 |
| | | 436.08 | 71.85 | 394.51 | 100.50 |
| | | | | 555.19 | 60.41 |
| | | | | 781.31 | 74.40 |

TABLE 28

| Example 4 | | Example 5 | | Example 6 | |
|---|---|---|---|---|---|
| Focal | | Focal | | Focal | |
| Distance | Dexp | Distance | Dexp | Distance | Dexp |
| 7.88 | −247.20 | 8.09 | −306.31 | 15.67 | −100.84 |
| 9.69 | −274.35 | 9.98 | −237.98 | 19.32 | −101.37 |
| 11.91 | −275.23 | 12.30 | −261.77 | 23.82 | −102.27 |
| 14.63 | −286.19 | 15.16 | −279.68 | 29.37 | −102.89 |
| 17.99 | −306.84 | 18.69 | −283.87 | 36.21 | −103.05 |
| 22.11 | −322.55 | 23.05 | −286.03 | 44.64 | −103.19 |
| 27.18 | −315.82 | 28.41 | −281.16 | 55.04 | −103.11 |
| 33.41 | −304.04 | 35.03 | −269.88 | 67.85 | −102.76 |
| 41.07 | −289.53 | 43.19 | −262.03 | 83.65 | −102.53 |
| 50.48 | −283.11 | 53.25 | −243.96 | 103.13 | −101.74 |
| 62.05 | −274.43 | 65.64 | −226.02 | 127.15 | −100.83 |
| 76.28 | −316.87 | 80.93 | 838.05 | 156.76 | −100.60 |
| 93.76 | 158.33 | 99.78 | 108.65 | 193.27 | −115.75 |
| 115.25 | 75.28 | 123.02 | 64.33 | 238.28 | −238.67 |
| 141.67 | 54.37 | 151.66 | 48.47 | 293.77 | 1701.14 |
| 174.14 | 43.53 | 186.98 | 41.96 | 362.18 | −821.45 |

TABLE 29

| Example 7 | | Example 8 | | Example 9 | |
|---|---|---|---|---|---|
| Focal | | Focal | | Focal | |
| Distance | Dexp | Distance | Dexp | Distance | Dexp |
| 7.63 | −121.50 | 15.55 | −162.44 | 4.67 | −1648.92 |
| 9.05 | −122.62 | 18.97 | −163.82 | 5.05 | −2071.10 |
| 10.73 | −123.17 | 23.16 | −164.45 | 5.47 | −2654.21 |
| 12.73 | −123.41 | 28.27 | −164.76 | 5.92 | −3460.12 |
| 15.10 | −123.49 | 34.50 | −164.86 | 6.41 | −4583.70 |
| 17.91 | −123.50 | 42.11 | −164.84 | 6.93 | −6169.34 |
| 21.24 | −123.51 | 51.39 | −164.74 | 7.50 | −8434.66 |
| 25.19 | −123.54 | 62.73 | −164.61 | 8.12 | −11695.55 |
| 29.88 | −123.58 | 76.56 | −164.49 | 8.79 | −16361.08 |
| 35.44 | −123.55 | 93.44 | −164.41 | 9.51 | −22791.92 |
| 42.03 | −123.40 | 114.05 | −164.39 | 10.30 | −30795.45 |
| 49.86 | −123.19 | 139.20 | −171.66 | 11.14 | −38715.05 |
| 59.13 | −189.95 | 169.90 | −189.99 | 12.06 | −43393.63 |
| 70.14 | 583.08 | 207.37 | −214.71 | 13.05 | −42798.73 |
| 83.19 | 132.38 | 253.10 | −248.92 | 14.13 | −38226.40 |
| 98.67 | 80.17 | 308.92 | −322.85 | 15.29 | −32371.72 |
| 117.04 | 60.13 | 377.04 | −608.92 | 16.55 | −26967.54 |
| 138.82 | 49.65 | 460.19 | 662.09 | 17.91 | −22585.75 |
| | | 561.68 | 237.27 | 19.38 | −19235.86 |
| | | 685.55 | 153.02 | 20.98 | −16775.79 |
| | | | | 22.70 | −15092.51 |
| | | | | 24.57 | 333.10 |
| | | | | 26.59 | 152.50 |
| | | | | 28.78 | 101.90 |
| | | | | 31.15 | 78.11 |
| | | | | 33.71 | 64.31 |
| | | | | 36.48 | 55.31 |
| | | | | 39.49 | 49.00 |
| | | | | 42.73 | 44.34 |
| | | | | 46.25 | 40.76 |
| | | | | 50.05 | 37.93 |
| | | | | 54.17 | 35.65 |

### Modification Example

The present disclosed technology has been hitherto described through the embodiments and the examples, but the present disclosed technology is not limited to the above-described embodiments and examples, and may be modified into various forms. For example, the curvature radius, the surface spacing, the refractive index, the Abbe number, the aspherical coefficient, and the like of each of the lenses including the zoom lens are not limited to the values shown in the examples, and different values may be used therefor.

The zoom lens may include a vibration-proof group consisting of at least one lens that moves during image shake correction. The lens device may include an image shake detection unit that detects a position of the vibration-proof group to detect a state of image shake correction using the detected position. In this case, it is preferable that correction data for correcting color shading has a correction value that is set depending on the state of the image shake correction.

In the above-described examples, as the color separation prism, a three-plate color separation prism that separates a luminous flux into three light components in order of blue light, red light, and green light has been described. However, the color separation prism according to the present disclosure is not limited to the above-described example. In the present disclosed technology, the colors of luminous fluxes to be separated, the order of separation of the respective color luminous fluxes, and the number of the luminous fluxes to be separated may be different from the above-described examples.

In the above description, the example where the imaging apparatus body includes the processing unit that performs the color shading correction has been described. In the present disclosed technology, the lens device may include the processing unit that performs the color shading correction.

The imaging apparatus according to the present disclosure is not limited to the broadcast camera, and may adopt various aspects, for example, a movie camera, a digital camera, a video camera, a surveillance camera, a camera for factory automation (FA), or a camera for machine vision (MV).

Regarding the above-described embodiments and examples, the following supplementary notes will be further disclosed.

### Supplementary Note 1

A lens device comprising:
a zoom lens,
in which the zoom lens includes a first lens group that includes a focusing group moving during focusing, is disposed closest to an object side, and is fixed relative to an image plane during changing magnification, a plurality of movable lens groups that move while changing a spacing to an adjacent lens group during changing magnification, and a final lens group that is disposed closest to an image side and is fixed relative to the image plane during changing magnification,
the lens device
is attachable to and detachable from an imaging apparatus body including a color separation prism, and
includes a storage unit that stores correction data for correcting color shading of image data obtained in a case where an image formed by the zoom lens is captured through the color separation prism in the imaging apparatus body, and
a communication unit that transmits the correction data to the imaging apparatus body,
the correction data has a correction value that is set for each combination of a zoom state, a focus state, and an aperture state of the zoom lens at a specific image height, and
in a case where a focal length and a maximum half angle of view of the zoom lens in each zoom state are represented by f and ω, respectively, and a unit of f is mm, the specific image height is defined by 0.49×f×tan ω, and
Conditional Expression (1) represented by

$$1.5 mm < 0.49 \times f \times tan ω < 5 mm \qquad ( 1 )$$

is satisfied.

### Supplementary Note 2

A lens device comprising:
a zoom lens, in which the zoom lens includes a first lens group that includes a focusing group moving during focusing, is disposed closest to an object side, and is fixed relative to an image plane during changing magnification, a plurality of movable lens groups that move while changing a spacing to an adjacent lens group during changing magnification, and a final lens group that is disposed closest to an image side and is fixed relative to the image plane during changing magnification,
the lens device
is attachable to and detachable from an imaging apparatus body including a color separation prism, and
includes a storage unit that stores correction data for correcting color shading of image data obtained in a case where an image formed by the zoom lens is captured through the color separation prism in the imaging apparatus body, and
a communication unit that transmits the correction data to the imaging apparatus body,
the correction data has a correction value that is set for each combination of a zoom state, a focus state, and an aperture state of the zoom lens, and
in a case where the number of the zoom states, the number of the focus states, and the number of the aperture states in groups of the combination are represented by Nz, Nf, and Na, respectively,
Conditional Expressions (2) and (3) represented by

$$0.05 \leq Nf / ( Nz \times Na ) \leq 0.3 , and \qquad ( 2 )$$

$$8 \leq ( Nz \times Nf ) / Na \leq 256 \qquad ( 3 )$$

are satisfied.

### Supplementary Note 3

The lens device according to Supplementary Note 2,
in which in a case where a focal length and a maximum half angle of view of the zoom lens in each zoom state are represented by f and ω, respectively, and a unit of f is mm, the correction value is a value at a specific image height that is defined by 0.49×f×tan ω, and
Conditional Expression (1) represented by

$$1.5 mm < 0.49 \times f \times tan ω < 5 mm \qquad ( 1 )$$

is satisfied.

### Supplementary Note 4

The lens device according to any one of Supplementary Notes 1 to 3,
in which in a case where the number of the zoom states, the number of the focus states, and the number of the aperture states in groups of the combination are represented by Nz, Nf, and Na, respectively,
Conditional Expression (4) represented by

$$256 \leq Nz \times Nf \times Na \leq 2048 \qquad ( 4 )$$

is satisfied.

### Supplementary Note 5

The lens device according to any one of Supplementary Notes 1 to 4, in which in a case where the focal length and the maximum half angle of view of the zoom lens in each zoom state are represented by f and ω, respectively, and the unit of f is mm, the correction value is a value at a specific image height that is defined by 0.49×f×tan ω,
in a case where a ray that is incident at a bisected angle of an angle between an upper ray and a lower ray among rays that are incident at the specific image height of the image plane of the zoom lens is a middle ray,
a focal length of the zoom lens in a state where an infinite distance object at a telephoto end is in focus is represented by ft,
a focal length of the zoom lens in a state where an infinite distance object at a wide angle end is in focus is represented by fw,
a distance from the image plane of the zoom lens in a state where an infinite distance object is in focus to an exit pupil position of the middle ray is represented by Dexp, and
a sign of Dexp is positive for a distance on the image side and is negative for a distance on the object side with respect to the image plane,
Dexp of the zoom lens at the wide angle end is negative,
Dexp of the zoom lens at the telephoto end is positive, and
a focal length of the zoom lens in a state where Dexp is infinite is in a range of fw×(ft/fw)^{0.6} or more and fw×(ft/fw)^{0.9} or less.

### Supplementary Note 6

The lens device according to any one of Supplementary Notes 1 to 5,
in which the zoom lens consists of, in order from the object side to the image side, the first lens group that has a positive refractive power, a second lens group that has a negative refractive power and moves during changing magnification, one or more and three or less lens groups that move while changing a spacing to an adjacent lens group during changing magnification, and the final lens group that has a positive refractive power.

### Supplementary Note 7

The lens device according to any one of Supplementary Notes 1 to 5,
in which the zoom lens consists of, in order from the object side to the image side, the first lens group that has a positive refractive power, a second lens group that has a negative refractive power, a third lens group that has a negative refractive power, and the final lens group that has a positive refractive power, and
during changing magnification, the second lens group and the third lens group move while changing a mutual spacing.

### Supplementary Note 8

The lens device according to any one of Supplementary Notes 1 to 5,
in which the zoom lens consists of, in order from the object side to the image side, the first lens group that has a positive refractive power, a second lens group that has a negative refractive power, a third lens group that has a negative refractive power, a fourth lens group that has a positive refractive power, and the final lens group that has a positive refractive power, and
during changing magnification, the second lens group, the third lens group, and the fourth lens group move while changing a spacing to an adjacent lens group.

### Supplementary Note 9

The lens device according to any one of Supplementary Notes 1 to 5,
in which the zoom lens consists of, in order from the object side to the image side, the first lens group that has a positive refractive power, a second lens group that has a negative refractive power, a third lens group that has a positive refractive power, a fourth lens group that has a positive refractive power, and the final lens group that has a positive refractive power, and
during changing magnification, the second lens group, the third lens group, and the fourth lens group move while changing a spacing to an adjacent lens group.

### Supplementary Note 10

The lens device according to any one of Supplementary Notes 1 to 5,
in which the zoom lens consists of, in order from the object side to the image side, the first lens group that has a positive refractive power, a second lens group that has a negative refractive power, a third lens group that has a negative refractive power, a fourth lens group that has a negative refractive power, a fifth lens group that has a negative refractive power, and the final lens group that has a positive refractive power, and
during changing magnification, the second lens group, the third lens group, the fourth lens group, and the fifth lens group move while changing a spacing to an adjacent lens group.

### Supplementary Note 11

The lens device according to any one of Supplementary Notes 1 to 5,
in which the zoom lens consists of, in order from the object side to the image side, the first lens group that has a positive refractive power, a second lens group that has a negative refractive power, a third lens group that has a positive refractive power, a fourth lens group that has a negative refractive power, a fifth lens group that has a positive refractive power, and the final lens group that has a positive refractive power, and
during changing magnification, the second lens group, the third lens group, the fourth lens group, and the fifth lens group move while changing a spacing to an adjacent lens group.

### Supplementary Note 12

The lens device according to any one of Supplementary Notes 1 to 5,
in which the zoom lens consists of, in order from the object side to the image side, the first lens group that has a positive refractive power, a second lens group that has a negative refractive power, a third lens group that has a negative refractive power, a fourth lens group that has a negative refractive power, a fifth lens group that has a negative refractive power, and the final lens group that has a positive refractive power, and
during changing magnification, the second lens group, the third lens group, the fourth lens group, and the fifth lens group move while changing a spacing to an adjacent lens group.

### Supplementary Note 13

The lens device according to any one of Supplementary Notes 1 to 12, further comprising:
an EX group that is insertable into and removable from an optical path of the zoom lens and changes a focal length depending on the insertion and removal; and
an insertion/removal detection unit that detects a state of the insertion and removal,
in which the correction value is set depending on the state of the insertion and removal.

### Supplementary Note 14

The lens device according to any one of Supplementary Notes 1 to 13,
in which in a case where an open F-number of the zoom lens in a state where an infinite distance object at a telephoto end is in focus is represented by Fnot,
a focal length of the zoom lens in a state where an infinite distance object at a telephoto end is in focus is represented by ft, and
a focal length of the zoom lens in a state where an infinite distance object at a wide angle end is in focus is represented by fw,
Conditional Expression (5) represented by

$$0.03 < FNot / ( f t / fw ) < 0.3 \qquad ( 5 )$$

is satisfied.

### Supplementary Note 15

The lens device according to any one of Supplementary Notes 1 to 14,
in which in a case where a focal length of a lens group that has a strongest negative refractive power among lens groups that have a negative refractive power and move during changing magnification in the zoom lens is represented by fn, and
a focal length of the zoom lens in a state where an infinite distance object at a telephoto end is in focus is represented by ft,
Conditional Expression (6) represented by

$$- 0.4 < fn / f t < - 0.02 \qquad ( 6 )$$

is satisfied.

### Supplementary Note 16

The lens device according to any one of Supplementary Notes 1 to 15,
in which the first lens group of the zoom lens consists of, in order from the object side to the image side, a first A partial group that is fixed relative to the image plane during focusing and has a negative refractive power, a first B partial group that moves along an optical axis during focusing and has a positive refractive power, and a first C partial group that changes a spacing to the first B partial group during focusing.

### Supplementary Note 17

The lens device according to any one of Supplementary Notes 1 to 16,
in which in a case where a back focus of the zoom lens in terms of an air conversion distance is represented by Bfw,
a focal length of the zoom lens in a state where an infinite distance object at a wide angle end is in focus is represented by fw, and
a maximum half angle of view of the zoom lens in a state where the infinite distance object at the wide angle end is in focus is represented by ωw,
Conditional Expression (7) represented by

$$4 < Bfw / ( fw \times tan ω w ) < 10 \qquad ( 7 )$$

is satisfied.

### Supplementary Note 18

The lens device according to any one of Supplementary Notes 1 to 17,
in which in a case where the focal length and the maximum half angle of view of the zoom lens in each zoom state are represented by f and ω, respectively, and the unit of f is mm, the correction value is a value at a specific image height that is defined by 0.49×f×tan ω,
in a case where a ray that is incident at a bisected angle of an angle between an upper ray and a lower ray among rays that are incident at the specific image height of the image plane of the zoom lens is a middle ray,
a focal length of the zoom lens in a state where an infinite distance object at a wide angle end is in focus is represented by fw,
a distance from the image plane of the zoom lens in a state where the infinite distance object at the wide angle end is in focus to an exit pupil position of the middle ray is represented by Dexpw, and
Dexpw is calculated using an air conversion distance for an optical member that does not have a refractive power and is disposed between the image plane and the exit pupil position of the middle ray,
Conditional Expression (8) represented by

$$4 < \vert Dexpw / fw \vert < 360 \qquad ( 8 )$$

is satisfied.

### Supplementary Note 19

The lens device according to any one of Supplementary Notes 1 to 18,
in which in a case where the focal length and the maximum half angle of view of the zoom lens in each zoom state are represented by f and ω, respectively, and the unit of f is mm, the correction value is a value at a specific image height that is defined by 0.49×f×tan ω,
in a state where the zoom lens is focused on an infinite distance object, in an entire zoom range, an exit pupil position of a principal ray at the specific image height is positioned closer to the image side than the image plane.

### Supplementary Note 20

An imaging apparatus comprising:
the lens device according to any one of Supplementary Notes 1 to 19; and
the imaging apparatus body,
in which the imaging apparatus body includes
the color separation prism,
an imaging element that captures the image formed by the zoom lens, and
a processing unit that performs a process of correcting color shading of the image data based on the correction data transmitted from the lens device.

What is claimed is:

1. A lens device comprising:
a zoom lens,
wherein the zoom lens includes a first lens group that includes a focusing group moving during focusing, is disposed closest to an object side, and is fixed relative to an image plane during changing magnification, a plurality of movable lens groups that move while changing a spacing to an adjacent lens group during changing magnification, and a final lens group that is disposed closest to an image side and is fixed relative to the image plane during changing magnification,
the lens device
is attachable to and detachable from an imaging apparatus body including a color separation prism, and
includes a storage unit that stores correction data for correcting color shading of image data obtained in a case where an image formed by the zoom lens is captured through the color separation prism in the imaging apparatus body, and
a communication unit that transmits the correction data to the imaging apparatus body,
the correction data has a correction value that is set for each combination of a zoom state, a focus state, and an aperture state of the zoom lens at a specific image height, and
in a case where a focal length and a maximum half angle of view of the zoom lens in each zoom state are represented by f and ω, respectively, and a unit of f is mm, the specific image height is defined by 0.49×f×tan ω, and
Conditional Expression (1) represented by
$$1.5 mm < 0.49 \times f \times tan ω < 5 mm \qquad ( 1 )$$
is satisfied.

2. A lens device comprising:
a zoom lens,
wherein the zoom lens includes a first lens group that includes a focusing group moving during focusing, is disposed closest to an object side, and is fixed relative to an image plane during changing magnification, a plurality of movable lens groups that move while changing a spacing to an adjacent lens group during changing magnification, and a final lens group that is disposed closest to an image side and is fixed relative to the image plane during changing magnification,
the lens device
is attachable to and detachable from an imaging apparatus body including a color separation prism, and
includes a storage unit that stores correction data for correcting color shading of image data obtained in a case where an image formed by the zoom lens is captured through the color separation prism in the imaging apparatus body, and
a communication unit that transmits the correction data to the imaging apparatus body,
the correction data has a correction value that is set for each combination of a zoom state, a focus state, and an aperture state of the zoom lens, and
in a case where the number of the zoom states, the number of the focus states, and the number of the aperture states in groups of the combination are represented by Nz, Nf, and Na, respectively,
Conditional Expressions (2) and (3) represented by
$$0.05 \leq Nf / ( Nz \times Na ) \leq 0.3 , and \qquad ( 2 )$$
$$8 \leq ( Nz \times Nf ) / Na \leq 256 \qquad ( 3 )$$
are satisfied.

3. The lens device according to claim 2,
wherein in a case where a focal length and a maximum half angle of view of the zoom lens in each zoom state are represented by f and ω, respectively, and a unit of f is mm, the correction value is a value at a specific image height that is defined by 0.49×f×tan ω, and
Conditional Expression (1) represented by
$$1.5 mm < 0.49 \times f \times tan ω < 5 mm \qquad ( 1 )$$
is satisfied.

4. The lens device according to claim 2,
wherein in a case where the number of the zoom states, the number of the focus states, and the number of the aperture states in groups of the combination are represented by Nz, Nf, and Na, respectively,
Conditional Expression (4) represented by
$$256 \leq Nz \times Nf \times Na \leq 2048 \qquad ( 4 )$$
is satisfied.

5. The lens device according to claim 1,
wherein in a case where the focal length and the maximum half angle of view of the zoom lens in each zoom state are represented by f and ω, respectively, and the unit of f is mm, the correction value is a value at a specific image height that is defined by 0.49×f×tan ω, and
in a case where a ray that is incident at a bisected angle of an angle between an upper ray and a lower ray among rays that are incident at the specific image height of the image plane of the zoom lens is a middle ray,
a focal length of the zoom lens in a state where an infinite distance object at a telephoto end is in focus is represented by ft,
a focal length of the zoom lens in a state where an infinite distance object at a wide angle end is in focus is represented by fw,
a distance from the image plane of the zoom lens in a state where an infinite distance object is in focus to an exit pupil position of the middle ray is represented by Dexp, and
a sign of Dexp is positive for a distance on the image side and is negative for a distance on the object side with respect to the image plane,
Dexp of the zoom lens at the wide angle end is negative,
Dexp of the zoom lens at the telephoto end is positive, and
a focal length of the zoom lens in a state where Dexp is infinite is in a range of fw×(ft/fw)^{0.6} or more and fw×(ft/fw)^{0.9} or less.

6. The lens device according to claim 1,
wherein the zoom lens consists of, in order from the object side to the image side, the first lens group that has a positive refractive power, a second lens group that has a negative refractive power and moves during changing magnification, one or more and three or less lens groups that move while changing a spacing to an adjacent lens group during changing magnification, and the final lens group that has a positive refractive power.

7. The lens device according to claim 1,
wherein the zoom lens consists of, in order from the object side to the image side, the first lens group that has a positive refractive power, a second lens group that has a negative refractive power, a third lens group that has a negative refractive power, and the final lens group that has a positive refractive power, and
during changing magnification, the second lens group and the third lens group move while changing a mutual spacing.

8. The lens device according to claim 1,
wherein the zoom lens consists of, in order from the object side to the image side, the first lens group that has a positive refractive power, a second lens group that has a negative refractive power, a third lens group that has a negative refractive power, a fourth lens group that has a positive refractive power, and the final lens group that has a positive refractive power, and
during changing magnification, the second lens group, the third lens group, and the fourth lens group move while changing a spacing to an adjacent lens group.

9. The lens device according to claim 1,
wherein the zoom lens consists of, in order from the object side to the image side, the first lens group that has a positive refractive power, a second lens group that has a negative refractive power, a third lens group that has a positive refractive power, a fourth lens group that has a positive refractive power, and the final lens group that has a positive refractive power, and
during changing magnification, the second lens group, the third lens group, and the fourth lens group move while changing a spacing to an adjacent lens group.

10. The lens device according to claim 1,
wherein the zoom lens consists of, in order from the object side to the image side, the first lens group that has a positive refractive power, a second lens group that has a negative refractive power, a third lens group that has a negative refractive power, a fourth lens group that has a negative refractive power, a fifth lens group that has a negative refractive power, and the final lens group that has a positive refractive power, and
during changing magnification, the second lens group, the third lens group, the fourth lens group, and the fifth lens group move while changing a spacing to an adjacent lens group.

11. The lens device according to claim 1,
wherein the zoom lens consists of, in order from the object side to the image side, the first lens group that has a positive refractive power, a second lens group that has a negative refractive power, a third lens group that has a positive refractive power, a fourth lens group that has a negative refractive power, a fifth lens group that has a positive refractive power, and the final lens group that has a positive refractive power, and
during changing magnification, the second lens group, the third lens group, the fourth lens group, and the fifth lens group move while changing a spacing to an adjacent lens group.

12. The lens device according to claim 1,
wherein the zoom lens consists of, in order from the object side to the image side, the first lens group that has a positive refractive power, a second lens group that has a negative refractive power, a third lens group that has a negative refractive power, a fourth lens group that has a negative refractive power, a fifth lens group that has a negative refractive power, and the final lens group that has a positive refractive power, and
during changing magnification, the second lens group, the third lens group, the fourth lens group, and the fifth lens group move while changing a spacing to an adjacent lens group.

13. The lens device according to claim 1, further comprising:
an EX group that is insertable into and removable from an optical path of the zoom lens and changes a focal length depending on the insertion and removal; and
an insertion/removal detection unit that detects a state of the insertion and removal,
wherein the correction value is set depending on the state of the insertion and removal.

14. The lens device according to claim 6,
wherein in a case where an open F-number of the zoom lens in a state where an infinite distance object at a telephoto end is in focus is represented by Fnot,
a focal length of the zoom lens in a state where the infinite distance object at the telephoto end is in focus is represented by ft, and
a focal length of the zoom lens in a state where an infinite distance object at a wide angle end is in focus is represented by fw,
Conditional Expression (5) represented by
$$0.03 < FNot / ( f t / fw ) < 0.3 \qquad ( 5 )$$
is satisfied.

15. The lens device according to claim 6,
wherein in a case where a focal length of a lens group that has a strongest negative refractive power among lens groups that have a negative refractive power and move during changing magnification in the zoom lens is represented by fn, and
a focal length of the zoom lens in a state where an infinite distance object at a telephoto end is in focus is represented by ft,
Conditional Expression (6) represented by
$$- 0.4 < fn / f t < - 0.02 \qquad ( 6 )$$
is satisfied.

16. The lens device according to claim 6,
wherein the first lens group of the zoom lens consists of, in order from the object side to the image side, a first A partial group that is fixed relative to the image plane during focusing and has a negative refractive power, a first B partial group that moves along an optical axis during focusing and has a positive refractive power, and a first C partial group that changes a spacing to the first B partial group during focusing.

17. The lens device according to claim 1,
wherein in a case where a back focus of the zoom lens in terms of an air conversion distance is represented by Bfw,
a focal length of the zoom lens in a state where an infinite distance object at a wide angle end is in focus is represented by fw, and
a maximum half angle of view of the zoom lens in a state where the infinite distance object at the wide angle end is in focus is represented by ωw,
Conditional Expression (7) represented by
$$4 < Bfw / ( fw \times tan ω w ) < 10 \qquad ( 7 )$$
is satisfied.

18. The lens device according to claim 1,
wherein in a case where the focal length and the maximum half angle of view of the zoom lens in each zoom state are represented by f and ω, respectively, and the unit of f is mm, the correction value is a value at a specific image height that is defined by 0.49×f×tan,
in a case where a ray that is incident at a bisected angle of an angle between an upper ray and a lower ray among rays that are incident at the specific image height of the image plane of the zoom lens is a middle ray,
a focal length of the zoom lens in a state where an infinite distance object at a wide angle end is in focus is represented by fw,
a distance from the image plane of the zoom lens in a state where the infinite distance object at the wide angle end is in focus to an exit pupil position of the middle ray is represented by Dexpw, and
Dexpw is calculated using an air conversion distance for an optical member that does not have a refractive power and is disposed between the image plane and the exit pupil position of the middle ray,
Conditional Expression (8) represented by
$$4 < \vert Dexpw / fw \vert < 360 \qquad ( 8 )$$
is satisfied.

19. The lens device according to claim 1,
wherein in a case where the focal length and the maximum half angle of view of the zoom lens in each zoom state are represented by f and ω, respectively, and the unit of f is mm, the correction value is a value at a specific image height that is defined by 0.49×f×tan ω, and
in a state where the zoom lens is focused on an infinite distance object, in an entire zoom range, an exit pupil position of a principal ray at the specific image height is positioned closer to the image side than the image plane.

20. An imaging apparatus comprising
the lens device according to claim 1; and
the imaging apparatus body,
wherein the imaging apparatus body includes
the color separation prism,
an imaging element that captures the image formed by the zoom lens, and
a processing unit that performs a process of correcting color shading of the image data based on the correction data transmitted from the lens device.
